(19) United States
(12) Patent Application Publication
(10) Pub. No.: US 2013/0230120 A1
(43) Pub. Date: Sep. 5, 2013

(54) APPARATUS AND METHODS FOR LONG AND SHORT TRAINING SEQUENCES FOR A FAST FOURIER TRANSFORM

(71) Applicants: Lin Yang, San Diego, CA (US); Didier Johannes Richard Van Nee, De Meern (NL); Mohammad Hossein Taghavi Nasrabadi, San Diego, CA (US); Sameer Vermani, San Diego, CA (US); Hemanth Sampath, San Diego, CA (US)

(72) Inventors: Lin Yang, San Diego, CA (US); Didier Johannes Richard Van Nee, De Meern (NL); Mohammad Hossein Taghavi Nasrabadi, San Diego, CA (US); Sameer Vermani, San Diego, CA (US); Hemanth Sampath, San Diego, CA (US)

(73) Assignee: QUALCOMM Incorporated, San Diego, CA (US)

(21) Appl. No.: 13/596,931

(22) Filed: Aug. 28, 2012

Related U.S. Application Data
(60) Provisional application No. 61/528,714, filed on Aug. 29, 2011.
(60) Provisional application No. 61/553,420, filed on Oct. 31, 2011.
(60) Provisional application No. 61/556,615, filed on Nov. 7, 2011.
(60) Provisional application No. 61/561,397, filed on Nov. 18, 2011.
(60) Provisional application No. 61/564,153, filed on Nov. 28, 2011.

(51) Int. Cl. H04L 1/00

(52) U.S. Cl. CPC H04L 1/001
USPC 375/295; 375/340

(57) ABSTRACT

Apparatus and methods for communicating and applying training sequences are described herein. For example, provided is a method for generating a short training field (STF) sequence comprising thirty two values or less. The STF sequence can include a first subset of values including zero and non-zero values. The non-zero values can be located at indices of the first subset that are at least a multiple of two, and can be a multiple of four. The STF sequence includes a second subset of zero values that can include all values not included within the first subset. The method further includes transmitting a data unit comprising the STF sequence over a wireless channel. In another example, a method is provided that includes generating a long training field (LTF) sequence comprising thirty two values or less, and transmitting a data unit comprising the LTF sequence over a wireless channel.

### CLAIM OF PRIORITY UNDER 35 U.S.C. §119

The present application for patent claims priority to the following U.S. Provisional Patent Application No. 61/528,714, entitled “SYSTEMS AND METHODS FOR LONG AND SHORT TRAINING SEQUENCES FOR A 32 POINT FAST FOURIER TRANSFORM” and filed Aug. 29, 2011; No. 61/553,420, entitled “SYSTEMS AND METHODS FOR LONG AND SHORT TRAINING SEQUENCES FOR A 32 POINT FAST FOURIER TRANSFORM” and filed Oct. 31, 2011; No. 61/556,615, entitled “SYSTEMS AND METHODS FOR LONG AND SHORT TRAINING SEQUENCES FOR A 32 POINT FAST FOURIER TRANSFORM” and filed Nov. 7, 2011; No. 61/561,397, entitled “SYSTEMS AND METHODS FOR LONG AND SHORT TRAINING SEQUENCES FOR A 32 POINT FAST FOURIER TRANSFORM” and filed Nov. 18, 2011; and No. 61/564,153, entitled “SYSTEMS AND METHODS FOR LONG AND SHORT TRAINING SEQUENCES FOR A 32 POINT FAST FOURIER TRANSFORM” and filed Nov. 28, 2011. These United States Provisional Applications are assigned to the assignee hereof and are hereby expressly incorporated by reference herein.

### FIELD OF DISCLOSURE

This disclosure relates generally to electronics, and more specifically, but not exclusively, to apparatus and methods for long and short training sequences for a fast Fourier transform.

### BACKGROUND

1. Field

The present application relates generally to electronics, and more specifically, but not exclusively, to apparatus and methods for wireless communication. Certain aspects herein determine and employ training sequences for use with a fast Fourier transform (FFT) to minimize a reduced peak-to-average power ratio (PAPR).

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), or personal area network (PAN). Networks also differ according to the switching/routing technique used to interconnect the network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network may transmit/receive information between each other. The information may comprise packets, which in some aspects may be referred to as data units. The packets may include overhead information (e.g., header information, packet properties, etc.) that helps in routing the packet through the network, identifying the data in the packet, processing the packet, and processing a payload of the packet (e.g., user data, multimedia content, etc.).

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description,” one will understand how the features of this invention provide advantages that include decreasing the overhead in transmitting payloads in data packets.

One aspect of the disclosure provides a method for wireless communication. The method includes generating one or more short training field (STF) sequences comprising thirty two values or less. The one or more STF sequences include a first subset of values including values of zero and non-zero values. The non-zero values are located at indices of the first subset that are at least a multiple of two. The one or more STF sequences include a second subset of zero values. The second subset of zero values comprises all values not included within the first subset. The method further includes transmitting a data unit comprising the one or more STF sequences over a wireless channel.

The non-zero values can include either a value of one plus the imaginary unit multiplied by the square root of one-half (+(1+j)) or a value of one plus the imaginary unit multiplied by the negative square root of one-half (−(1+j)). The STF sequence can be characterized by a peak-to-average power ratio having a value less than 4.5 db. The STF sequence can be characterized by a peak-to-average power ratio having a value less than 2.25 db. The non-zero values can be located at indices of the first subset that are a multiple of four where the first subset of values can correspond to indices in a range from −13 to +13, and where the first subset of value includes values of a square root of one half multiplied by (0, 1+j, 0, 0, 0, −1−j, 0, 0, 0, 1+j, 0, 0, 0, 0, 0, 0, 0, −1−j, 0, 0, 0, −1−j, 0, 0, 0, −1−j, and 0).

Generating one or more short training field (STF) sequences can include generating one or more STF sequences for use with an extended range mode. For the extended range mode, the first subset of values can correspond to indices in a range from −13 to +13, and the first subset of values can include values of the square root of one half multiplied by (0, 1+j, 0, 1+j, 0, 1+j, 0, −1−j, 0, −1−j, 0, −1−j, 0, 0, 0, −1−j, 0, 1+j, 0, −1−j, 0, −1−j, 0, 1+j, 0, −1−j, and 0).

Another aspect of the disclosure provides a wireless communication apparatus. The wireless communication apparatus includes a processor configured to generate one or more short training field (STF) sequences comprising thirty two values or less. The one or more STF sequences can include a first subset of values comprising values of zero and non-zero values. The non-zero values can be located at indices of the first subset that are at least a multiple of two. The one or more STF sequences can include a second subset of zero values. The second subset of zero values can include all values not included within the first subset. The wireless communication apparatus further includes a transmitter configured to transmit a data unit comprising the one or more STF sequences over a wireless channel.

Yet another aspect of the disclosure provides a wireless communication apparatus. The wireless communication apparatus includes means for generating one or more short training field (STF) sequences comprising thirty two values or less. The one or more STF sequences include a first subset of values comprising values of zero and non-zero values. The non-zero values are located at indices of the first subset that are at least a multiple of two. The one or more STF sequences include a second subset of zero values. The second subset of zero values includes all values not included within the first subset. The wireless communication apparatus further includes means for transmitting a data unit comprising the one or more STF sequences over a wireless channel.

Another aspect of the disclosure provides a method for wireless communication. The method includes generating one or more long training field (LTF) sequences comprising thirty two values or less. Each of the values of the one or more LTF sequences correspond to one of a guard subcarrier, a direct current subcarrier, a pilot subcarrier, and a data subcarrier. Each of the values corresponding to the pilot subcarrier and the data subcarrier has a value of either one or negative one. Each of the values corresponding to the guard subcarrier and the direct current subcarrier has a value of zero. The method further includes transmitting a data unit comprising the one or more LTF sequences over a wireless channel.

The LTF sequence can be characterized by a peak to average ratio that has a value less than 2 db. The values corresponding to the direct current subcarrier, the pilot subcarrier, and the data subcarrier can correspond to indices in a range from −13 to +13 and the values corresponding to the direct current subcarrier, the pilot subcarrier, and the data subcarrier can form a subset of values comprising 1, −1, 1, 1, −1, 1, 1, −1, 1, 1, 1, −1, 1, 0, −1, −1, −1, 1, −1, −1, −1, 1, 1, 1, −1, −1, and −1.

Generating one or more LTF sequences comprises generating one or more LTF sequences for use with a mode where values corresponding to pilot subcarriers are multiplied by a first value, and values corresponding to data subcarriers are multiplied by a second value, the first value being different than the second value. In this case values corresponding to the direct current subcarrier, the pilot subcarrier, and the data subcarrier can correspond to indices in a range from −13 to +13, the values corresponding to the pilot subcarriers can have indices of −7 and +7, and the values corresponding to the direct current subcarrier, the pilot subcarriers, and the data subcarrier form a subset of values comprising 1, 1, −1, 1, 1, −1, 1, 1, −1, −1, −1, −1, −1, 0, −1, 1, −1, 1, −1, −1, −1, 1, 1, −1, −1, −1, and 1.

Yet another aspect of the disclosure provides a wireless communication apparatus. The wireless communication apparatus includes a processor configured to generate one or more long training field (LTF) sequences comprising thirty two values or less. Each of the values of the one or more LTF sequences correspond to one of a guard subcarrier, a direct current subcarrier, a pilot subcarrier, and a data subcarrier. Each of the values corresponding to the pilot subcarrier and the data subcarrier have a value of either one or negative one. Each of the values corresponding to the guard subcarrier and the direct current subcarrier have a value of 0. The wireless communication apparatus further includes a transmitter configured to a data unit comprising the one or more LTF sequences over a wireless channel.

Another aspect of the disclosure provides a wireless communication apparatus. The wireless communication apparatus includes means for generating one or more long training field (LTF) sequences comprising thirty two values or less. Each of the values of the one or more LTF sequences correspond to one of a guard subcarrier, a direct current subcarrier, a pilot subcarrier, and a data subcarrier. Each of the values corresponding to the pilot subcarrier and the data subcarrier have a value of either one or negative one. Each of the values corresponding to the guard subcarrier and the direct current subcarrier have a value of 0. The wireless communication apparatus further includes means for transmitting a data unit comprising the one or more LTF sequences over a wireless channel.

Another aspect of the disclosure provides a method for wireless communication. The method includes receiving a data unit comprising one or more short training field (STF) sequences comprising thirty two values or less. The one or more STF sequences includes a first subset of values comprising values of zero and non-zero values. The non-zero values are located at indices of the first subset that are at least a multiple of two. The one or more STF sequences include a second subset of zero values. The second subset of zero values includes all values not included within the first subset. The method further includes decoding one or more data symbols based at least in part on the one or more STF sequences.

Another aspect of the disclosure provides a wireless communication apparatus. The wireless communication apparatus includes a receiver configured to receive a data unit comprising one or more short training field (STF) sequences comprising thirty two values or less. The one or more STF sequences include a first subset of values comprising values of zero and non-zero values. The non-zero values are located at indices of the first subset that are at least a multiple of two. The one or more STF sequences include a second subset of zero values. The second subset of zero values includes all values not included within the first subset. The wireless communication apparatus further includes a processor configured to decode one or more data symbols based at least in part on the one or more STF sequences.

Another aspect of the disclosure provides a wireless communication apparatus. The wireless communication apparatus includes means for receiving a data unit comprising one or more short training field (STF) sequences comprising thirty two values or less. The one or more STF sequences include a first subset of values comprising values of zero and non-zero values. The non-zero values are located at indices of the first subset that are at least a multiple of two. The one or more STF sequences include a second subset of zero values. The second subset of zero values include all values not included within the first subset. The wireless communication apparatus further includes means for decoding one or more data symbols based at least in part on the one or more STF sequences.

Another aspect of the disclosure provides a method for wireless communication. The method includes receiving one or more long training field (LTF) sequences comprising thirty two values or less. Each of the values of the one or more LTF sequences correspond to one of a guard subcarrier, a direct current subcarrier, a pilot subcarrier, and a data subcarrier. Each of the values corresponding to the pilot subcarrier and the data subcarrier have a value of either one or negative one. Each of the values corresponding to the guard subcarrier and the direct current subcarrier have a value of zero. The method further includes decoding one or more data symbols based at least in part on the one or more LTF sequences.

Another aspect of the disclosure provides a wireless communication apparatus. The wireless communication apparatus includes a receiver configured to receive one or more long training field (LTF) sequences comprising thirty two values or less. Each of the values of the one or more LTF sequences correspond to one of a guard subcarrier, a direct current subcarrier, a pilot subcarrier, and a data subcarrier. Each of the values corresponding to the pilot subcarrier and the data subcarrier have a value of either one or negative one. Each of the values corresponding to the guard subcarrier and the direct current subcarrier have a value of zero. The wireless communication apparatus further includes a processor configured to decode one or more data symbols based at least in part on the one or more LTF sequences.

Another aspect of the disclosure provides a wireless communication apparatus. The wireless communication apparatus includes means for receiving one or more long training field (LTF) sequences comprising thirty two values or less. Each of the values of the one or more LTF sequences correspond to one of a guard subcarrier, a direct current subcarrier, a pilot subcarrier, and a data subcarrier. Each of the values corresponding to the pilot subcarrier and the data subcarrier have a value of either one or negative one. Each of the values corresponding to the guard subcarrier and the direct current subcarrier have a value of zero. The wireless communication apparatus further includes means for decoding one or more data symbols based at least in part on the one or more LTF sequences.

Another aspect of the disclosure provides a method for wireless communication. The method includes generating a training field sequence comprising thirty two values. Each value corresponds to a wireless subcarrier. The training field sequence includes values corresponding to seven guard subcarriers, one DC subcarrier, twenty two data subcarriers, and two pilot subcarriers. The method further includes transmitting the training field sequence over a wireless subcarrier.

Another aspect of the disclosure provides a method for wireless communication. The method includes generating one or more short training field (STF) sequences comprising thirty two values or less. The STF sequence comprises values of 0, 0, 0, 0, 1+j, 0, 0, 0, −1−j, 0, 0, 0, 1+j, 0, 0, 0, 0, 0, 0, 0, −1−j, 0, 0, 0, −1−j, 0, 0, 0, −1−j, 0, 0, and 0. The method further includes transmitting a data unit comprising the one or more STF sequences over a wireless channel.

Another aspect of the disclosure provides a method for wireless communication. The method includes generating one or more short training field (STF) sequences comprising thirty two values or less. A peak-to-average power ratio of a time domain signal generated from the one or more STF sequences has value that is less than 3 dB. The method further includes transmitting a data unit comprising the one or more STF sequences over a wireless channel.

Another aspect of the disclosure provides a method for wireless communication. The method includes receiving one or more short training field (STF) sequences comprising thirty two values or less. The STF sequence comprises values of 0, 0, 0, 0, 1+j, 0, 0, 0, −1−j, 0, 0, 0, 1+j, 0, 0, 0, 0, 0, 0, 0, −1−j, 0, 0, 0, −1−j, 0, 0, 0, −1−j, 0, 0, and 0. The method further includes decoding one or more data symbols based at least in part on the one or more STF sequences.

Another aspect of the disclosure provides a method for wireless communication. The method includes receiving one or more short training field (STF) sequences comprising thirty two values or less. A peak-to-average power ratio of a time domain signal generated from the one or more STF sequences has value that is less than 3 dB. The method further includes decoding one or more data symbols based at least in part on the one or more STF sequences.

Another aspect of the disclosure provides a method for wireless communication. The method includes generating one or more short training field (STF) sequences comprising thirty two values or less. The one or more STF sequences includes a subset of values comprising non-zero values. At least one of the non-zero values has a different assigned value than at least one other of the non-zero values. The method further includes transmitting a data unit comprising the one or more STF sequences over a wireless channel.

Another aspect of the disclosure provides a method for wireless communication. The method includes receiving one or more short training field (STF) sequences includes thirty two values or less. The one or more STF sequences includes a subset of values comprising non-zero values. At least one of the non-zero values has a different assigned value than at least one other of the non-zero values. The method further includes decoding one or more data symbols based at least in part on the one or more STF sequences.

In an example, a physical layer device is configured to generate one or more short training field (STF) sequences comprising thirty two values or less. The one or more STF sequences comprises a first subset of values comprising values of zero and non-zero values, the non-zero values are located at indices of the first subset that are at least a multiple of two, where the one or more STF sequences comprises a second subset of zero values, and the second subset of zero values comprises all values not included within the first subset.

In an example, provided is a station that includes a physical layer device configured to generate one or more short training field (STF) sequences comprising thirty two values or less. The one or more STF sequences include a first subset of values comprising values of zero and non-zero values. The non-zero values are located at indices of the first subset that are at least a multiple of two, the one or more STF sequences comprises a second subset of zero values, and the second subset of zero values comprises all values not included within the first subset.

In another example, provided is an access point that includes a physical layer device configured to generate one or more short training field (STF) sequences comprising thirty two values or less. The one or more STF sequences comprises a first subset of values comprising values of zero and non-zero values. The non-zero values are located at indices of the first subset that are at least a multiple of two, the one or more STF sequences comprises a second subset of zero values, and the second subset of zero values comprises all values not included within the first subset.

In a further example, provided is a physical layer device configured to generate one or more long training field (LTF) sequences comprising thirty two values or less. Each of the values of the one or more LTF sequences correspond to one of a guard subcarrier, a direct current subcarrier, a pilot subcarrier, and a data subcarrier. Each of the values corresponding to the pilot subcarrier and the data subcarrier comprise a value of either one or negative one, and each of the values corresponding to the guard subcarrier and the direct current subcarrier comprises a value of zero.

In an example, provided is a station, including a physical layer device configured to generate one or more long training field (LTF) sequences comprising thirty two values or less. Each of the values of the one or more LTF sequences correspond to one of a guard subcarrier, a direct current subcarrier, a pilot subcarrier, and a data subcarrier. Further, each of the values corresponding to the pilot subcarrier and the data subcarrier comprise a value of either one or negative one, and each of the values corresponding to the guard subcarrier and the direct current subcarrier comprises a value of zero.

In an example, provided is an access point, comprising a physical layer device configured to generate one or more long training field (LTF) sequences comprising thirty two values or less. Each of the values of the one or more LTF sequences correspond to one of a guard subcarrier, a direct current subcarrier, a pilot subcarrier, and a data subcarrier. Further, each of the values corresponding to the pilot subcarrier and the data subcarrier comprise a value of either one or negative one, and each of the values corresponding to the guard subcarrier and the direct current subcarrier comprises a value of zero.

In another aspect, provided is a physical layer device, comprising a circuit that is configured to receive a data unit comprising one or more short training field (STF) sequences comprising thirty two values or less. The one or more STF sequences comprises a first subset of values comprising values of zero and non-zero values, where the non-zero values are located at indices of the first subset that are at least a multiple of two. The one or more STF sequences comprises a second subset of zero values. The second subset of zero values comprises all values not included within the first subset. The circuit is further configured to decode one or more data symbols based at least in part on the one or more STF sequences.

In a further example, provided is a station, comprising a physical layer device configured to receive a data unit comprising one or more short training field (STF) sequences comprising thirty two values or less. The one or more STF sequences comprises a first subset of values comprising values of zero and non-zero values, the non-zero values are located at indices of the first subset that are at least a multiple of two. The one or more STF sequences comprises a second subset of zero values. The second subset of zero values comprises all values not included within the first subset. The physical layer device is further configured to decode one or more data symbols based at least in part on the one or more STF sequences.

In another example, provided is an access point, comprising a physical layer device configured to receive a data unit comprising one or more short training field (STF) sequences comprising thirty two values or less. The one or more STF sequences comprises a first subset of values comprising values of zero and non-zero values. The non-zero values are located at indices of the first subset that are at least a multiple of two. The one or more STF sequences comprises a second subset of zero values. The second subset of zero values comprises all values not included within the first subset. The physical layer device is further configured to decode one or more data symbols based at least in part on the one or more STF sequences.

In an example, provided is a physical layer device, comprising a circuit configured to receive one or more long training field (LTF) sequences comprising thirty two values or less. Each of the values of the one or more LTF sequences correspond to one of a guard subcarrier, a direct current subcarrier, a pilot subcarrier, and a data subcarrier. Each of the values corresponding to the pilot subcarrier and the data subcarrier comprise a value of either one or negative one. Each of the values corresponding to the guard subcarrier and the direct current subcarrier comprises a value of zero. The circuit is further configured to decode one or more data symbols based at least in part on the one or more LTF sequences.

In an example, provided is a station, comprising a physical layer device configured to receive one or more long training field (LTF) sequences comprising thirty two values or less. Each of the values of the one or more LTF sequences correspond to one of a guard subcarrier, a direct current subcarrier, a pilot subcarrier, and a data subcarrier. Each of the values corresponding to the pilot subcarrier and the data subcarrier comprise a value of either one or negative one. Each of the values corresponding to the guard subcarrier and the direct current subcarrier comprises a value of zero. The physical layer device is further configured to decode one or more data symbols based at least in part on the one or more LTF sequences.

In an example, provided is an access point, comprising a physical layer device configured to receive one or more long training field (LTF) sequences comprising thirty two values or less. Each of the values of the one or more LTF sequences correspond to one of a guard subcarrier, a direct current subcarrier, a pilot subcarrier, and a data subcarrier. Each of the values corresponding to the pilot subcarrier and the data subcarrier comprise a value of either one or negative one. Each of the values corresponding to the guard subcarrier and the direct current subcarrier comprises a value of zero. The physical layer device is further configured to decode one or more data symbols based at least in part on the one or more LTF sequences.

### BRIEF DESCRIPTION OF THE DRAWINGS

FIG. 1 depicts an example of a wireless communication system in which aspects of the present disclosure can be employed.

FIG. 2 shows a functional block diagram of an exemplary wireless device that can be employed within the wireless communication system of FIG. 1.

FIG. 3 shows a functional block diagram of exemplary components that can be utilized in the wireless device of FIG. 2 to transmit wireless communications.

FIG. 4 shows a functional block diagram of exemplary components that can be utilized in the wireless device of FIG. 2 to receive wireless communications.

FIG. 5 depicts an example of a physical layer data unit.

FIG. 6 shows a table listing exemplary allocations of different types of subcarriers for 32 subcarriers along with a potential position of the pilot subcarriers.

FIGS. 7A, 7B, and 7C show a comparison of the AGC error span between an STF sequence with equal power on all non-zero tones as compared an STF with unequal power on certain tones.

FIG. 8 shows a flow chart of an aspect of an exemplary method for generating and transmitting a data unit.

FIG. 9 shows a flow chart of another aspect of an exemplary method 800 for receiving and processing a data unit including a training sequence.

FIG. 10 shows a flow chart of an aspect of another exemplary method for generating and transmitting a data unit.

FIG. 11 shows a flow chart of an aspect of another exemplary method 1000 for receiving and processing a data unit including a training sequence.

FIG. 12 is a functional block diagram of another exemplary wireless device that can be employed within the wireless communication system of FIG. 1.

FIG. 13 is a functional block diagram of yet another exemplary wireless device that can be employed within the wireless communication system of FIG. 1.

FIG. 14 depicts an exemplary physical layer device that can be employed within a wireless device.

### DETAILED DESCRIPTION

Aspects of the novel systems, apparatuses, and methods are described more fully hereinafter with reference to the accompanying drawings. The teachings disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to or other than the aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting.

Wireless network technologies can include types of wireless local area networks (WLANs). A WLAN can be used to interconnect nearby devices together, employing widely used networking protocols. The aspects described herein can apply to devices that are compatible with any communication standard, such as WiFi or, more generally, any member of the IEEE 802.11 family of wireless protocols. For example, the aspects described herein can be used as part of the IEEE 802.11ah protocol, which uses sub-1 GHz bands.

In some aspects, wireless signals in a sub-gigahertz band can be transmitted according to the 802.11ah protocol using orthogonal frequency-division multiplexing (OFDM), direct-sequence spread spectrum (DSSS) communications, a combination of OFDM and DSSS communications, and/or other schemes. Implementations of the 802.11ah protocol can be used for communicating with sensors, with metering, and/or with smart grid networks. Advantageously, aspects of certain devices implementing the 802.11ah protocol can consume less power than devices implementing other wireless protocols, and/or can be used to transmit wireless signals across a relatively long range, for example about one kilometer or longer.

In some implementations, a WLAN includes devices which are the components that access the wireless network. For example, there can be two types of devices: access points (“APs”) and clients (also referred to as stations, or “STAs”). In general, an AP serves as a hub or base station for the WLAN and a STA serves as a user of the WLAN. For example, a STA can be a laptop computer, a personal digital assistant (PDA), a mobile phone, etc. In an example, a STA connects to an AP via a WiFi (e.g., using IEEE 802.11 protocol such as 802.11ah) compliant wireless link to obtain general connectivity to the Internet and/or to other wide area networks. In some implementations a STA can also be used as an AP.

An access point (“AP”) can also comprise, be implemented as, or be known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A STA can also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal can comprise a cellular telephone, a cordless telephone, a Session Initiation Protocol (“SIP”) phone, a wireless local loop (“WLL”) station, a personal digital assistant (“PDA”), a handheld device having wireless connection capability, and/or some other suitable processing device connected to a wireless modem. Accordingly, one or more aspects taught herein can be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, and/or any suitable device that is configured to communicate via a wireless medium.

As discussed above, certain of the devices described herein can implement the 802.11ah standard, for example. Such devices, whether used as a STA, an AP, or other device, can be used for smart metering and/or in a smart grid network. Such devices can provide sensor applications or be used in home automation. The devices can instead or in addition be used in a healthcare context, for example for personal healthcare. They can also be used for surveillance, to enable extended-range Internet connectivity (e.g. for use with hotspots), and/or to implement machine-to-machine communications.

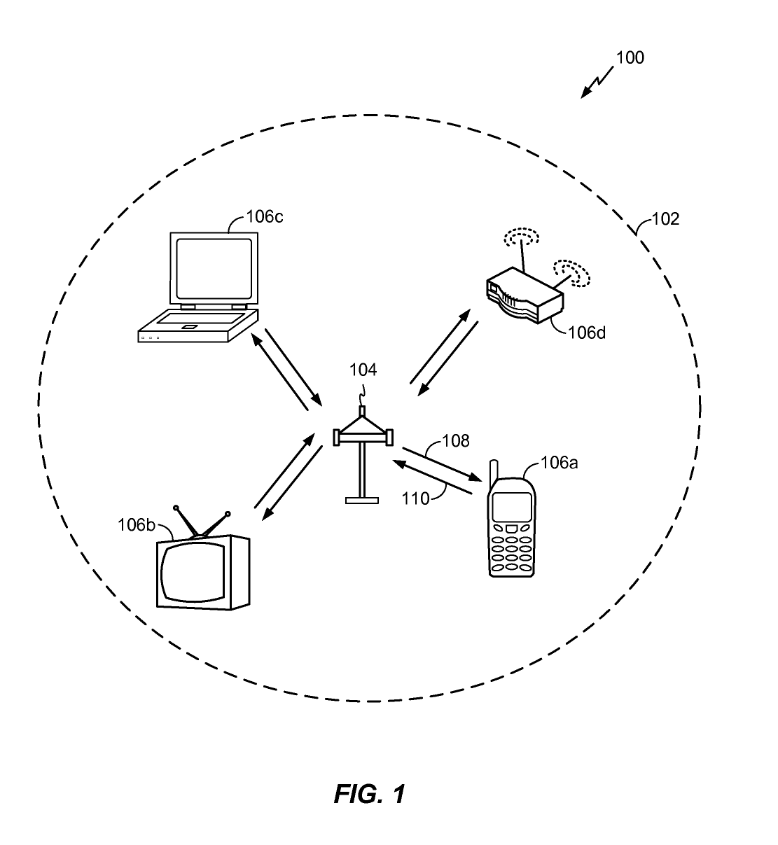

FIG. 1 illustrates an example of a wireless communication system 100 in which aspects of the present disclosure can be employed. The wireless communication system 100 can operate pursuant to a wireless standard, for example the 802.11ah standard. The wireless communication system 100 can include an AP 104, which communicates with STAs 106.

A variety of processes and methods can be used for transmissions in the wireless communication system 100 between the AP 104 and the STAs 106. For example, signals can be sent and received between the AP 104 and the STAs 106 in accordance with OFDM/OFDMA techniques. If this is the case, the wireless communication system 100 can be referred to as an OFDM/OFDMA system. Alternatively, signals can be sent and received between the AP 104 and the STAs 106 in accordance with CDMA techniques. If this is the case, the wireless communication system 100 can be referred to as a CDMA system.

A communication link that facilitates transmission from the AP 104 to one or more of the STAs 106 can be referred to as a downlink (DL) 108, and a communication link that facilitates transmission from one or more of the STAs 106 to the AP 104 can be referred to as an uplink (UL) 110. Alternatively, a downlink 108 can be referred to as a forward link or a forward channel, and an uplink 110 can be referred to as a reverse link or a reverse channel.

The AP 104 can act as a base station and provide wireless communication coverage in a basic service area (BSA) 102. The AP 104 along with the STAs 106 associated with the AP 104 and that use the AP 104 for communication can be referred to as a basic service set (BSS). It should be noted that the wireless communication system 100 cannot have a central AP 104, but rather can function as a peer-to-peer network between the STAs 106. Accordingly, the functions of the AP 104 described herein can alternatively be performed by one or more of the STAs 106.

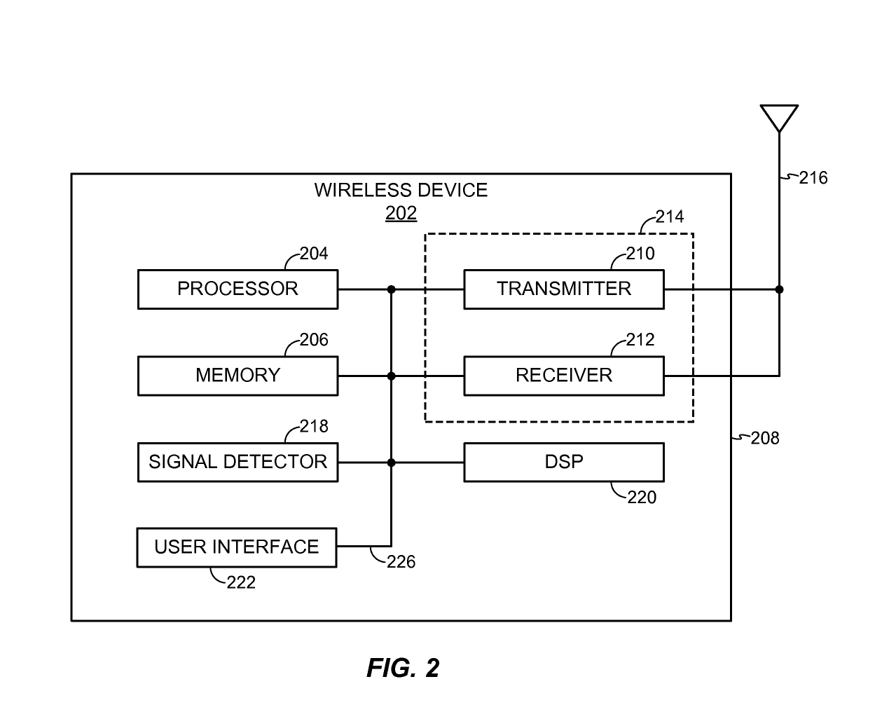

FIG. 2 illustrates components that can be utilized in a wireless device 202 that can be employed within the wireless communication system 100. The wireless device 202 is an example of a device that can be configured to implement the methods described herein. For example, the wireless device 202 can comprise the AP 104 or one of the STAs 106.

The wireless device 202 can include a processor 204 which controls operation of the wireless device 202. The processor 204 can also be referred to as a central processing unit (CPU). Memory 206, which can include both read-only memory (ROM) and random access memory (RAM), provides instructions and data to the processor 204. A portion of the memory 206 can also include non-volatile random access memory (NVRAM). The processor 204 typically performs logical and arithmetic operations based on program instructions stored within the memory 206. The instructions in the memory 206 can be executable to implement the methods described herein.

The processor 204 can comprise or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the functions described herein.

The wireless device 202 can also include a housing 208 that can include a transmitter 210 and a receiver 212 to allow transmission and reception of data between the wireless device 202 and a remote location. The transmitter 210 and receiver 212 can be combined into a transceiver 214. An antenna 216 can be attached to the housing 208 and electrically coupled to the transceiver 214. The wireless device 202 can also include (not shown) multiple transmitters, multiple receivers, multiple transceivers, and/or multiple antennas.

The wireless device 202 can also include a signal detector 218 that can be used in an effort to detect and quantify the level of signals received by the transceiver 214. The signal detector 218 can detect such signals as total energy, energy per subcarrier per symbol, power spectral density and other signals. The wireless device 202 can also include a digital signal processor (DSP) 220 for use in processing signals. The DSP 220 can be configured to generate a data unit for transmission. In some aspects, the data unit can comprise a physical layer data unit (PPDU). In some aspects, the PPDU is referred to as a packet.

The wireless device 202 can further comprise a user interface 222 in some aspects. The user interface 222 can comprise a keypad, a microphone, a speaker, and/or a display. The user interface 222 can include any element or component that conveys information to a user of the wireless device 202 and/or receives input from the user.

The components of the wireless device 202 can be coupled together by a bus system 226. The bus system 226 can include a data bus, for example, as well as a power bus, a control signal bus, and a status signal bus in addition to the data bus. Those of skill in the art will appreciate the components of the wireless device 202 can be coupled together or accept or provide inputs to each other using some other mechanism.

Although a number of separate components are illustrated in FIG. 2, those of skill in the art will recognize that one or more of the components can be combined or commonly implemented. For example, the processor 204 can be used to implement not only the functionality described above with respect to the processor 204, but also to implement the functionality described above with respect to the signal detector 218 and/or the DSP 220. Further, each of the components illustrated in FIG. 2 can be implemented using a plurality of separate elements.

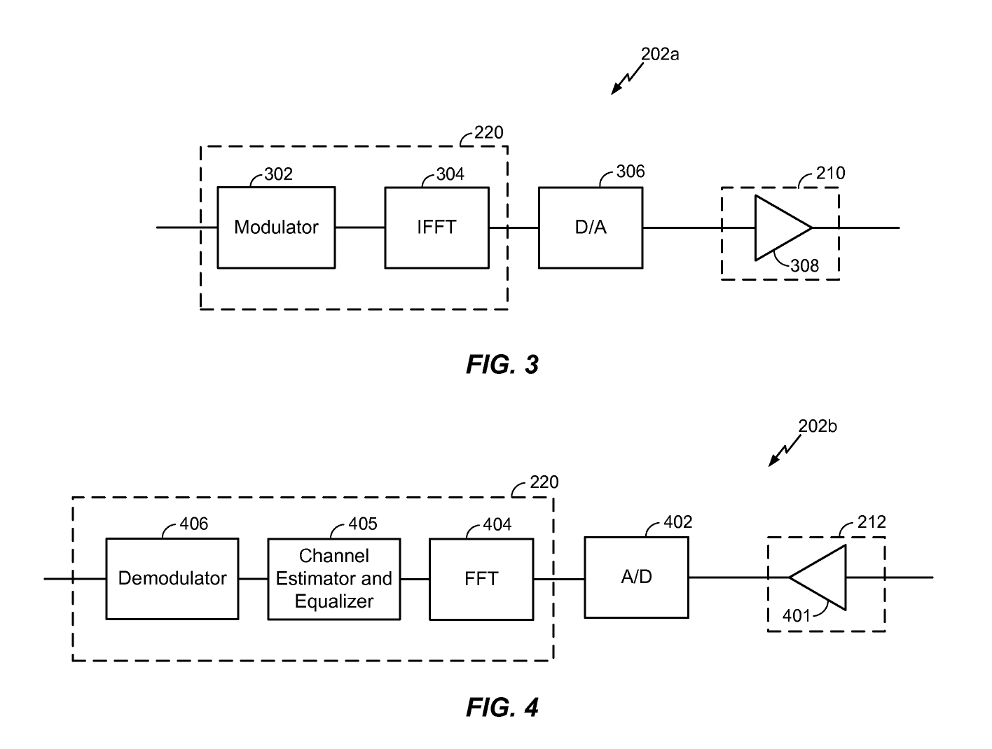

As discussed above, the wireless device 202 can comprise an AP 104 or a STA 106, and can be used to transmit and/or receive communications. FIG. 3 illustrates components that can be utilized in the wireless device 202 to transmit wireless communications. The components illustrated in FIG. 3 can be used, for example, to transmit OFDM communications. In some aspects, the components illustrated in FIG. 3 are used to transmit data units with training fields providing a peak-to-power average ratio that is as low as possible, as will be discussed in additional detail below. For ease of reference, the wireless device 202 configured with the components illustrated in FIG. 3 is hereinafter referred to as a wireless device 202a.

The wireless device 202a can comprise a modulator 302 configured to modulate bits for transmission. For example, the modulator 302 can determine a plurality of symbols from bits received from the processor 204 or the user interface 222, for example by mapping bits to a plurality of symbols according to a constellation. The bits can correspond to user data or to control information. In some aspects, the bits are received in codewords. In one aspect, the modulator 302 comprises a QAM (quadrature amplitude modulation) modulator, for example a 16-QAM modulator or a 64-QAM modulator. In other aspects, the modulator 302 comprises a binary phase-shift keying (BPSK) modulator or a quadrature phase-shift keying (QPSK) modulator.

The wireless device 202a can further comprise a transform module 304 configured to convert symbols or otherwise modulated bits from the modulator 302 into a time domain. In FIG. 3, the transform module 304 is illustrated as being implemented by an inverse fast Fourier transform (IFFT) module. In some implementations, there can be multiple transform modules (not shown) that transform units of data of different sizes.

In FIG. 3, the modulator 302 and the transform module 304 are illustrated as being implemented in the DSP 220. In some aspects, however, one or both of the modulator 302 and the transform module 304 are implemented in the processor 204 or in another element of the wireless device 202.

As discussed above, the DSP 220 can be configured to generate a data unit for transmission. In some aspects, the modulator 302 and the transform module 304 can be configured to generate a data unit comprising a plurality of fields including control information and a plurality of data symbols. The fields including the control information can comprise one or more training fields, for example, and one or more signal (SIG) fields. Each of the training fields can include a known sequence of bits or symbols. Each of the SIG fields can include information about the data unit, for example a description of a length or data rate of the data unit.

Returning to the description of FIG. 3, the wireless device 202a can further comprise a digital to analog converter 306 configured to convert the output of the transform module into an analog signal. For example, the time-domain output of the transform module 306 can be converted to a baseband OFDM signal by the digital to analog converter 306. The digital to analog converter 306 can be implemented in the processor 204 or in another element of the wireless device 202. In some aspects, the digital to analog converter 306 is implemented in the transceiver 214 or in a data transmit processor.

The analog signal can be wirelessly transmitted by the transmitter 210. The analog signal can be further processed before being transmitted by the transmitter 210, for example by being filtered and/or by being upconverted to an intermediate and/or carrier frequency. In the aspect illustrated in FIG. 3, the transmitter 210 includes a transmit amplifier 308. Prior to being transmitted, the analog signal can be amplified by the transmit amplifier 308. In some aspects, the amplifier 308 comprises a low noise amplifier (LNA).

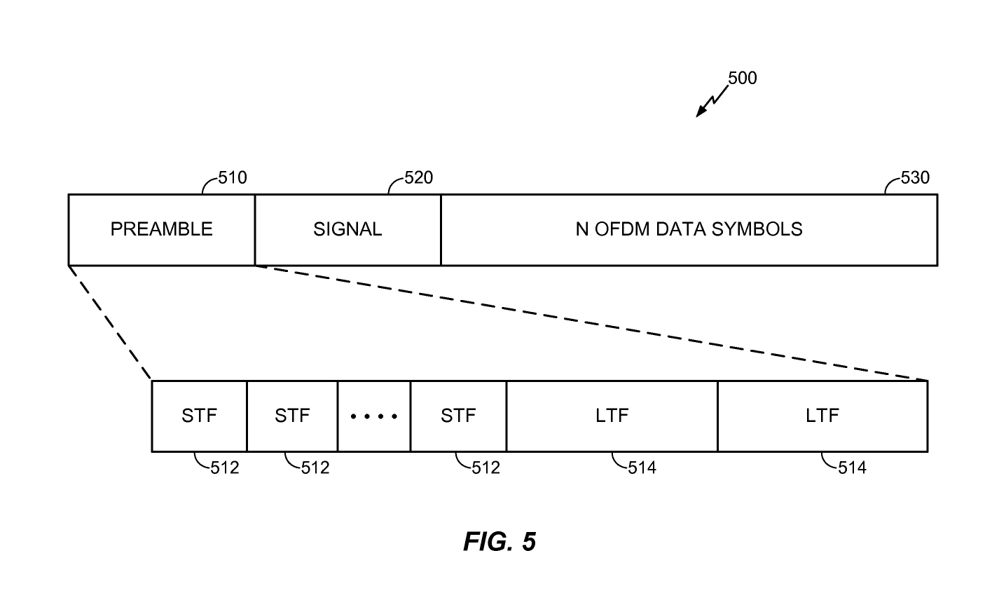

The transmitter 210 is configured to transmit one or more packets or data units in a wireless signal based on the analog signal. The data units can be generated using the processor 204 and/or the DSP 220, for example using the modulator 302 and the transform module 304 as discussed above. Data units that can be generated and transmitted as discussed above are described in additional detail below with respect to FIGS. 5-10.

FIG. 4 illustrates components that can be utilized in the wireless device 202 to receive wireless communications. The components illustrated in FIG. 4 can be used, for example, to receive OFDM communications. In some aspects, the components illustrated in FIG. 4 are used to receive data units that include one or more training fields, as will be discussed in additional detail below. For example, the components illustrated in FIG. 4 can be used to receive data units transmitted by the components discussed above with respect to FIG. 3. For ease of reference, the wireless device 202 configured with the components illustrated in FIG. 4 is hereinafter referred to as a wireless device 202b.

The receiver 212 is configured to receive one or more packets or data units in a wireless signal. Data units that can be received and decoded or otherwise processed as discussed below are described in additional detail with respect to FIGS. 5-12.

In the aspect illustrated in FIG. 4, the receiver 212 includes a receive amplifier 401. The receive amplifier 401 can be configured to amplify the wireless signal received by the receiver 212. In some aspects, the receiver 212 is configured to adjust the gain of the receive amplifier 401 using an automatic gain control (AGC) procedure. In some aspects, the automatic gain control uses information in one or more received training fields, such as a received short training field (STF) for example, to adjust the gain. Those having ordinary skill in the art understand methods for performing AGC. In some aspects, the amplifier 401 comprises an LNA.

The wireless device 202b can comprise an analog to digital converter 402 configured to convert the amplified wireless signal from the receiver 212 into a digital representation thereof. Further to being amplified, the wireless signal can be processed before being converted by the digital to analog converter 402, for example by being filtered and/or by being downconverted to an intermediate and/or baseband frequency. The analog to digital converter 402 can be implemented in the processor 204 or in another element of the wireless device 202. In some aspects, the analog to digital converter 402 is implemented in the transceiver 214 or in a data receive processor.

The wireless device 202b can further comprise a transform module 404 configured to convert the information carried by the wireless signal into a frequency spectrum. In FIG. 4, the transform module 404 is illustrated as being implemented by a fast Fourier transform (FFT) module. In some aspects, the transform module can identify a symbol for each point that the transform module uses.

The wireless device 202b can further comprise a channel estimator and equalizer 405 configured to form an estimate of the channel over which the data unit is received, and to remove certain effects of the channel based on the channel estimate. For example, the channel estimator can be configured to approximate a function of the channel, and the channel equalizer can be configured to apply an inverse of that function to the data in the frequency spectrum.

In some aspects, the channel estimator and equalizer 405 uses information in one or more received training fields, such as a long training field (LTF) for example, to estimate the channel. The channel estimate can be formed based on one or more LTFs received at the beginning of the data unit. This channel estimate can thereafter be used to equalize data symbols that follow the one or more LTFs. After a certain period of time or after a certain number of data symbols, one or more additional LTFs can be received in the data unit. The channel estimate can be updated or a new estimate formed using the additional LTFs. This new or update channel estimate can be used to equalize data symbols that follow the additional LTFs. In some aspects, the new or updated channel estimate is used to re-equalize data symbols preceding the additional LTFs. Those having ordinary skill in the art understand methods for forming a channel estimate.

The wireless device 202b can further comprise a demodulator 406 configured to demodulate the equalized data. For example, the demodulator 406 can determine a plurality of bits from symbols output by the transform module 404 and the channel estimator and equalizer 405, for example by reversing a mapping of bits to a symbol in a constellation. The bits can be processed and/or evaluated by the processor 204, and/or used to display (or otherwise output) information to the user interface 222. In this way, data and/or information can be decoded. In some aspects, the bits correspond to codewords. In one aspect, the demodulator 406 comprises a QAM (quadrature amplitude modulation) demodulator, for example a 16-QAM demodulator or a 64-QAM demodulator. In other aspects, the demodulator 406 comprises a binary phase-shift keying (BPSK) demodulator or a quadrature phase-shift keying (QPSK) demodulator.

In FIG. 4, the transform module 404, the channel estimator and equalizer 405, and the demodulator 406 are illustrated as being implemented in the DSP 220. In some aspects, however, one or more of the transform module 404, the channel estimator and equalizer 405, and the demodulator 406 are implemented in the processor 204 or in another element of the wireless device 202.

As discussed above, the wireless signal received at the receiver 212 comprises one or more data units. Using the functions or components described above, the data units or data symbols therein can be decoded evaluated or otherwise evaluated or processed. For example, the processor 204 and/or the DSP 220 can be used to decode data symbols in the data units using the transform module 404, the channel estimator and equalizer 405, and the demodulator 406.

Data units exchanged by the AP 104 and the STA 106 can include control information or data, as discussed herein. At the physical (PHY) layer, these data units can be referred to as physical layer protocol data units (PPDUs). In some aspects, a PPDU can be referred to as a packet or physical layer packet. Each PPDU can comprise a preamble and a payload. The preamble can include training fields and a SIG field. The payload can comprise a Media Access Control (MAC) header or data for other layers, and/or user data, for example. The payload can be transmitted using one or more data symbols. The systems, methods, and devices herein can utilize data units with training fields whose peak-to-power ratio has been minimized.

FIG. 5 illustrates an example of a data unit 500. The data unit 500 can comprise a PPDU for use with the wireless device 202. The data unit 500 can be used by legacy devices or devices implementing a legacy standard or downclocked version thereof.

The data unit 500 includes a preamble 510. The preamble 510 can comprise a variable number of repeating STF 512 symbols, and one or more LTF 514 symbols. In one implementation 10 repeated STF 512 symbols can be set followed by two LTF 512 symbols. The STF 512 can be used by the receiver 212 to perform automatic gain control to adjust the gain of the receive amplifier 401, as discussed above. Furthermore, the STF 512 sequence can be used by the receiver 212 for packet detection, rough timing, and other settings. The LTF 514 can be used by the channel estimator and equalizer 405 to form an estimate of the channel over which the data unit 500 is received.

Following the preamble 510 in the data unit 500 is a SIGNAL unit 520. The SIGNAL can be one OFDM signal that includes information relating to the transmission rate, the length of the data unit 500, and the like. The data unit 500 additionally includes a variable number of data symbols 530, such as OFDM data symbols.

When the data unit 500 is received at the wireless device 202b, the size of the data unit 500 including the training symbols 514 can be computed based on the SIGNAL field 520, and the STF 512 can be used by the receiver 212 to adjust the gain of the receive amplifier 401. Further, a LTF 514a can be used by the channel estimator and equalizer 405 to form an estimate of the channel over which the data unit 500 is received. The channel estimate can be used by the processor 220 to decode the plurality of data symbols 522 that follow the preamble 510.

The data unit 500 illustrated in FIG. 5 is only an example of a data unit that can be used in the system 100 and/or with the wireless device 202. Those having ordinary skill in the art will appreciate that a greater or fewer number of the STFs 412 or LTFs 514 and/or the data symbols 530 can be included in the data unit 500. In addition, one or more symbols or fields can be included in the data unit 500 that are not illustrated in FIG. 5, and one or more of the illustrated fields or symbols can be omitted.

When using OFDM, information using a number of orthogonal subcarriers of the frequency band being used. The number of subcarriers that are used can depend on a variety of considerations including the available frequency bands for use, bandwidth and any associated regulatory constraints. The number of subcarriers used is correlated to the size of an FFT module as each modulated subcarrier is an input to an IFFT module to create the OFDM signal to be transmitted. As such, in some implementations a larger FFT size (e.g., 64, 128, 256, 512) can, corresponding to transmitting data using more subcarriers, be desired to achieve a larger bandwidth. In other implementations, a smaller FFT size can be used for transmitting data in a narrow bandwidth. The number of subcarriers, and therefore FFT size, can be chosen so as to comply with regulatory domains with certain bandwidth restrictions. For example, an FFT size of 32 can be provided for certain implementations (e.g., for down clocked implementations), and provided for use for 802.11ah. As such, the wireless device 202a can include a several transform modules 304 implemented as an FFT or IFFT module, each of different sizes so as to comply with the number of subcarriers specified to be used. At least one of the transform modules 304 can be a 32-point size IFFT or FFT module according to certain aspects described herein.

The number of subcarriers can be characterized by a spectral line used to map the subcarriers to indices for identifying each subcarrier. The spectral line can define indices that span a negative and positive range where half of the subcarriers are represented on each of the negative and positive ranges. For example, for 64 subcarriers, each subcarrier can be mapped to indices from −32 to +31 to define the spectral line. When using 32 subcarriers (i.e., tones), the spectral line can defined to map each subcarrier to indices from −16 to +15.

The number of subcarriers used and therefore FFT size can determine the size of the training sequence such as the STF 512 and LTF 514 transmitted as described above. Each signal sent, and therefore training sequence can be characterized by its peak-to-power average ratio (PAPR). The PAPR can be generally defined as the peak amplitude of OFDM signal divided by the root mean square of the amplitudes OFDM signal. For example, an OFDM signal can be expressed as:

$$x ( t ) = {\sum }_{k = 0}^{N - 1} {X}_{k} {e}^{j \frac{2 π kt}{T}}$$

where Xₖ represents data symbols, N is the number of subcarriers, and T is time for the OFDM symbol. The PAPR can be calculated as:

$$PAPR = \frac{max {\vert x ( t ) \vert}^{2}}{E [ {\vert x ( t ) \vert}^{2} ]}$$

where E defines a function for the mean square value of the signal.

As an OFDM signal can be a combination of a large number of signals each with different amplitudes, a PAPR value for the signal can be fairly large. A high PAPR can result in distortion of the signal and other problems, for example, if the signal passes through nonlinear components, such as a power amplifier 308. This signal distortion can result in increased noise and interference between subcarriers. Furthermore, a low PAPR can avoid clipping the signal. As such, it can be beneficial to reduce the PAPR of each OFDM signal when possible. More importantly, as each training sequence is used to synchronize the OFDM signal at the receiver, any added distortion in the training sequence can make synchronization particularly problematic. As such, it can be desirable to minimize the PAPR for a training sequence in order to minimize distortion and ensure accurate synchronization with a receiver for transmitting information. As such, certain aspects of the disclosure are directed to generating training field sequences with minimal PAPR values.

The training sequence size can correspond to the number of subcarriers and therefore FFT size used to transmit the signal. As such, for a 32-point FFT, each training sequence can include 32 values. Accordingly, determining a 32 value sequence with a minimal PAPR can be beneficial for preventing distortion of the training sequence. Each subcarrier can be mapped for different types for transmission that can include guard subcarriers (with a value of zero), direct current (DC) subcarriers, pilot subcarriers, and data subcarriers. As described above, a spectral line for identifying subcarriers for 32 subcarriers can be defined from −16 to +15. The DC subcarrier can be located at an index for generating a zero mean signal. As such one or more DC subcarriers can be located at indexes of −1, 0, and +1 in the spectral line for generating a zero mean signal with three DC tones. For example, in the sequences described below, if using one DC subcarrier, the one DC subcarrier can be located at the 0 index. Guard subcarriers can be positioned at the most negative subcarrier indices and the most positive subcarrier indices in the spectral line (e.g., for 3 guard subcarriers using a spectral line of −16 to +15, the guard subcarriers can be located at indices of −16, −15, and +15. The number of each type of subcarriers and the position of the subcarrier type can determine sequence values and therefore impact the PAPR.

It should be appreciated that while an OFDM symbol can be transmitted using a number of subcarriers, implementations can use oversampling in the IFFT operation to produce the resulting OFDM signal. As such, if 64 subcarriers are used, a 256 IFFT can be used to generate the signal for four times oversampling. In addition, if OFDM symbols are transmitted using 32 subcarriers, the OFDM signal can be produced via a 128 point IFFT four times oversampling. Accordingly the training sequences described below can correspond to sequences with low PAPR when using a four times sampled IFFT.

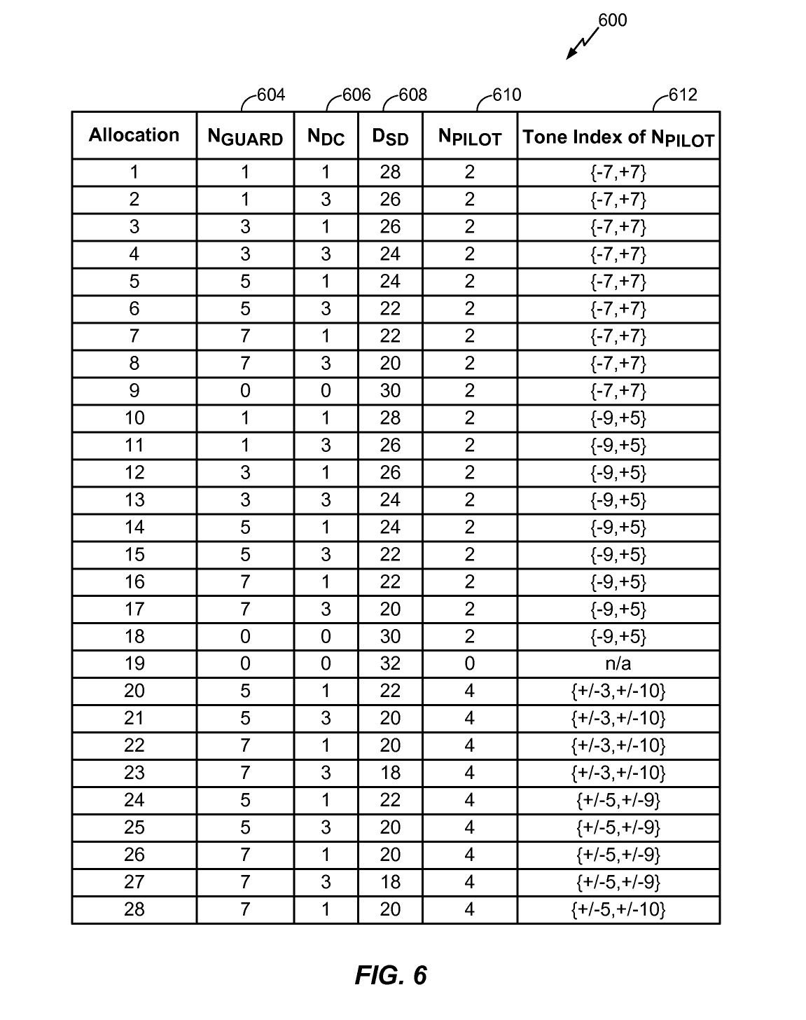

FIG. 6 shows a table 600 listing exemplary allocations of different types of subcarriers for 32 subcarriers along with a potential position of the pilot subcarriers 610. The spectral line for each allocation is from −16:15. For example, according to allocation 1, each OFDM signal can be transmitted with 1 guard subcarrier 604, 1 DC subcarrier 606, 28 data subcarriers 608, and 2 pilot subcarriers 610 and where the subcarriers index of the pilot subcarriers 612 are at {−7:−7} According to another allocation 7, each OFDM signal can be transmitted with 7 guard subcarriers 604, 1 DC subcarrier 606, 22 data subcarriers 608, and 2 pilot subcarriers 610, where the tone index of the pilot subcarriers 612 are at {−7:−7}. The training sequence for each possible allocation of subcarriers can therefore be different depending on the number of each type of subcarrier and potential values that are chosen to be used in the training sequence.

According to one embodiment, short training fields 512 can be determined for allocation 5 of FIG. 6 with reduced PAPR. In the fifth sub-carrier allocation, there are 5 guard subcarriers 604, 1 DC subcarrier 606, 2 pilot subcarriers 610 at {−7,+7}, and 24 data subcarriers, and 612. For the STF sequence, the subcarriers corresponding to the guard subcarriers and DC subcarrier can be modulated with a value of zero. The position of the guard subcarriers can be divided and be at the beginning and the end of the spectral line of subcarriers. As such, the STF sequence 512 would have zero values for each of the guard subcarriers and DC subcarriers, with zero values for the guard subcarriers at the beginning and end. A limited number of data or pilot subcarriers for the STF sequence 512 are chosen to be modulated with non-zero values. The spectral lines described below can refer to the spectral line with guard subcarriers which are located the beginning and end of the spectral lines. As such the spectral lines below can refer to the spectral line of data and pilot subcarriers with a DC subcarrier at the 0 index (e.g., middle) of the spectral line. For example, for the fifth allocation of FIG. 6, the spectral line without guard subcarriers can be defined with indices from −13 to +13 as three guard carriers can lead the sequence and 2 guard carriers can trail the sequence. To achieve a low PAPR, the values for modulating the non-zero value subcarriers can be chosen from:

$$\{ {e}^{\pm j \frac{π}{4}} = \pm \sqrt{\frac{1}{2}} ( 1 + j ) \}$$

and can correspond to indices that are a multiple of 4 in the spectral line of S_{-13:13}. The two values of \sqrt{1/2}(1+j) and \sqrt{1/2}(−1−j) can correspond to values that provide improved correlation for the detection of the presence of a packet while also additionally providing a value to allow a reduced PAPR for the STF sequence 512. Repeating non-zero values (e.g., ensuring the sequence has periodicity) and ensuring that there are an equal number of non-zero values on each side of the DC value provides good correlation and helps with packet detection. The values in Table 1 below shows short training sequences 512, according to certain embodiments, that have been determined to have low PAPR values using the choice of symbols as just described according to the fifth subcarrier allocation shown in FIG. 6.

TABLE 1

| S_{-13:13} | PAPR |
|---|---|
| \sqrt{1/2} {0, 1 + j, 0, 0, 0, −1 − j, 0, 0, 0, 1 + j, 0, 0, 0, 0, 0, 0, 0, | 2.2303 dB |
| −1 − j, 0, 0, 0, −1 − j, 0, 0, 0, −1 − j, 0} | |
| \sqrt{1/2} {0, −1 − j, 0, 0, 0, 1 + j, 0, 0, 0, −1 − j, 0, 0, 0, 0, 0, 0, | 2.2303 dB |
| 0, 1 + j, 0, 0, 0, 1 + j, 0, 0, 0, 1 + j, 0} | |
| \sqrt{1/2} {0, 1 + j, 0, 0, 0, 1 + j, 0, 0, 0, 1 + j, 0, 0, 0, 0, 0, 0, 0, | 2.2303 dB |
| −1 − j, 0, 0, 0, 1 + j, 0, 0, 0, −1 − j, 0} | |
| \sqrt{1/2} {0, −1 − j, 0, 0, 0, −1 − j, 0, 0, 0, −1 − j, 0, 0, 0, 0, 0, 0, | 2.2303 dB |
| 0, 1 + j, 0, 0, 0, −1 − j, 0, 0, 0, 1 + j, 0} | |
| \sqrt{1/2} {0, 1 + j, 0, 0, 0, 1 + j, 0, 0, 0, −1 − j, 0, 0, 0, 0, 0, 0, 0, | 3.3095 dB |
| −1 − j, 0, 0, 0, −1 − j, 0, 0, 0, 1 + j, 0} | |
| \sqrt{1/2} {0, 1 + j, 0, 0, 0, −1 − j, 0, 0, 0, −1 − j, 0, 0, 0, 0, 0, 0, | 3.3095 dB |
| 0, −1 − j, 0, 0, 0, 1 + j, 0, 0, 0, 1 + j, 0} | |
| \sqrt{1/2} {0, −1 − j, 0, 0, 0, 1 + j, 0, 0, 0, 1 + j 0, 0, 0, 0, 0, 0, 0, | 3.3095 dB |
| 1 + j, 0, 0, 0, −1 − j, 0, 0, 0, −1 − j, 0} | |
| \sqrt{1/2} {0, −1 − j, 0, 0, 0, −1 − j, 0, 0, 0, 1 + j, 0, 0, 0, 0, 0, 0, | 3.3095 dB |
| 0, 1 + j, 0, 0, 0, 1 + j, 0, 0, 0, −1 − j, 0} | |
| \sqrt{1/2} {0, 1 + j, 0, 0, 0, 1 + j, 0, 0, 0, 1 + j, 0, 0, 0, 0, 0, 0, 0, | 4.2597 dB |
| 1 + j, 0, 0, 0, −1 − j, 0, 0, 0, 1 + j, 0} | |
| \sqrt{1/2} {0, 1 + j, 0, 0, 0, 1 + j, 0, 0, 0, −1 − j, 0, 0, 0, 0, 0, 0, 0, | 4.2597 dB |
| −1 − j, 0, 0, 0, 1 + j, 0, 0, 0, −1 − j, 0} | |

Accordingly, these STF sequences can correspond to optimally low PAPR values that can avoid distorting the short training sequence when transmitted while having good correlation properties for packet detection for the fifth allocation shown in FIG. 6. These sequences can correspond to training sequence with low PAPR values when using a four times oversampled IFFT.

According to another embodiment, a different mode might be used to extend range (e.g., for Medium—XR mode)). Rather than having a non-zero value at multiples of four indices of the spectral line, every other data or pilot subcarrier can be modulated with a non-zero value such as either \sqrt{1/2}(1+j) or \sqrt{1/2}(−1−j) as described above. As such the non-zero subcarriers can have indices of a multiple of 2 in spectral lines of M_{-13:13}. The values in Table 2 below show short training sequences 512, according to certain embodiments, that have been determined to have low PAPR values using the choice of symbols as just described for the extended range mode using the fifth allocation of FIG. 6.

TABLE 2

| M_{-13:13} | PAPR |
|---|---|
| \sqrt{1/2} {0, 1 + j, 0, 1 + j, 0, 1 + j, 0, −1 − j, 0, −1 − j, 0, | 2.0589 dB |
| −1 − j, 0, 0, 0, −1 − j, 0, 1 + j, 0, −1 − j, 0, −1 − j, 0, 1 + j, | |
| 0, −1 − j, 0} | |
| \sqrt{1/2} {0, 1 + j, 0, −1 − j, 0, 1 + j, 0, 1 + j, 0, −1 − j, 0, 1 + j, | 2.0589 dB |
| 0, 0, 0, 1 + j, 0, 1 + j, 0, 1 + j, 0, −1 − j, 0, −1 − j, 0, −1 −j, | |
| 0} | |
| \sqrt{1/2} {0, −1 − j, 0, 1 + j, 0, −1 − j, 0, −1 − j, 0, 1 + j, | 2.0589 dB |
| 0, −1 − j, 0, 0, 0, −1 − j, 0, −1 − j, 0, −1 −j, 0, 1 + j, 0, 1 + j, | |
| 0, 1 + j, 0} | |
| \sqrt{1/2} {0, −1 − j, 0, −1 − j, 0, −1 − j, 0, 1 + j, 0, 1 + j, | 2.0589 dB |
| 0, 1 + j, 0, 0, 0, 1 + j, 0, −1 − j, 0, 1 + j, 0, 1 + j, 0, −1 −j, 0, | |
| 1 + j, 0} | |
| \sqrt{1/2} {0, 1 + j, 0, 1 + j, 0, 1 + j, 0, 1 + j, 0, −1 − j, 0, | 2.2394 dB |
| −1 − j, 0, 0, 0, 1 + j, 0, −1 − j, 0, −1 − j, 0, 1 + j, 0, −1 −j, | |
| 0, 1 + j, 0} | |
| \sqrt{1/2} {0, 1 + j, 0, −1 − j, 0, 1 + j, 0, −1 − j, 0, −1 − j, 0, 1 + j, | 2.2394 dB |
| 0, 0, 0, −1 − j, 0, −1 −j, 0, 1 + j, 0, 1 + j, 0, 1 + j, 0, 1 + j, | |
| 0} | |
| \sqrt{1/2} {0, −1 − j, 0, 1 + j, 0, −1 − j, 0, 1 + j, 0, 1 + j, 0, | 2.2394 dB |
| −1 − j, 0, 0, 0, 1 + j, 0, 1 + j, 0, −1 − j, 0, −1 − j, 0, −1 −j, 0, | |
| −1 − j, 0} | |
| \sqrt{1/2} {0, −1 − j, 0, −1 − j, 0, −1 − j, 0, −1 − j, 0, 1 + j, 0, | 2.2394 dB |
| 1 + j, 0, 0, 0, −1 − j, 0, 1 + j, 0, 1 + j, 0, −1 −j, 0, 1 + j, 0, | |
| −1 − j, 0} | |
| \sqrt{1/2} {0, 1 + j, 0, 1 + j, 0, 1 + j, 0, 1 + j, 0, 1 + j, 0, | 2.2974 dB |
| −1 − j, 0, 0, 0, −1 − j, 0, 1 + j, 0, 1 + j, 0, −1 − j, 0, −1 −j, | |
| 0, 1 + j, 0} | |
| \sqrt{1/2} {0, −1 − j, 0, −1 − j, 0, −1 − j, 0, −1 − j, 0, −1 − j, 0, | 2.2974 dB |
| 1 + j, 0, 0, 0, 1 + j, 0, −1 − j, 0, −1 −j, 0, 1 + j, 0, 1 + j, 0, | |
| −1 − j, 0} | |

Accordingly, these STF sequences 512 can correspond to optimally low PAPR values for the fifth allocation shown in FIG. 6 when using an extended range mode. The sequences can correspond to training sequence with low PAPR values when using a four times oversampled IFFT.

According to another embodiment, LTF sequences 514 can be determined for the fifth allocation shown in FIG. 6 that have low PAPR values. For an LTF sequence, every subcarrier corresponding to a data subcarrier or a pilot subcarrier can be modulated with a non-zero symbol. To achieve a low PAPR, all the data and pilot symbol values can be chosen from either +1 or −1, and selected so as to minimize the PAPR ratio. The values in Table 3 below shows LTF sequences 512, according to certain embodiments, that have been determined to have low PAPR values using the choice of symbols as just described according to the fifth subcarrier allocation shown in FIG. 6 for the spectral line of −13:13.

TABLE 3

| LTF_{-13:13} | PAPR |
|---|---|
| {1, −1, 1, 1, −1, 1, 1, −1, 1, 1, 1, −1, 1, 0, −1, −1, −1, 1, | 1.8365 dB |
| −1, −1, −1, 1, 1, 1, −1, −1, −1} | |
| {1, −1, 1, −1, 1, −1, −1, 1, −1, −1, 1, 1, −1, 0, −1, | 1.9942 dB |
| −1, 1, 1, −1, −1, −1, 1, 1, 1, 1, 1, 1} | |
| {1, −1, 1, −1, 1, −1, 1, 1, −1, −1, −1, 1, 1, 0, 1, −1, | 2.0381 dB |
| −1, 1, −1, −1, 1, 1, 1, 1, 1, 1, 1} | |
| {1, −1, 1, −1, 1, 1, 1, 1, 1, 1, 1, 1, −1, 0, −1, −1, 1, −1, | 2.2113 dB |
| 1, 1, −1, −1, 1, 1, −1, −1, 1} | |
| {1, −1, 1, −1, 1, −1, −1, 1, 1, 1, −1, −1, 1, 0, 1, 1, −1, −1, | 2.3083 dB |
| 1, −1, −1, 1, 1, 1, 1, 1, 1} | |
| {1, 1, 1, −1, 1, −1, −1, −1, 1, 1, 1, 1, −1, 0, 1, 1, −1, 1, −1, | 2.3087 dB |
| −1, 1, −1, −1, −1, −1, 1, −1} | |
| {1, 1, 1, 1, 1, 1, 1, −1, −1, 1, −1, 1, −1, 0, −1, 1, 1, 1, −1, −1, | 2.3140 dB |
| −1, 1, 1, −1, 1, 1, −1} | |
| {1, 1, 1, 1, 1, −1, −1, −1, −1, −1, 1, −1, −1, 0, 1, −1, −1, | 2.3579 dB |
| −1, 1, −1, 1, −1, −1, 1, −1, 1, −1} | |
| {1, −1, −1, 1, 1, −1, −1, 1, −1, −1, 1, −1, 1, 0, 1, 1, 1, 1, 1, 1, | 2.3622 dB |
| 1, −1, −1, −1, 1, 1, 1} | |
| {1, 1, −1, −1, −1, −1, 1, 1, 1, 1, −1, 1, −1, 0, −1, 1, −1, −1, | 2.3983 dB |
| −1, 1, −1, −1, −1, −1, 1, −1, −1} | |

Accordingly, these LTF sequences 514 can correspond to optimally low PAPR values for the fifth allocation shown in FIG. 6. The sequences can correspond to training sequence with low PAPR values when using a four times oversampled IFFT.

The LTF field can provide a mechanism for a receiver to estimate a MIMO channel and provides training for space time streams. Accordingly, to another embodiment, single stream pilots can be used for channel estimation purposes and for detecting frequency drift for estimating MIMO channel. When using single stream pilots, data subcarriers can be multiplied a matrix P before being transmitted while pilot subcarriers can be multiplied by a matrix R whose values can be different than the P matrix. This can allow for tracking phase offset and frequency offset during MIMO channel estimation at the receiver.

After multiplication by a matrix and transformation to a time domain signal, the resulting PAPR can be different when P matrix values are different than R matrix values. As such, having different P and R values results in different LTF sequences 514. Accordingly, according to embodiments, the LTF can be chosen by identifying a sequence that minimizes the maximal PAPR over all possible P and R matrix values:

$$LTF = {min}_{S} \{ {max}_{P , R} [ PAPR ( S , P , R ) ] \}$$

where S are the possible sequences for all chosen tone values. As with the embodiment described above with reference to Table 3, data and pilot symbol values can be chosen from +1 or −1. As such, according to the fifth allocation of FIG. 6 where sub-carriers chosen for the pilot signals are at indices of −7, and +7 of the spectral line −13:13, where there are up to four streams to transmit, the LTF sequences 512 shown below in Table 4 have been determined to have low PAPR values for all possible P and R matrix values.

TABLE 4

| LTF_{-13:13} | PAPR |
|---|---|
| {1, 1, −1, 1, 1, −1, 1, 1, −1, −1, −1, −1, −1, 0, −1, 1, −1, 1, −1, −1, −1, 1, | 2.8580 dB |
| 1, −1, −1, −1, 1} | |
| {1, 1, 1, 1, 1, 1, 1, −1, 1, 1, −1, −1, −1, 0, 1, 1, −1, 1, 1, −1, −1, −1, 1, −1, 1, 1, −1} | 3.0931 dB |
| {1, 1, 1, −1, −1, −1, 1, 1, 1, −1, 1, 1, 1, 0, 1, 1, 1, −1, 1, 1, −1, −1, 1, −1, −1, 1, −1} | 3.0984 dB |
| {1, 1, −1, 1, −1, −1, 1, 1, 1, −1, 1, −1, −1, 0, 1, −1, −1, −1, −1, 1, 1, −1, 1, 1, 1, 1, −1} | 3.1144 dB |
| {1, −1, 1, −1, −1, 1, 1, −1, 1, 1, −1, −1, −1, 0, 1, 1, −1, −1, −1, 1, 1, 1, 1, 1, 1, 1, 1} | 3.1528 dB |
| {1, 1, 1, 1, 1, −1, 1, 1, −1, −1, 1, −1, −1, 0, 1, −1, −1, −1, 1, 1, 1, −1, −1, 1, −1, 1, −1} | 3.1580 dB |
| {1, 1, 1, 1, 1, −1, 1, −1, −1, 1, 1, −1, −1, 0, 1, −1, −1, 1, 1, −1, −1, −1, −1, 1, −1, 1, −1} | 3.1742 dB |
| {1, 1, 1, −1, −1, −1, 1, −1, −1, 1, 1, −1, −1, 0, −1, −1, 1, −1, −1, −1, −1, 1, −1, 1, −1, 1, 1} | 3.1780 dB |
| {1, 1, 1, −1, −1, −1, 1, 1, 1, 1, −1, 1, −1, 0, −1, −1, −1, −1, 1, −1, 1, 1, −1, 1, 1, −1, 1} | 3.1912 dB |
| {1, −1, −1, −1, −1, 1, 1, −1, −1, −1, 1, 1, 1, 0, 1, −1, 1, −1, −1, 1, −1, −1, −1, 1, −1, −1, 1} | 3.2136 dB |

Accordingly, the LTF sequences 514 of Table 4 can correspond to LTF sequences with optimally low PAPR values for a 32-point FFT for the fifth allocation shown in FIG. 6 for use with single stream pilots. The LTF sequences 514 can correspond to training sequences with low PAPR values when using a four times oversampled IFFT.

As each sub-carrier allocation as shown in FIG. 6 has different subcarrier mappings, each allocation can have optimized STF and LTF sequences for reduced PAPR like those described above with reference to the fifth subcarrier allocation of FIG. 6.

According to another embodiment, STF and LTF sequences 512 and 514 with low PAPR values are identified for the seventh subcarrier allocation of FIG. 6. In the seventh sub-carrier allocation, there are 7 guard subcarriers 604, 1 DC subcarrier 606, 2 pilot subcarriers 610 at {−7,+7}, and 22 data subcarriers 612. The guard subcarriers can correspond to the first four subcarriers and the last three subcarriers. As described above, values of zero are chosen for the guard subcarriers and the DC subcarrier. The DC tone can be located at index 0 in the spectral line. Table 5 below shows STF sequences 512 optimized for low PAPR for the seventh allocation shown in FIG. 6 where the values for pilot and data subcarriers are chosen from either \sqrt{1/2}(1+j) or \sqrt{1/2}(−1−j) where the non-zero values correspond to subcarriers having indices that are multiples of four in the spectral line of S_{-12:12}.

TABLE 5

| S_{-12:12} | PAPR |
|---|---|
| \sqrt{1/2} {1 + j, 0, 0, 0, −1 − j, 0, 0, 0, 1 + j, 0, 0, 0, 0, 0, 0, 0, −1 − j, 0, 0, 0, −1 − j, 0, 0, 0, −1 − j} | 2.2303 dB |
| \sqrt{1/2} {−1 − j, 0, 0, 0, 1 + j, 0, 0, 0, −1 − j, 0, 0, 0, 0, 0, 0, 0, 1 + j, 0, 0, 0, 1 + j, 0, 0, 0, 1 + j} | 2.2303 dB |
| \sqrt{1/2} {1 + j, 0, 0, 0, 1 + j, 0, 0, 0, 1 + j, 0, 0, 0, 0, 0, 0, 0, −1 − j, 0, 0, 0, 1 + j, 0, 0, 0, −1 − j} | 2.2303 dB |
| \sqrt{1/2} {−1 − j, 0, 0, 0, −1 − j, 0, 0, 0, −1 − j, 0, 0, 0, 0, 0, 0, 0, 1 + j, 0, 0, 0, −1 − j, 0, 0, 0, 1 + j} | 2.2303 dB |
| \sqrt{1/2} {1 + j, 0, 0, 0, 1 + j, 0, 0, 0, −1 − j, 0, 0, 0, 0, 0, 0, 0, −1 − j, 0, 0, 0, −1 − j, 0, 0, 0, 1 + j} | 3.3095 dB |
| \sqrt{1/2} {1 + j, 0, 0, 0, −1 − j, 0, 0, 0, −1 − j, 0, 0, 0, 0, 0, 0, 0, −1 − j, 0, 0, 0, 1 + j, 0, 0, 0, 1 + j} | 3.3095 dB |
| \sqrt{1/2} {−1 − j, 0, 0, 0, 1 + j, 0, 0, 0, 1 + j, 0, 0, 0, 0, 0, 0, 0, 1 + j, 0, 0, 0, −1 − j, 0, 0, 0, −1 − j} | 3.3095 dB |
| \sqrt{1/2} {−1 − j, 0, 0, 0, −1 − j, 0, 0, 0, 1 + j, 0, 0, 0, 0, 0, 0, 0, 1 + j, 0, 0, 0, 1 + j, 0, 0, 0, −1 − j} | 3.3095 dB |
| \sqrt{1/2} {1 + j, 0, 0, 0, 1 + j, 0, 0, 0, 1 + j, 0, 0, 0, 0, 0, 0, 0, 1 + j, 0, 0, 0, −1 − j, 0, 0, 0, 1 + j} | 4.2597 dB |
| \sqrt{1/2} {1 + j, 0, 0, 0, 1 + j, 0, 0, 0, −1 − j, 0, 0, 0, 0, 0, 0, 0, −1 − j, 0, 0, 0, 1 + j, 0, 0, 0, −1 − j} | 4.2597 dB |

Accordingly, the STF sequences 512 of Table 5 can correspond to STF sequences with optimally low PAPR values for a 32-point FFT for the seventh allocation shown in FIG. 6. The STF sequences 512 can correspond to training sequences with low PAPR values when using a four times oversampled IFFT.

In another embodiment, STF sequences 512 for the seventh allocation of FIG. 6 can also be determined for use with an extended range mode. As described above, rather than selecting every fourth pilot or data subcarrier to be modulated with a non-zero value, for an extended range mode, every two pilot or data subcarriers can be modulated with a non-zero value. Table 6 below shows STF sequences 512 optimized for low PAPR for the seventh allocation shown in FIG. 6 where the values for pilot and data subcarriers are chosen from either \sqrt{1/2}(1+j) or \sqrt{1/2}(−1−j) and where the non-zero values correspond to subcarriers having indices that are multiples of two in the spectral line of M_{-12:12}.

TABLE 6

| M−12:12 | PAPR |
|---|---|
| \sqrt{1/2} {1 + j, 0, 1 + j, 0, 1 + j, 0, −1 − j, 0, −1 − j, 0, −1 − j, | 2.0589 dB |
| 0, 0, 0, −1 − j, 0, 1 + j, 0, −1 − j, 0, −1 − j, 0, 1 + j, | |
| 0, −1 − j} | |
| \sqrt{1/2} {1 + j, 0, −1 − j, 0, 1 + j, 0, 1 + j, 0, −1 − j, 0, 1 + j, | 2.0589 dB |
| 0, 0, 0, 1 + j, 0, 1 + j, 0, 1 + j, 0, −1 − j, 0, | |
| −1 − j, 0, −1 − j} | |
| \sqrt{1/2} {−1 − j, 0, 1 + j, 0, −1 − j, 0, −1 − j, 0, 1 + j, 0, −1 − j, | 2.0589 dB |
| 0, 0, 0, −1 − j, 0, −1 − j, 0, −1 − j, 0, 1 + j, 0, 1 + j, 0, | |
| 1 + j} | |
| \sqrt{1/2} {−1 − j, 0, −1 − j, 0, −1 − j, 0, 1 + j, 0, 1 + j, 0, 1 + j, | 2.0589 dB |
| 0, 0, 0, 1 + j, 0, −1 − j, 0, 1 + j, 0, 1 + j, 0, −1 − j, | |
| 0, 1 + j} | |
| \sqrt{1/2} {1 + j, 0, 1 + j, 0, 1 + j, 0, 1 + j, 0, −1 − j, 0, −1 − j, | 2.2394 dB |
| 0, 0, 0, 1 + j, 0, −1 − j, 0, −1 − j, 0, 1 + j, 0, −1 − j, 0, | |
| 1 + j} | |
| \sqrt{1/2} {1 + j, 0, −1 − j, 0, 1 + j, 0, −1 − j, 0, −1 − j, 0, 1 + j, 0, | 2.2394 dB |
| 0, 0, −1 − j, 0, −1 − j, 0, 1 + j, 0, 1 + j, 0, 1 + j, 0, 1 + j} | |
| \sqrt{1/2} {−1 − j, 0, 1 + j, 0, −1 − j, 0, 1 + j, 0, 1 + j, 0, −1 − j, | 2.2394 dB |
| 0, 0, 0, 1 + j, 0, 1 + j, 0, −1 − j, 0, −1 − j, 0, −1 − j, 0, | |
| −1 − j} | |
| \sqrt{1/2} {−1 − j, 0, −1 − j, 0, −1 − j, 0, −1 − j, 0, 1 + j, 0, 1 + j, | 2.2394 dB |
| 0, 0, 0, −1 − j, 0, 1 + j, 0, 1 + j, 0, −1 − j, 0, 1 + j, 0, −1 − j} | |
| \sqrt{1/2} {1 + j, 0, 1 + j, 0, 1 + j, 0, 1 + j, 0, 1 + j, 0, −1 − j, 0, | 2.2974 dB |
| 0, 0, −1 − j, 0, 1 + j, 0, 1 + j, 0, −1 − j, 0, −1 − j, 0, 1 + j} | |
| \sqrt{1/2} {−1 − j, 0, −1 − j, 0, −1 − j, 0, −1 − j, 0, −1 − j, 0, | 2.2974 dB |
| 1 + j, 0, 0, 0, 1 + j, 0, −1 − j, 0, −1 − j, 0, 1 + j, 0, | |
| 1 + j, 0, −1 − j} | |

Accordingly, the STF sequences 512 of Table 6 can correspond to STF sequences with optimally low PAPR values for a 32-point FFT for the seventh allocation shown in FIG. 6 for use with an extended mode range. The STF sequences 512 can correspond to training sequences with low PAPR values when using a four times oversampled IFFT.

In another embodiment, LTF sequences 514 for the seventh allocation of FIG. 6 can be determined Table 7 below shows LTF sequences optimized for low PAPR for the seventh allocation shown in FIG. 6 where the values for all the data and pilot subcarriers are chosen from either +1 or −1 in the spectral line of LTF_{-12:12}.

TABLE 7

| LTF_{-12:12} | PAPR |
|---|---|
| {1, 1, −1, −1, −1, −1, 1, 1, −1, 1, 1, −1, 0, 1, 1, 1, −1, 1, 1, | 1.8712 dB |
| −1, 1, −1, 1, −1, 1} | |
| {1, −1, −1, −1, 1, −1, −1, 1, 1, 1, 1, 1, 0, 1, −1, −1, 1, 1, 1, | 2.1749 dB |
| 1, −1, 1, −1, 1, 1} | |
| {1, 1, 1, 1, 1, 1, −1, −1, −1, 1, 1, 1, 0, −1, 1, 1, −1, 1, 1, −1, | 2.1821 dB |
| −1, 1, −1, 1, −1} | |
| {1, 1, 1, 1, −1, −1, −1, −1, −1, 1, −1, −1, 0, 1, −1, −1, | 2.1847 dB |
| −1, 1, −1, 1, −1, −1, 1, −1, 1} | |
| {1, −1, 1, −1, −1, −1, 1, 1, 1, −1, 1, 1, 0, 1, −1, −1, −1, 1, | 2.2697 dB |
| −1, −1, 1, −1, −1, −1, −1} | |
| {1, 1, −1, −1, −1, −1, −1, −1, −1, 1, 1, −1, 0, −1, −1, | 2.2899 dB |
| 1, 1, −1, 1, −1, 1, −1, 1, 1, −1} | |
| {1, 1, 1, 1, 1, −1, 1, 1, 1, 1, −1, −1, 0, −1, 1, −1, 1, −1, 1, 1, | 2.3227 dB |
| −1, −1, 1, 1, −1} | |
| {1, 1, 1, 1, 1, 1, −1, 1, −1, −1, −1, 1, 0, 1, 1, −1, 1, −1, −1, | 2.3775 dB |
| 1, 1, 1, −1, −1, 1} | |
| {1, 1, −1, −1, −1, 1, 1, 1, 1, 1, 1, −1, 0, −1, 1, −1, −1, −1, | 2.3892 dB |
| 1, −1, −1, 1, −1, −1, 1} | |
| {1, −1, −1, −1, 1, −1, −1, −1, 1, −1, 1, −1, 0, 1, −1, 1, | 2.4027 dB |
| −1, −1, 1, 1, 1, 1, 1, −1, −1} | |

Accordingly, the LTF sequences 514 of Table 7 can correspond to LTF sequences with optimally low PAPR values for a 32-point FFT for the seventh allocation shown in FIG. 6. The LTF sequences 514 can correspond to training sequences with low PAPR values when using a four times oversampled IFFT.

In another embodiment, LTF sequences 514 for the seventh allocation of FIG. 6 can be determined for use with single stream pilots. Table 8 below shows LTF sequences optimized for low PAPR for the seventh allocation shown in FIG. where the values for all the data and pilot subcarriers are chosen from either +1 or −1 in the spectral line of LTF_{-12:12}, the pilot subcarriers have indices of +7 and −7 for the spectral line, and the LTF sequences are chose to minimize the maximal PAPR for all possible P and R values for up to 4 streams to transmit.

TABLE 8

| LTF_{-12:12} | PAPR |
|---|---|
| {1, 1, 1, 1, 1, 1, −1, 1, 1, 1, −1, −1, 0, −1, 1, 1, −1, 1, 1, −1, | 2.7429 dB |
| −1, 1, −1, 1, −1} | |
| {1, 1, 1, −1, −1, 1, 1, 1, −1, 1, −1, 1, 0, 1, 1, 1, 1, 1, −1, −1, | 2.8978 dB |
| 1, −1, −1, 1, −1} | |
| {1, −1, 1, 1, −1, 1, 1, −1, 1, 1, 1, 1, 0, 1, −1, 1, −1, −1, −1, | 2.9349 dB |
| 1, 1, 1, −1, −1, −1} | |
| {1, −1, −1, 1, −1, 1, 1, −1, −1, −1, −1, 1, 0, 1, 1, 1, 1, −1, | 2.9448 dB |
| 1, 1, 1, −1, 1, 1, 1} | |
| {1, 1, −1, −1, −1, 1, −1, 1, 1, −1, −1, −1, 0, −1, 1, | 2.9661 dB |
| −1, −1, 1, 1, 1, 1, −1, 1, 1, −1} | |
| {1, 1, −1, 1, −1, 1, −1, 1, 1, −1, −1, 1, 0, 1, 1, −1, −1, 1, | 3.0413 dB |
| 1, −1, 1, 1, 1, 1, −1} | |
| {1, −1, 1, 1, −1, 1, 1, −1, −1, 1, −1, 1, 0, 1, 1, 1, 1, −1, −1, | 3.0803 dB |
| 1, 1, 1, −1, −1, −1} | |
| {1, 1, 1, −1, −1, 1, 1, −1, −1, −1, −1, −1, 0, −1, 1, −1, | 3.1139 dB |
| 1, −1, −1, −1, 1, −1, −1, 1, −1} | |
| {1, −1, −1, 1, −1, 1, −1, 1, −1, −1, −1, −1, 0, 1, −1, | 3.1302 dB |
| 1, −1, −1, 1, 1, −1, −1, 1, 1, 1} | |
| {1, 1, 1, 1, 1, 1, 1, −1, −1, 1, 1, −1, 0, −1, −1, 1, −1, 1, −1, | 3.1405 dB |
| 1, −1, 1, 1, −1, −1} | |

Accordingly, the LTF sequences 514 of Table 8 can correspond to LTF sequences with optimally low PAPR values for a 32-point FFT for use with single stream pilots for the seventh allocation shown in FIG. 6. The LTF sequences 514 can correspond to training sequences with low PAPR values when using a four times oversampled IFFT.

According to another embodiment, STF and LTF sequences 512 and 514 with low PAPR values are identified for the third subcarrier allocation of FIG. 6. In the third sub-carrier allocation, there are 3 guard subcarriers 604, 1 DC subcarrier 606, 2 pilot subcarriers 610 at {−7,+7}, and 26 data subcarriers 612. The guard subcarriers can correspond to the first two subcarriers and the last subcarrier. As described above, values of zero are chosen for the guard subcarriers and the DC subcarrier. The DC tone can be located at index 0 in the spectral line. Table 9 below shows STF sequences 512 optimized for low PAPR for the third allocation shown in FIG. 6 where the values for pilot and data subcarriers are chosen from either \sqrt{1/2}(1+j) or \sqrt{1/2}(−1−j) where the non-zero values correspond to subcarriers having indices that are multiples of four in the spectral line of S_{-14:14}.

TABLE 9

| S_{-14:14} | PAPR |
|---|---|
| \sqrt{1/2} {0, 0, 1 + j, 0, 0, 0, −1 − j, 0, 0, 0, 1 + j, 0, 0, 0, 0, 0, | 2.2303 dB |
| 0, 0, −1 − j, 0, 0, 0, −1 − j, 0, 0, 0, −1 − j, 0, 0} | |
| \sqrt{1/2} {0, 0, −1 − j, 0, 0, 0, 1 + j, 0, 0, 0, −1 − j, 0, 0, 0, | 2.2303 dB |
| 0, 0, 0, 0, 1 + j, 0, 0, 0, 1 + j, 0, 0, 0, 1 + j, 0, 0} | |
| \sqrt{1/2} {0, 0, 1 + j, 0, 0, 0, 1 + j, 0, 0, 0, 1 + j, 0, 0, 0, 0, 0, 0, | 2.2303 dB |
| 0, −1 − j, 0, 0, 0, 1 + j, 0, 0, 0, −1 − j, 0, 0} | |
| \sqrt{1/2} {0, 0, −1 − j, 0, 0, 0, −1 − j, 0, 0, 0, −1 − j, 0, 0, | 2.2303 dB |
| 0, 0, 0, 0, 0, 1 + j, 0, 0, 0, −1 − j, 0, 0, 0, 1 + j, 0, 0} | |
| \sqrt{1/2} {0, 0, 1 + j, 0, 0, 0, 1 + j, 0, 0, 0, −1 − j, 0, 0, 0, 0, 0, | 3.3095 dB |
| 0, 0, −1 − j, 0, 0, 0, −1 − j, 0, 0, 0, 1 + j, 0, 0} | |
| \sqrt{1/2} {0, 0, 1 + j, 0, 0, 0, −1 − j, 0, 0, 0, −1 − j, 0, 0, 0, 0, | 3.3095 dB |
| 0, 0, 0, −1 − j, 0, 0, 0, 1 + j, 0, 0, 0, 1 + j, 0, 0} | |
| \sqrt{1/2} {0, 0, −1 − j, 0, 0, 0, 1 + j, 0, 0, 0, 1 + j0, 0, 0, 0, 0, 0, | 3.3095 dB |
| 0, 1 + j, 0, 0, 0, −1 − j, 0, 0, 0, −1 − j, 0, 0} | |
| \sqrt{1/2} {0, 0, −1 − j, 0, 0, 0, −1 − j, 0, 0, 0, 1 + j, 0, 0, 0, 0, | 3.3095 dB |
| 0, 0, 0, 1 + j, 0, 0, 0, 1 + j, 0, 0, 0, −1 − j, 0, 0} | |
| \sqrt{1/2} {0, 0, 1 + j, 0, 0, 0, 1 + j, 0, 0, 0, 1 + j, 0, 0, 0, 0, 0, 0, | 4.2597 dB |
| 0, 1 + j, 0, 0, 0, −1 − j, 0, 0, 0, 1 + j, 0, 0} | |
| \sqrt{1/2} {0, 0, 1 + j, 0, 0, 0, 1 + j, 0, 0, 0, −1 − j, 0, 0, 0, 0, 0, | 4.2597 dB |
| 0, 0, −1 − j, 0, 0, 0, 1 + j, 0, 0, 0, −1 − j, 0, 0} | |

Accordingly, the STF sequences 512 of Table 9 can correspond to STF sequences with optimally low PAPR values for a 32-point FFT for the third allocation shown in FIG. 6. The STF sequences 512 can correspond to training sequences with low PAPR values when using a four times oversampled IFFT.

In another embodiment, STF sequences 512 for the third allocation of FIG. 6 can also be determined for use with an extended range mode. As described above, rather than selecting every fourth pilot or data subcarrier to be modulated with a non-zero value, for an extended range mode, every two pilot or data subcarriers can be modulated with a non-zero value. Table 10 below shows STF sequences 512 optimized for low PAPR for the third allocation shown in FIG. 6 where the values for pilot and data subcarriers are chosen from either \sqrt{1/2}(1+j) or \sqrt{1/2}(−1−j) and where the non-zero values correspond to subcarriers having indices that are multiples of two in the spectral line of M_{-14:14}.

TABLE 10

| M−14:14 | PAPR |
|---|---|
| \sqrt{1/2} {0, 0, 1 + j, 0, 1 + j, 0, 1 + j, 0, −1 − j, 0, −1 − j, | 2.0589 dB |
| 0, −1 − j, 0, 0, 0, −1 − j, 0, 1 + j, 0, −1 − j, 0, −1 − | |
| j, 0, 1 + j, 0, −1 − j, 0, 0} | |
| \sqrt{1/2} {0, 0, 1 + j, 0, −1 − j, 0, 1 + j, 0, 1 + j, 0, −1 − j, 0, | 2.0589 dB |
| 1 + j, 0, 0, 0, 1 + j, 0, 1 + j, 0, 1 + j, 0, −1 − j, 0, −1 − | |
| j, 0, −1 − j, 0, 0} | |
| \sqrt{1/2} {0, 0, −1 − j, 0, 1 + j, 0, −1 − j, 0, −1 − j, 0, 1 + j, | 2.0589 dB |
| 0, −1 − j, 0, 0, 0, −1 − j, 0, −1 − j, 0, −1 − | |
| j, 0, 1 + j, 0, 1 + j, 0, 1 + j, 0, 0} | |
| \sqrt{1/2} {0, 0, −1 − j, 0, −1 − j, 0, −1 − j, 0, 1 + j, 0, 1 + j, | 2.0589 dB |
| 0, 1 + j, 0, 0, 0, 1 + j, 0, −1 − j, 0, 1 + j, 0, 1 + j, 0, −1 − | |
| j, 0, 1 + j, 0, 0} | |
| \sqrt{1/2} {0, 0, 1 + j, 0, 1 + j, 0, 1 + j, 0, 1 + j, 0, −1 − j, 0, | 2.2394 dB |
| −1 − j, 0, 0, 0, 1 + j, 0, −1 − j, 0, −1 − j, 0, 1 + j, 0, −1 − | |
| j, 0, 1 + j, 0, 0} | |
| \sqrt{1/2} {0, 0, 1 + j, 0, −1 − j, 0, 1 + j, 0, −1 − j, 0, −1 − j, | 2.2394 dB |
| 0, 1 + j, 0, 0, 0, −1 − j, 0, −1 − | |
| j, 0, 1 + j, 0, 1 + j, 0, 1 + j, 0, 0} | |
| \sqrt{1/2} {0, 0, −1 − j, 0, 1 + j, 0, −1 − j, 0, 1 + j, 0, 1 + j, 0, | 2.2394 dB |
| −1 − j, 0, 0, 0, 1 + j, 0, 1 + j, 0, −1 − j, 0, −1 − j, 0, −1 − | |
| j, 0, −1 − j, 0, 0} | |
| \sqrt{1/2} {0, 0, −1 − j, 0, −1 − j, 0, −1 − j, 0, −1 − j, 0, 1 + j, | 2.2394 dB |
| 0, 1 + j, 0, 0, 0, −1 − j, 0, 1 + j, 0, 1 + j, 0, −1 − | |
| j, 0, 1 + j, 0, −1 − j, 0, 0} | |
| \sqrt{1/2} {0, 0, 1 + j, 0, 1 + j, 0, 1 + j, 0, 1 + j, 0, 1 + j, 0, −1 − j, | 2.2974 dB |
| 0, 0, 0, −1 − j, 0, 1 + j, 0, 1 + j, 0, −1 − j, 0, −1 − | |
| j, 0, 1 + j, 0, 0} | |
| \sqrt{1/2} {0, 0, −1 − j, 0, −1 − j, 0, −1 − j, 0, −1 − j, 0, −1 − j, | 2.2974 dB |
| 0, 1 + j, 0, 0, 0, 1 + j, 0, −1 − j, 0, −1 − | |
| j, 0, 1 + j, 0, 1 + j, 0, −1 − j, 0, 0} | |

Accordingly, the STF sequences 512 of Table 10 can correspond to STF sequences with optimally low PAPR values for a 32-point FFT for the third allocation shown in FIG. 6 for use with an extended range mode. The STF sequences 512 can correspond to training sequences with low PAPR values when using a four times oversampled IFFT.

In another embodiment, LTF sequences 514 for the third allocation of FIG. 6 can be determined Table 11 below shows LTF sequences optimized for low PAPR where the values for all the data and pilot subcarriers are chosen from either +1 or −1 in the spectral line of LTF_{-14:14}.

TABLE 11

| LTF_{-14:14} | PAPR |
|---|---|
| {1, −1, 1, 1, −1, −1, 1, −1, −1, 1, −1, 1, −1, 1, 0, −1, | 1.8230 dB |
| −1, −1, −1, −1, −1, 1, 1, 1, −1, −1, 1, 1, 1} | |
| {1, 1, 1, 1, 1, 1, −1, −1, 1, 1, 1, −1, −1, −1, 0, 1, −1, 1, 1, −1, | 1.8884 dB |
| 1, 1, −1, −1, 1, −1, 1, −1, 1} | |
| {1, −1, 1, −1, 1, −1, 1, 1, −1, −1, −1, 1, 1, −1, 0, −1, −1, | 2.2242 dB |
| 1, 1, −1, 1, 1, −1, −1, −1, −1, −1, −1, −1} | |
| {1, 1, 1, 1, −1, −1, −1, 1, 1, 1, −1, 1, 1, 1, 0, −1, 1, −1, −1, | 2.2377 dB |
| −1, 1, −1, −1, 1, −1, −1, 1, −1, 1} | |
| {1, 1, 1, −1, −1, 1, 1, 1, −1, −1, −1, −1, −1, −1, 0, 1, −1, | 2.2753 dB |
| 1, 1, −1, −1, 1, −1, −1, 1, −1, 1, −1, 1} | |
| {1, 1, 1, 1, 1, 1, 1, 1, −1, −1, −1, 1, −1, 1, 0, 1, −1, −1, 1, | 2.2825 dB |
| −1, 1, 1, −1, 1, −1, −1, 1, 1, −1} | |
| {1, 1, 1, −1, −1, −1, −1, −1, −1, −1, 1, −1, 1, −1, 0, 1, | 2.3065 dB |
| −1, 1, −1, −1, 1, 1, −1, 1, 1, −1, −1, 1, 1} | |
| {1, −1, −1, 1, −1, 1, −1, −1, 1, −1, −1, −1, 1, −1, 0, | 2.3124 dB |
| −1, −1, −1, 1, −1, −1, −1, 1, 1, 1, 1, 1, −1, −1} | |
| {1, −1, 1, −1, 1, −1, 1, 1, −1, 1, 1, 1, 1, 1, 0, −1, −1, 1, 1, | 2.3161 dB |
| −1, −1, 1, −1, −1, −1, −1, 1, 1, −1} | |
| {1, 1, −1, −1, −1, −1, 1, −1, −1, −1, −1, 1, 1, 1, 0, | 2.3407 dB |
| 1, 1, −1, −1, 1, 1, −1, 1, 1, 1, −1, 1, −1, 1} | |

Accordingly, the LTF sequences 514 of Table 11 can correspond to LTF sequences with optimally low PAPR values for a 32-point FFT for the third allocation shown in FIG. 6. The LTF sequences 514 can correspond to training sequences with low PAPR values when using a four times oversampled IFFT.

In another embodiment, LTF sequences 514 for the third allocation of FIG. 6 can be determined for use with single stream pilots. Table 12 below shows LTF sequences optimized for low PAPR where the values for all the data and pilot subcarriers are chosen from either +1 or −1 in the spectral line of LTF_{-14:14}, the pilot subcarriers have indices of −7 and +7 for the spectral line, and the LTF sequences are chose to minimize the maximal PAPR for all possible P and R values for up to 4 streams to transmit.

TABLE 12

| LTF_{-14:14} | PAPR |
|---|---|
| {1, 1, −1, 1, −1, 1, −1, 1, 1, −1, −1, 1, 1, −1, 0, −1, −1, | 2.8723 dB |
| 1, 1, −1, −1, 1, 1, 1, 1, 1, 1, 1, −1} | |
| {1, 1, 1, 1, 1, 1, 1, 1, −1, −1, −1, 1, 1, −1, 0, 1, 1, −1, −1, 1, | 3.0514 dB |
| −1, −1, 1, −1, 1, −1, 1, −1, 1} | |
| {1, 1, 1, 1, 1, −1, −1, 1, 1, 1, −1, −1, 1, −1, 0, −1, −1, −1, 1, | 3.0559 dB |
| 1, −1, 1, 1, −1, −1, 1, −1, 1, −1} | |
| {1, 1, −1, 1, 1, −1, −1, 1, −1, −1, 1, −1, 1, −1, 0, −1, −1, | 3.0929 dB |
| −1, −1, −1, 1, 1, 1, −1, −1, 1, 1, 1, −1} | |
| {1, 1, −1, −1, 1, 1, 1, 1, −1, 1, 1, −1, 1, 1, 0, −1, −1, −1, | 3.0989 dB |
| −1, −1, 1, 1, −1, 1, −1, 1, −1, 1, −1} | |
| {1, −1, −1, 1, 1, 1, 1, 1, 1, 1, 1, −1, 1, −1, 0, 1, 1, −1, 1, −1, | 3.1115 dB |
| −1, 1, −1, 1, −1, 1, 1, −1, −1} | |
| {1, 1, −1, 1, 1, −1, 1, 1, −1, −1, −1, −1, −1, −1, 0, −1, | 3.1383 dB |
| 1, −1, 1, −1, 1, 1, −1, −1, −1, 1, 1, 1, −1} | |
| {1, 1, 1, 1, 1, 1, 1, 1, −1, −1, 1, 1, −1, −1, 0, 1, −1, 1, 1, 1, | 3.1419 dB |
| −1, −1, −1, −1, 1, 1, −1, 1, −1} | |
| {1, 1, 1, 1, −1, −1, −1, 1, 1, −1, −1, −1, 1, −1, 0, −1, | 3.1539 dB |
| −1, −1, 1, −1, −1, 1, 1, −1, 1, 1, −1, 1, −1} | |
| {1, 1, 1, −1, 1, −1, 1, 1, −1, 1, 1, 1, −1, −1, 0, 1, −1, −1, 1, | 3.1663 dB |
| −1, −1, −1, 1, 1, 1, 1, 1, −1, 1} | |

Accordingly, the LTF sequences 514 of Table 12 can correspond to LTF sequences with optimally low PAPR values for a 32-point FFT for use with single stream pilots for the third allocation shown in FIG. 6. The LTF sequences 514 can correspond to training sequences with low PAPR values when using a four times oversampled IFFT.

According to another embodiment, STF and LTF sequences 512 and 514 with low PAPR values are identified for the fourteenth subcarrier allocation of FIG. 6. In the fourteenth sub-carrier allocation, there are 5 guard subcarriers 604, 1 DC subcarrier 606, 2 pilot subcarriers 610 at {−9,+5}, and 24 data subcarriers 612. The guard subcarriers can correspond to the first three subcarriers and the last two subcarriers. As described above, values of zero are chosen for the guard subcarriers and the DC subcarrier. The DC tone can be located at index 0 in the spectral line. Table 13 below shows STF sequences 512 optimized for low PAPR for the fourteenth allocation shown in FIG. 6 where the values for pilot and data subcarriers are chosen from either \sqrt{1/2}(1+j) or \sqrt{1/2}(−1−j) where the non-zero values correspond to subcarriers having indices that are multiples of four in the spectral line of S_{-13:13}.

TABLE 13

| S_{-13:13} | PAPR |
|---|---|
| \sqrt{1/2} {0, 1 + j, 0, 0, 0, −1 − j, 0, 0, 0, 1 + j, 0, 0, 0, 0, 0, 0, 0, | 2.2303 dB |
| −1 − j, 0, 0, 0, −1 − j, 0, 0, 0, −1 − j, 0} | |
| \sqrt{1/2} {0, −1 − j, 0, 0, 0, 1 + j, 0, 0, 0, −1 − j, 0, 0, 0, 0, 0, | 2.2303 dB |
| 0, 0, 1 + j, 0, 0, 0, 1 + j, 0, 0, 0, 1 + j, 0} | |
| \sqrt{1/2} {0, 1 + j, 0, 0, 0, 1 + j, 0, 0, 0, 1 + j, 0, 0, 0, 0, 0, 0, 0, | 2.2303 dB |
| −1 − j, 0, 0, 0, 1 + j, 0, 0, 0, −1 − j, 0} | |
| \sqrt{1/2} {0, −1 − j, 0, 0, 0, −1 − j, 0, 0, 0, −1 − j, 0, 0, 0, | 2.2303 dB |
| 0, 0, 0, 0, 1 + j, 0, 0, 0, −1 − j, 0, 0, 0, 1 + j, 0} | |
| \sqrt{1/2} {0, 1 + j, 0, 0, 0, 1 + j, 0, 0, 0, −1 − j, 0, 0, 0, 0, 0, 0, | 3.3095 dB |
| 0, −1 − j, 0, 0, 0, −1 − j, 0, 0, 0, 1 + j, 0} | |
| \sqrt{1/2} {0, 1 + j, 0, 0, 0, −1 − j, 0, 0, 0, −1 − j, 0, 0, 0, 0, 0, | 3.3095 dB |
| 0, 0, −1 − j, 0, 0, 0, 1 + j, 0, 0, 0, 1 + j, 0} | |
| \sqrt{1/2} {0, −1 − j, 0, 0, 0, 1 + j, 0, 0, 0, 1 + j0, 0, 0, 0, 0, 0, 0, | 3.3095 dB |
| 1 + j, 0, 0, 0, −1 − j, 0, 0, 0, −1 − j, 0} | |
| \sqrt{1/2} {0, −1 − j, 0, 0, 0, −1 − j, 0, 0, 0, 1 + j, 0, 0, 0, 0, 0, | 3.3095 dB |
| 0, 0, 1 + j, 0, 0, 0, 1 + j, 0, 0, 0, −1 − j, 0} | |
| \sqrt{1/2} {0, 1 + j, 0, 0, 0, 1 + j, 0, 0, 0, 1 + j, 0, 0, 0, 0, 0, 0, 0, | 4.2597 dB |
| 1 + j, 0, 0, 0, −1 − j, 0, 0, 0, 1 + j, 0} | |
| \sqrt{1/2} {0, 1 + j, 0, 0, 0, 1 + j, 0, 0, 0, −1 − j, 0, 0, 0, 0, 0, | 4.2597 dB |
| 0, 0, −1 − j, 0, 0, 0, 1 + j, 0, 0, 0, −1 − j, 0} | |

Accordingly, the STF sequences 512 of Table 13 can correspond to STF sequences with optimally low PAPR values for a 32-point FFT for the fourteenth allocation shown in FIG. 6. The STF sequences 512 can correspond to training sequences with low PAPR values when using a four times oversampled IFFT.

In another embodiment, STF sequences 512 for the fourteenth allocation of FIG. 6 can also be determined for use with an extended range mode. As described above, rather than selecting every fourth pilot or data subcarrier to be modulated with a non-zero value, for an extended range mode, every two pilot or data subcarriers can be modulated with a non-zero value. Table 14 below shows STF sequences 512 optimized for low PAPR for the fourteenth allocation shown in FIG. 6 where the values for pilot and data subcarriers are chosen from either \sqrt{1/2}(1+j) or \sqrt{1/2}(−1−j) and where the non-zero values correspond to subcarriers having indices that are multiples of two in the spectral line of M_{-13:13}.

TABLE 14

| M−13:13 | PAPR |
|---|---|
| \sqrt{1/2} {0, 1 + j, 0, 1 + j, 0, 1 + j, 0, −1 − j, 0, −1 − j, 0, −1 − j, | 2.0589 dB |
| 0, 0, 0, −1 − j, 0, 1 + j, 0, −1 − j, 0, −1 − j, 0, 1 + j, 0, −1 − | |
| j, 0} | |
| \sqrt{1/2} {0, 1 + j, 0, −1 − j, 0, 1 + j, 0, 1 + j, 0, −1 − j, 0, 1 + j, | 2.0589 dB |
| 0, 0, 0, 1 + j, 0, 1 + j, 0, 1 + j, 0, −1 − j, 0, −1 − j, 0, −1 − | |
| j, 0} | |
| \sqrt{1/2} {0, −1 − j, 0, 1 + j, 0, −1 − j, 0, −1 − j, 0, 1 + j, 0, | 2.0589 dB |
| −1 − j, 0, 0, 0, −1 − j, 0, −1 − j, 0, −1 − | |
| j, 0, 1 + j, 0, 1 + j, 0, 1 + j, 0} | |
| \sqrt{1/2} {0, −1 − j, 0, −1 − j, 0, −1 − j, 0, 1 + j, 0, 1 + j, 0, | 2.0589 dB |
| 1 + j, 0, 0, 0, 1 + j, 0, −1 − j, 0, 1 + j, 0, 1 + j, 0, −1 − | |
| j, 0, 1 + j, 0} | |
| \sqrt{1/2} {0, 1 + j, 0, 1 + j, 0, 1 + j, 0, 1 + j, 0, −1 − j, 0, −1 − j, | 2.2394 dB |
| 0, 0, 0, 1 + j, 0, −1 − j, 0, −1 − j, 0, 1 + j, 0, −1 − | |
| j, 0, 1 + j, 0} | |
| \sqrt{1/2} {0, 1 + j, 0, −1 − j, 0, 1 + j, 0, −1 − j, 0, −1 − j, 0, | 2.2394 dB |
| 1 + j, 0, 0, 0, −1 − j, 0, −1 − j, 0, 1 + j, 0, 1 + j, 0, | |
| 1 + j, 0, 1 + j, 0} | |
| \sqrt{1/2} {0, −1 − j, 0, 1 + j, 0, −1 − j, 0, 1 + j, 0, 1 + j, 0, | 2.2394 dB |
| −1 − j, 0, 0, 0, 1 + j, 0, 1 + j, 0, −1 − j, 0, −1 − j, 0, | |
| −1 − j, 0, −1 − j, 0} | |
| \sqrt{1/2} {0, −1 − j, 0, −1 − j, 0, −1 − j, 0, −1 − j, 0, 1 + j, | 2.2394 dB |
| 0, 1 + j, 0, 0, 0, −1 − j, 0, 1 + j, 0, 1 + j, 0, −1 − j, 0, 1 + j, | |
| 0, −1 − j, 0} | |
| \sqrt{1/2} {0, 1 + j, 0, 1 + j, 0, 1 + j, 0, 1 + j, 0, 1 + j, 0, −1 − j, | 2.2974 dB |
| 0, 0, 0, −1 − j, 0, 1 + j, 0, 1 + j, 0, −1 − j, 0, −1 − | |
| j, 0, 1 + j, 0} | |
| \sqrt{1/2} {0, −1 − j, 0, −1 − j, 0, −1 − j, 0, −1 − j, 0, −1 − j, 0, | 2.2974 dB |
| 1 + j, 0, 0, 0, 1 + j, 0, −1 − j, 0, −1 − j, 0, 1 + j, 0, 1 + j, | |
| 0, −1 − j, 0} | |

Accordingly, the STF sequences 512 of Table 14 can correspond to STF sequences with optimally low PAPR values for a 32-point FFT for the fourteenth allocation shown in FIG. 6. The STF sequences 512 can correspond to training sequences with low PAPR values when using a four times oversampled IFFT.

In another embodiment, LTF sequences 514 for the fourteenth allocation of FIG. 6 can be determined Table 15 below shows LTF sequences optimized for low PAPR where the values for all the data and pilot subcarriers are chosen from either +1 or −1 in the spectral line of LTF_{-13:13}.

TABLE 15

| LTF_{-13:13} | PAPR |
|---|---|
| {1, −1, 1, 1, −1, 1, 1, −1, 1, 1, 1, −1, 1, 0, −1, −1, −1, 1, −1, | 1.8365 dB |
| −1, −1, 1, 1, 1, −1, −1, −1} | |
| {1, −1, 1, −1, 1, −1, −1, 1, −1, −1, 1, 1, −1, 0, −1, −1, 1, | 1.9942 dB |
| 1, −1, −1, −1, 1, 1, 1, 1, 1, 1} | |
| {1, −1, 1, −1, 1, −1, 1, 1, −1, −1, −1, 1, 1, 0, 1, −1, −1, 1, | 2.0381 dB |
| −1, −1, 1, 1, 1, 1, 1, 1, 1} | |
| {1, −1, 1, −1, 1, 1, 1, 1, 1, 1, 1, 1, −1, 0, −1, −1, 1, −1, 1, 1, | 2.2113 dB |
| −1, −1, 1, 1, −1, −1, 1} | |
| {1, −1, 1, −1, 1, −1, −1, 1, 1, 1, −1, −1, 1, 0, 1, 1, −1, −1, | 2.3083 dB |
| 1, −1, −1, 1, 1, 1, 1, 1, 1} | |
| {1, 1, 1, −1, 1, −1, −1, −1, 1, 1, 1, 1, −1, 0, 1, 1, −1, 1, −1, | 2.3087 dB |
| −1, 1, −1, −1, −1, −1, 1, −1} | |
| {1, 1, 1, 1, 1, 1, 1, −1, −1, 1, −1, 1, −1, 0, −1, 1, 1, 1, −1, −1, | 2.3140 dB |
| −1, 1, 1, −1, 1, 1, −1} | |
| {1, 1, 1, 1, 1, −1, −1, −1, −1, −1, 1, −1, −1, 0, 1, −1, −1, | 2.3579 dB |
| −1, 1, −1, 1, −1, −1, 1, −1, 1, −1} | |
| {1, −1, −1, 1, 1, −1, −1, 1, −1, −1, 1, −1, 1, 0, 1, 1, 1, 1, 1, 1, | 2.3622 dB |
| 1, −1, −1, −1, 1, 1, 1} | |
| {1, 1, −1, −1, −1, −1, 1, 1, 1, 1, −1, 1, −1, 0, −1, 1, −1, | 2.3983 dB |
| −1, −1, 1, −1, −1, −1, −1, 1, −1, −1} | |

Accordingly, the LTF sequences 514 of Table 15 can correspond to LTF sequences with optimally low PAPR values for a 32-point FFT for the fourteenth allocation shown in FIG. 6. The LTF sequences 514 can correspond to training sequences with low PAPR values when using a four times oversampled IFFT.

In another embodiment, LTF sequences 514 for the fourteenth allocation of FIG. 6 can be determined for use with single stream pilots. Table 16 below shows LTF sequences optimized for low PAPR where the values for all the data and pilot subcarriers are chosen from either +1 or −1 in the spectral line of LTF_{-13:13}, the pilot subcarriers have indices of −9 and +5 for the spectral line, and the LTF sequences are chose to minimize the maximal PAPR for all possible P and R values for up to 4 streams to transmit.

TABLE 16

| LTF_{-13:13} | PAPR |
|---|---|
| {1, 1, 1, 1, 1, 1, 1, 1, −1, −1, −1, −1, 1, 0, 1, 1, −1, −1, 1, 1, | 2.9479 dB |
| −1, −1, 1, 1, −1, 1, −1} | |
| {1, 1, −1, −1, 1, 1, 1, −1, −1, −1, −1, −1, −1, 0, −1, | 2.9549 dB |
| 1, 1, −1, 1, 1, −1, −1, 1, −1, 1, −1, 1} | |
| {1, 1, −1, 1, 1, 1, −1, 1, 1, −1, 1, −1, −1, 0, −1, −1, 1, | 2.9803 dB |
| −1, 1, 1, 1, −1, −1, −1, 1, 1, 1} | |
| {1, 1, 1, 1, 1, 1, −1, 1, −1, 1, −1, −1, 1, 0, −1, 1, 1, −1, | 3.0624 dB |
| −1, −1, −1, 1, 1, 1, −1, −1, 1} | |
| {1, 1, −1, 1, 1, 1, −1, 1, 1, −1, 1, 1, −1, 0, 1, 1, 1, −1, −1, | 3.1362 dB |
| 1, 1, 1, 1, −1, −1, −1, −1} | |
| {1, 1, 1, 1, 1, −1, −1, 1, 1, −1, −1, −1, 1, 0, −1, −1, 1, | 3.1481 dB |
| −1, 1, −1, 1, −1, 1, 1, −1, 1, −1} | |
| {1, 1, 1, 1, 1, 1, 1, 1, −1, −1, 1, −1, −1, 0, 1, −1, 1, 1, 1, | 3.1521 dB |
| −1, −1, −1, 1, 1, −1, 1, −1} | |
| {1, −1, 1, −1, 1, 1, −1, 1, −1, −1, −1, 1, 1, 0, 1, 1, −1, | 3.1734 dB |
| −1, 1, −1, −1, −1, −1, 1, 1, −1, −1} | |
| {1, 1, −1, −1, 1, 1, −1, −1, −1, −1, −1, 1, 1, 0, 1, −1, | 3.2298 dB |
| −1, −1, −1, −1, −1, 1, −1, 1, −1, −1, 1} | |
| {1, 1, 1, −1, 1, −1, −1, −1, 1, −1, −1, −1, 1, 0, −1, | 3.2362 dB |
| −1, −1, 1, 1, −1, −1, 1, −1, 1, 1, −1, 1} | |

Accordingly, the LTF sequences 514 of Table 16 can correspond to LTF sequences with optimally low PAPR values for a 32-point FFT for use with single stream pilots for the fourteenth allocation shown in FIG. 6. The LTF sequences 514 can correspond to training sequences with low PAPR values when using a four times oversampled IFFT.

According to another embodiment, STF and LTF sequences 512 and 514 with low PAPR values are identified for the sixteenth subcarrier allocation of FIG. 6. In the sixteenth sub-carrier allocation, there are 7 guard subcarriers 604, 1 DC subcarrier 606, 2 pilot subcarriers 610 at {−9,+5}, and 22 data subcarriers 612. The guard subcarriers can correspond to the first four subcarriers and the last three subcarriers. As described above, values of zero are chosen for the guard subcarriers and the DC subcarrier. The DC tone can be located at index 0 in the spectral line. Table 12 below shows STF sequences 512 optimized for low PAPR for the sixteenth allocation shown in FIG. 6 where the values for pilot and data subcarriers are chosen from either \sqrt{1/2}(1+j) or \sqrt{1/2}(−1−j) where the non-zero values correspond to subcarriers having indices that are multiples of four in the spectral line of S_{-12:12}.

TABLE 17

| S_{-12:12} | PAPR |
|---|---|
| \sqrt{1/2} {1 + j, 0, 0, 0, −1 − j, 0, 0, 0, 1 + j, 0, 0, 0, 0, 0, 0, | 2.2303 dB |
| 0, −1 − j, 0, 0, 0, −1 − j, 0, 0, 0, −1 − j} | |
| \sqrt{1/2} {−1 − j, 0, 0, 0, 1 + j, 0, 0, 0, −1 − j, 0, 0, 0, 0, 0, 0, | 2.2303 dB |
| 0, 1 + j, 0, 0, 0, 1 + j, 0, 0, 0, 1 + j} | |
| \sqrt{1/2} {1 + j, 0, 0, 0, 1 + j, 0, 0, 0, 1 + j, 0, 0, 0, 0, 0, 0, 0, | 2.2303 dB |
| −1 − j, 0, 0, 0, 1 + j, 0, 0, 0, −1 − j} | |
| \sqrt{1/2} {−1 − j, 0, 0, 0, −1 − j, 0, 0, 0, −1 − j, 0, 0, 0, 0, 0, | 2.2303 dB |
| 0, 0, 1 + j, 0, 0, 0, −1 − j, 0, 0, 0, 1 + j} | |
| \sqrt{1/2} {1 + j, 0, 0, 0, 1 + j, 0, 0, 0, −1 − j, 0, 0, 0, 0, 0, 0, 0, | 3.3095 dB |
| −1 − j, 0, 0, 0, −1 − j, 0, 0, 0, 1 + j} | |
| \sqrt{1/2} {1 + j, 0, 0, 0, −1 − j, 0, 0, 0, −1 − j, 0, 0, 0, 0, 0, 0, | 3.3095 dB |
| 0, −1 − j, 0, 0, 0, 1 + j, 0, 0, 0, 1 + j} | |
| \sqrt{1/2} {−1 − j, 0, 0, 0, 1 + j, 0, 0, 0, 1 + j0, 0, 0, 0, 0, 0, 0, | 3.3095 dB |
| 1 + j, 0, 0, 0, −1 − j, 0, 0, 0, −1 − j} | |
| \sqrt{1/2} {−1 − j, 0, 0, 0, −1 − j, 0, 0, 0, 1 + j, 0, 0, 0, 0, 0, 0, | 3.3095 dB |
| 0, 1 + j, 0, 0, 0, 1 + j, 0, 0, 0, −1 − j} | |
| \sqrt{1/2} {1 + j, 0, 0, 0, 1 + j, 0, 0, 0, 1 + j, 0, 0, 0, 0, 0, 0, 0, | 4.2597 dB |
| 1 + j, 0, 0, 0, −1 − j, 0, 0, 0, 1 + j} | |
| \sqrt{1/2} {1 + j, 0, 0, 0, 1 + j, 0, 0, 0, −1 − j, 0, 0, 0, 0, 0, 0, | 4.2597 dB |
| 0, −1 − j, 0, 0, 0, 1 + j, 0, 0, 0, −1 − j} | |

Accordingly, the STF sequences 512 of Table 13 can correspond to STF sequences with optimally low PAPR values for a 32-point FFT for the sixteenth allocation shown in FIG. 6. The STF sequences 512 can correspond to training sequences with low PAPR values when using a four times oversampled IFFT.

In another embodiment, STF sequences 512 for the sixteenth allocation of FIG. 6 can also be determined for use with an extended range mode. As described above, rather than selecting every fourth pilot or data subcarrier to be modulated with a non-zero value, for an extended range mode, every two pilot or data subcarriers can be modulated with a non-zero value. Table 14 below shows STF sequences 512 optimized for low PAPR for the sixteenth allocation shown in FIG. 6 where the values for pilot and data subcarriers are chosen from either \sqrt{1/2}(1+j) or \sqrt{1/2}(−1−j) and where the non-zero values correspond to subcarriers having indices that are multiples of two in the spectral line of M_{-12:12}.

TABLE 18

| M−12:12 | PAPR |
|---|---|
| \sqrt{1/2} {1 + j, 0, 1 + j, 0, 1 + j, 0, −1 − j, 0, −1 − j, 0, −1 − j, 0, 0, 0, −1 − j, 0, 1 + j, 0, −1 − j, 0, −1 − j, 0, 1 + j, 0, −1 − | 2.0589 dB |
| j} | |
| \sqrt{1/2} {1 + j, 0, −1 − j, 0, 1 + j, 0, 1 + j, 0, −1 − j, 0, 1 + j, 0, 0, 0, 1 + j, 0, 1 + j, 0, 1 + j, 0, −1 − j, 0, −1 − j, 0, −1 − | 2.0589 dB |
| j} | |
| \sqrt{1/2} {−1 − j, 0, 1 + j, 0, −1 − j, 0, −1 − j, 0, 1 + j, 0, −1 − j, 0, 0, 0, −1 − j, 0, −1 − j, 0, −1 − | 2.0589 dB |
| j, 0, 1 + j, 0, 1 + j, 0, 1 + j} | |
| \sqrt{1/2} {−1 − j, 0, −1 − j, 0, −1 − j, 0, 1 + j, 0, 1 + j, 0, 1 + j, 0, 0, 0, 1 + j, 0, −1 − j, 0, 1 + j, 0, 1 + j, 0, −1 − | 2.0589 dB |
| j, 0, 1 + j} | |
| \sqrt{1/2} {1 + j, 0, 1 + j, 0, 1 + j, 0, 1 + j, 0, −1 − j, 0, −1 − j, 0, 0, 0, 1 + j, 0, −1 − j, 0, −1 − j, 0, 1 + j, 0, −1 − | 2.2394 dB |
| j, 0, 1 + j} | |
| \sqrt{1/2} {1 + j, 0, −1 − j, 0, 1 + j, 0, −1 − j, 0, −1 − j, 0, 1 + j, 0, 0, 0, −1 − j, 0, −1 − | 2.2394 dB |
| j, 0, 1 + j, 0, 1 + j, 0, 1 + j, 0, 1 + j} | |
| \sqrt{1/2} {−1 − j, 0, 1 + j, 0, −1 − j, 0, 1 + j, 0, 1 + j, 0, −1 − j, 0, 0, 0, 1 + j, 0, 1 + j, 0, −1 − j, 0, −1 − j, 0, −1 − j, 0, −1 − | 2.2394 dB |
| j} | |
| \sqrt{1/2} {−1 − j, 0, −1 − j, 0, −1 − j, 0, −1 − j, 0, 1 + j, 0, 1 + j, 0, 0, 0, −1 − j, 0, 1 + j, 0, 1 + j, 0, −1 − j, 0, 1 + j, 0, −1 − | 2.2394 dB |
| j} | |
| \sqrt{1/2} {1 + j, 0, 1 + j, 0, 1 + j, 0, 1 + j, 0, 1 + j, 0, −1 − j, 0, 0, 0, −1 − j, 0, 1 + j, 0, 1 + j, 0, −1 − j, 0, −1 − | 2.2974 dB |
| j, 0, 1 + j} | |
| \sqrt{1/2} {−1 − j, 0, −1 − j, 0, −1 − j, 0, −1 − j, 0, −1 − j, 0, 1 + j, 0, 0, 0, 1 + j, 0, −1 − j, 0, −1 − j, 0, 1 + j, 0, 1 + j, 0, −1 − | 2.2974 dB |
| j} | |

Accordingly, the STF sequences 512 of Table 14 can correspond to STF sequences with optimally low PAPR values for a 32-point FFT for the sixteenth allocation shown in FIG. 6. The STF sequences 512 can correspond to training sequences with low PAPR values when using a four times oversampled IFFT.

In another embodiment, LTF sequences 514 for the sixteenth allocation of FIG. 6 can be determined. Table 15 below shows LTF sequences optimized for low PAPR where the values for all the data and pilot subcarriers are chosen from either +1 or −1 in the spectral line of LTF_{-12:12}.

TABLE 19

| LTF_{-12:12} | PAPR |
|---|---|
| {1, 1, −1, −1, −1, −1, 1, 1, −1, 1, 1, −1, 0, 1, 1, 1, −1, 1, 1, −1, 1, −1, 1, −1, 1} | 1.8712 dB |
| {1, −1, −1, −1, 1, −1, −1, 1, 1, 1, 1, 1, 0, 1, −1, −1, 1, 1, 1, 1, −1, 1, −1, 1, 1} | 2.1749 dB |
| {1, 1, 1, 1, 1, 1, −1, −1, −1, 1, 1, 1, 0, −1, 1, 1, −1, 1, 1, −1, −1, 1, −1, 1, −1} | 2.1821 dB |
| {1, 1, 1, 1, −1, −1, −1, −1, −1, 1, −1, −1, 0, 1, −1, −1, −1, 1, −1, 1, −1, −1, 1, −1, 1} | 2.1847 dB |
| {1, −1, 1, −1, −1, −1, 1, 1, 1, −1, 1, 1, 0, 1, −1, −1, −1, 1, −1, −1, 1, −1, −1, −1, −1} | 2.2697 dB |
| {1, 1, −1, −1, −1, −1, −1, −1, −1, 1, 1, −1, 0, −1, −1, 1, 1, −1, 1, −1, 1, −1, 1, 1, −1} | 2.2899 dB |
| {1, 1, 1, 1, 1, −1, 1, 1, 1, 1, −1, −1, 0, −1, 1, −1, 1, −1, 1, 1, −1, −1, 1, 1, −1} | 2.3227 dB |
| {1, 1, 1, 1, 1, 1, −1, 1, −1, −1, −1, 1, 0, 1, 1, −1, 1, −1, −1, 1, 1, 1, −1, −1, 1} | 2.3775 dB |
| {1, 1, −1, −1, −1, 1, 1, 1, 1, 1, 1, −1, 0, −1, 1, −1, −1, −1, 1, −1, −1, 1, −1, −1, 1} | 2.3892 dB |
| {1, −1, −1, −1, 1, −1, −1, −1, 1, −1, 1, −1, 0, 1, −1, 1, −1, −1, 1, 1, 1, 1, 1, −1, −1} | 2.4027 dB |

Accordingly, the LTF sequences 514 of Table 15 can correspond to LTF sequences with optimally low PAPR values for a 32-point FFT for the sixteenth allocation shown in FIG. 6. The LTF sequences 514 can correspond to training sequences with low PAPR values when using a four times oversampled IFFT.

In another embodiment, LTF sequences 514 for the sixteenth allocation of FIG. 6 can be determined for use with single stream pilots. Table 16 below shows LTF sequences optimized for low PAPR where the values for all the data and pilot subcarriers are chosen from either +1 or −1 in the spectral line of LTF_{-12:12}, the pilot subcarriers have indices of −9 and +5 for the spectral line, and the LTF sequences are chose to minimize the maximal PAPR for all possible P and R values for up to 4 streams to transmit.

TABLE 20

| LTF_{-12:12} | PAPR |
|---|---|
| {1, 1, −1, 1, −1, 1, −1, −1, −1, 1, −1, 1, 0, −1, 1, 1, 1, 1, 1, −1, −1, 1, 1, 1, 1} | 3.1471 dB |
| {1, −1, −1, 1, −1, −1, −1, 1, 1, −1, −1, 1, 0, 1, 1, −1, −1, −1, −1, −1, −1, 1, −1, 1, −1} | 3.2485 dB |
| {1, −1, −1, 1, 1, 1, 1, 1, 1, −1, −1, 1, 0, −1, −1, −1, −1, 1, 1, −1, −1, 1, −1, 1, −1} | 3.2718 dB |
| {1, 1, 1, 1, −1, 1, −1, 1, 1, 1, −1, 1, 0, −1, −1, 1, −1, −1, 1, −1, 1, 1, 1, 1, −1} | 3.2942 dB |
| {1, −1, 1, 1, 1, 1, 1, −1, 1, 1, 1, −1, 0, 1, −1, −1, −1, 1, −1, 1, 1, 1, 1, −1, −1} | 3.3128 dB |
| {1, 1, 1, 1, 1, 1, 1, −1, 1, −1, −1, −1, 0, 1, 1, 1, −1, −1, −1, 1, 1, −1, 1, 1, −1} | 3.3163 dB |
| {1, −1, 1, 1, 1, 1, −1, −1, −1, 1, 1, 1, 0, 1, 1, 1, −1, 1, 1, −1, −1, 1, −1, −1, −1} | 3.3171 dB |
| {1, 1, 1, 1, 1, −1, 1, −1, 1, −1, −1, 1, 0, 1, −1, −1, −1, 1, 1, −1, −1, 1, −1, −1, 1} | 3.3237 dB |
| {1, −1, 1, 1, 1, 1, −1, −1, 1, −1, 1, 1, 0, 1, 1, 1, −1, 1, −1, −1, −1, 1, 1, −1, −1} | 3.3342 dB |
| {1, 1, −1, 1, 1, −1, 1, 1, 1, −1, −1, 1, 0, 1, −1, 1, 1, 1, 1, −1, −1, −1, −1, −1, 1} | 3.3429 dB |

Accordingly, the LTF sequences 514 of Table 16 can correspond to LTF sequences with optimally low PAPR values for a 32-point FFT for use with single stream pilots for the sixteenth allocation shown in FIG. 6. The LTF sequences 514 can correspond to training sequences with low PAPR values when using a four times oversampled IFFT.

According to another embodiment, STF and LTF sequences 512 and 514 with low PAPR values are identified for the twentieth subcarrier allocation of FIG. 6. In the twentieth sub-carrier allocation, there are 5 guard subcarriers 604, 1 DC subcarrier 606, 4 pilot subcarriers 610 at {−3,+3,−10,+10}, and 22 data subcarriers 612. The guard subcarriers can correspond to the first three subcarriers and the last two subcarriers. As described above, values of zero are chosen for the guard subcarriers and the DC subcarrier. The DC tone can be located at index 0 in the spectral line. Table 21 below shows STF sequences 512 optimized for low PAPR for the twentieth allocation shown in FIG. 6 where the values for pilot and data subcarriers are chosen from either \sqrt{1/2}(1+j) or \sqrt{1/2}(−1−j) where the non-zero values correspond to subcarriers having indices that are multiples of four in the spectral line of S_{-13:13}.

TABLE 21

| S_{-13:13} | PAPR |
|---|---|
| \sqrt{1/2} {0, 1 + j, 0, 0, 0, −1 − j, 0, 0, 0, 1 + j, 0, 0, 0, 0, 0, 0, 0, −1 − j, 0, 0, 0, −1 − j, 0, 0, 0, −1 − j, 0} | 2.2303 dB |
| \sqrt{1/2} {0, −1 − j, 0, 0, 0, 1 + j, 0, 0, 0, −1 − j, 0, 0, 0, 0, 0, 0, 0, 1 + j, 0, 0, 0, 1 + j, 0, 0, 0, 1 + j, 0} | 2.2303 dB |
| \sqrt{1/2} {0, 1 + j, 0, 0, 0, 1 + j, 0, 0, 0, 1 + j, 0, 0, 0, 0, 0, 0, 0, −1 − j, 0, 0, 0, 1 + j, 0, 0, 0, −1 − j, 0} | 2.2303 dB |
| \sqrt{1/2} {0, −1 − j, 0, 0, 0, −1 − j, 0, 0, 0, −1 − j, 0, 0, 0, 0, 0, 0, 0, 1 + j, 0, 0, 0, −1 − j, 0, 0, 0, 1 + j, 0} | 2.2303 dB |
| \sqrt{1/2} {0, 1 + j, 0, 0, 0, 1 + j, 0, 0, 0, −1 − j, 0, 0, 0, 0, 0, 0, 0, −1 − j, 0, 0, 0, −1 − j, 0, 0, 0, 1 + j, 0} | 3.3095 dB |
| \sqrt{1/2} {0, 1 + j, 0, 0, 0, −1 − j, 0, 0, 0, −1 − j, 0, 0, 0, 0, 0, 0, 0, −1 − j, 0, 0, 0, 1 + j, 0, 0, 0, 1 + j, 0} | 3.3095 dB |
| \sqrt{1/2} {0, −1 − j, 0, 0, 0, 1 + j, 0, 0, 0, 1 + j0, 0, 0, 0, 0, 0, 0, 1 + j, 0, 0, 0, −1 − j, 0, 0, 0, −1 − j, 0} | 3.3095 dB |
| \sqrt{1/2} {0, −1 − j, 0, 0, 0, −1 − j, 0, 0, 0, 1 + j, 0, 0, 0, 0, 0, 0, 0, 1 + j, 0, 0, 0, 1 + j, 0, 0, 0, −1 − j, 0} | 3.3095 dB |
| \sqrt{1/2} {0, 1 + j, 0, 0, 0, 1 + j, 0, 0, 0, 1 + j, 0, 0, 0, 0, 0, 0, 0, 1 + j, 0, 0, 0, −1 − j, 0, 0, 0, 1 + j, 0} | 4.2597 dB |
| \sqrt{1/2} {0, 1 + j, 0, 0, 0, 1 + j, 0, 0, 0, −1 − j, 0, 0, 0, 0, 0, 0, 0, −1 − j, 0, 0, 0, 1 + j, 0, 0, 0, −1 − j, 0} | 4.2597 dB |

Accordingly, the STF sequences 512 of Table 21 can correspond to STF sequences with optimally low PAPR values for a 32-point FFT for the twentieth allocation shown in FIG. 6. The STF sequences 512 can correspond to training sequences with low PAPR values when using a four times oversampled IFFT.

In another embodiment, STF sequences 512 for the twentieth allocation of FIG. 6 can also be determined for use with an extended range mode. As described above, rather than selecting every fourth pilot or data subcarrier to be modulated with a non-zero value, for an extended range mode, every two pilot or data subcarriers can be modulated with a non-zero value. Table 22 below shows STF sequences 512 optimized for low PAPR for the twentieth allocation shown in FIG. 6 where the values for pilot and data subcarriers are chosen from either \sqrt{1/2}(1+j) or \sqrt{1/2}(−1−j) and where the non-zero values correspond to subcarriers having indices that are multiples of two in the spectral line of M_{-13:13}.

TABLE 22

| M_{-13:13} | PAPR |
|---|---|
| \sqrt{1/2} {0, 1 + j, 0, 1 + j, 0, 1 + j, 0, −1 − j, 0, −1 − j, 0, −1 − j, 0, 0, 0, −1 − j, 0, 1 + j, 0, −1 − j, 0, −1 − | 2.0589 dB |
| j, 0, 1 + j, 0, −1 − j, 0} | |
| \sqrt{1/2} {0, 1 + j, 0, −1 − j, 0, 1 + j, 0, 1 + j, 0, −1 − j, 0, 1 + j, 0, 0, 0, 1 + j, 0, 1 + j, 0, 1 + j, 0, −1 − j, 0, −1 − j, 0, −1 − | 2.0589 dB |
| j, 0} | |
| \sqrt{1/2} {0, −1 − j, 0, 1 + j, 0, −1 − j, 0, −1 − j, 0, 1 + j, 0, −1 − j, 0, 0, 0, −1 − j, 0, −1 − j, 0, −1 − | 2.0589 dB |
| j, 0, 1 + j, 0, 1 + j, 0, 1 + j, 0} | |
| \sqrt{1/2} {0, −1 − j, 0, −1 − j, 0, −1 − j, 0, 1 + j, 0, 1 + j, 0, 1 + j, 0, 0, 0, 1 + j, 0, −1 − j, 0, 1 + j, 0, 1 + j, 0, −1 − | 2.0589 dB |
| j, 0, 1 + j, 0} | |
| \sqrt{1/2} {0, 1 + j, 0, 1 + j, 0, 1 + j, 0, 1 + j, 0, −1 − j, 0, −1 − j, 0, 0, 0, 1 + j, 0, −1 − j, 0, −1 − j, 0, 1 + j, 0, −1 − | 2.2394 dB |
| j, 0, 1 + j, 0} | |
| \sqrt{1/2} {0, 1 + j, 0, −1 − j, 0, 1 + j, 0, −1 − j, 0, −1 − j, 0, 1 + j, 0, 0, 0, −1 − j, 0, −1 − | 2.2394 dB |
| j, 0, 1 + j, 0, 1 + j, 0, 1 + j, 0, 1 + j, 0} | |
| \sqrt{1/2} {0, −1 − j, 0, 1 + j, 0, −1 − j, 0, 1 + j, 0, 1 + j, 0, −1 − j, 0, 0, 0, 1 + j, 0, 1 + j, 0, −1 − j, 0, −1 − j, 0, −1 − | 2.2394 dB |
| j, 0, −1 − j, 0} | |
| \sqrt{1/2} {0, −1 − j, 0, −1 − j, 0, −1 − j, 0, −1 − j, 0, 1 + j, 0, 1 + j, 0, 0, 0, −1 − j, 0, 1 + j, 0, 1 + j, 0, −1 − | 2.2394 dB |
| j, 0, 1 + j, 0, −1 − j, 0} | |
| \sqrt{1/2} {0, 1 + j, 0, 1 + j, 0, 1 + j, 0, 1 + j, 0, 1 + j, 0, −1 − j, 0, 0, 0, −1 − j, 0, 1 + j, 0, 1 + j, 0, −1 − j, 0, −1 − | 2.2974 dB |
| j, 0, 1 + j, 0} | |
| \sqrt{1/2} {0, −1 − j, 0, −1 − j, 0, −1 − j, 0, −1 − j, 0, −1 − j, 0, 1 + j, 0, 0, 0, 1 + j, 0, −1 − j, 0, −1 − | 2.2974 dB |
| j, 0, 1 + j, 0, 1 + j, 0, −1 − j, 0} | |

Accordingly, the STF sequences 512 of Table 22 can correspond to STF sequences with optimally low PAPR values for a 32-point FFT for the twentieth allocation shown in FIG. 6 for use with an extended range mode. The STF sequences 512 can correspond to training sequences with low PAPR values when using a four times oversampled IFFT.

In another embodiment, LTF sequences 514 for the twentieth allocation of FIG. 6 can be determined Table 23 below shows LTF sequences optimized for low PAPR where the values for all the data and pilot subcarriers are chosen from either +1 or −1 in the spectral line of LTF_{-13:13}.

TABLE 23

| LTF_{-13:13} | PAPR |
|---|---|
| {1, −1, 1, 1, −1, 1, 1, −1, 1, 1, 1, −1, 1, 0, −1, −1, −1, 1, −1, −1, −1, 1, 1, 1, −1, −1, −1} | 1.8365 dB |
| {1, −1, 1, −1, 1, −1, −1, 1, −1, −1, 1, 1, −1, 0, −1, −1, 1, 1, −1, −1, −1, 1, 1, 1, 1, 1, 1} | 1.9942 dB |
| {1, −1, 1, −1, 1, −1, 1, 1, −1, −1, −1, 1, 1, 0, 1, −1, −1, 1, −1, −1, 1, 1, 1, 1, 1, 1, 1} | 2.0381 dB |
| {1, −1, 1, −1, 1, 1, 1, 1, 1, 1, 1, 1, −1, 0, −1, −1, 1, −1, 1, 1, −1, −1, 1, 1, −1, −1, 1} | 2.2113 dB |
| {1, −1, 1, −1, 1, −1, −1, 1, 1, 1, −1, −1, 1, 0, 1, 1, −1, −1, 1, −1, −1, 1, 1, 1, 1, 1, 1} | 2.3083 dB |
| {1, 1, 1, −1, 1, −1, −1, −1, 1, 1, 1, 1, −1, 0, 1, 1, −1, 1, −1, −1, 1, −1, −1, −1, −1, 1, −1} | 2.3087 dB |
| {1, 1, 1, 1, 1, 1, 1, −1, −1, 1, −1, 1, −1, 0, −1, 1, 1, 1, −1, −1, −1, 1, 1, −1, 1, 1, −1} | 2.3140 dB |
| {1, 1, 1, 1, 1, −1, −1, −1, −1, −1, 1, −1, −1, 0, 1, −1, −1, −1, 1, −1, 1, −1, −1, 1, −1, 1, −1} | 2.3579 dB |
| {1, −1, −1, 1, 1, −1, −1, 1, −1, −1, 1, −1, 1, 0, 1, 1, 1, 1, 1, 1, 1, −1, −1, −1, 1, 1, 1} | 2.3622 dB |
| {1, 1, −1, −1, −1, −1, 1, 1, 1, 1, −1, 1, −1, 0, −1, 1, −1, −1, −1, 1, −1, −1, −1, −1, 1, −1, −1} | 2.3983 dB |

Accordingly, the LTF sequences 514 of Table 23 can correspond to LTF sequences with optimally low PAPR values for a 32-point FFT for the twentieth allocation shown in FIG. 6. The LTF sequences 514 can correspond to training sequences with low PAPR values when using a four times oversampled IFFT.

In another embodiment, LTF sequences 514 for the twentieth allocation of FIG. 6 can be determined for use with single stream pilots. Table 24 below shows LTF sequences optimized for low PAPR where the values for all the data and pilot subcarriers are chosen from either +1 or −1 in the spectral line of LTF_{-13:13}, the pilot subcarriers have indices of −10,−3 and +3,+10 for the spectral line, and the LTF sequences are chose to minimize the maximal PAPR for all possible P and R values for up to four streams to transmit.

TABLE 24

| LTF_{-13:13} | PAPR |
|---|---|
| {1, 1, 1, 1, −1, 1, 1, 1, −1, 1, −1, 1, −1, 0, 1, −1, −1, −1, 1, −1, −1, 1, 1, 1, 1, −1, −1} | 3.0990 dB |
| {1, 1, 1, 1, 1, −1, 1, 1, −1, 1, −1, 1, 1, 0, −1, −1, 1, 1, −1, −1, −1, 1, −1, 1, 1, 1, −1} | 3.1116 dB |
| {1, 1, 1, 1, 1, −1, −1, −1, 1, 1, −1, 1, −1, 0, 1, 1, −1, 1, −1, 1, 1, 1, −1, 1, 1, −1, −1} | 3.1187 dB |
| {1, 1, 1, 1, −1, −1, −1, 1, −1, 1, 1, 1, −1, 0, 1, −1, 1, 1, −1, −1, −1, −1, 1, −1, −1, −1, 1} | 3.1725 dB |
| {1, 1, −1, 1, −1, −1, −1, 1, 1, −1, 1, −1, 1, 0, 1, −1, −1, −1, 1, −1, −1, −1, −1, −1, −1, −1, 1} | 3.1895 dB |
| {1, 1, −1, 1, 1, 1, 1, −1, 1, −1, 1, 1, −1, 0, −1, −1, −1, 1, 1, 1, 1, −1, 1, 1, −1, −1, 1} | 3.2166 dB |
| {1, 1, 1, 1, 1, −1, −1, 1, 1, 1, −1, −1, 1, 0, 1, 1, −1, 1, 1, −1, −1, 1, −1, 1, −1, 1, −1} | 3.2489 dB |
| {1, 1, 1, 1, −1, −1, −1, −1, −1, 1, 1, −1, −1, 0, −1, 1, −1, −1, −1, 1, −1, 1, −1, 1, 1, −1, 1} | 3.2718 dB |
| {1, 1, −1, 1, −1, 1, 1, −1, 1, −1, −1, −1, 1, 0, −1, −1, 1, 1, −1, −1, 1, −1, −1, −1, −1, −1, 1} | 3.2771 dB |
| {1, 1, 1, 1, 1, 1, 1, 1, −1, −1, −1, −1, 1, 0, 1, −1, 1, −1, −1, −1, 1, 1, −1, −1, 1, 1, −1} | 3.2916 dB |

Accordingly, the LTF sequences 514 of Table 24 can correspond to LTF sequences with optimally low PAPR values for a 32-point FFT for use with single stream pilots for the twentieth allocation shown in FIG. 6. The LTF sequences 514 can correspond to training sequences with low PAPR values when using a four times oversampled IFFT.

According to another embodiment, STF and LTF sequences 512 and 514 with low

PAPR values are identified for the twenty-second subcarrier allocation of FIG. 6. In the twenty-second sub-carrier allocation, there are 7 guard subcarriers 604, 1 DC subcarrier 606, 4 pilot subcarriers 610 at {−3,+3, −10, +10}, and 20 data subcarriers 612. The guard subcarriers can correspond to the first 4 subcarriers and the last 3 subcarriers. As described above, values of zero are chosen for the guard subcarriers and the DC subcarrier. The DC tone can be located at index 0 in the spectral line. Table 25 below shows STF sequences 512 optimized for low PAPR for the twenty-second allocation shown in FIG. 6 where the values for pilot and data subcarriers are chosen from either \sqrt{1/2}(1+j) or \sqrt{1/2}(−1−j) where the non-zero values correspond to subcarriers having indices that are multiples of four in the spectral line of S_{-12:12}.

TABLE 25

| S_{-12:12} | PAPR |
|---|---|
| \sqrt{1/2} {1 + j, 0, 0, 0, −1 − j, 0, 0, 0, 1 + j, 0, 0, 0, 0, 0, 0, 0, −1 − j, 0, 0, 0, −1 − j, 0, 0, 0, −1 − j} | 2.2303 dB |
| \sqrt{1/2} {−1 − j, 0, 0, 0, 1 + j, 0, 0, 0, −1 − j, 0, 0, 0, 0, 0, 0, 0, 1 + j, 0, 0, 0, 1 + j, 0, 0, 0, 1 + j} | 2.2303 dB |
| \sqrt{1/2} {1 + j, 0, 0, 0, 1 + j, 0, 0, 0, 1 + j, 0, 0, 0, 0, 0, 0, 0, −1 − j, 0, 0, 0, 1 + j, 0, 0, 0, −1 − j} | 2.2303 dB |
| \sqrt{1/2} {−1 − j, 0, 0, 0, −1 − j, 0, 0, 0, −1 − j, 0, 0, 0, 0, 0, 0, 0, 1 + j, 0, 0, 0, −1 − j, 0, 0, 0, 1 + j} | 2.2303 dB |
| \sqrt{1/2} {1 + j, 0, 0, 0, 1 + j, 0, 0, 0, −1 − j, 0, 0, 0, 0, 0, 0, 0, −1 − j, 0, 0, 0, −1 − j, 0, 0, 0, 1 + j} | 3.3095 dB |
| \sqrt{1/2} {1 + j, 0, 0, 0, −1 − j, 0, 0, 0, −1 − j, 0, 0, 0, 0, 0, 0, 0, −1 − j, 0, 0, 0, 1 + j, 0, 0, 0, 1 + j} | 3.3095 dB |
| \sqrt{1/2} {−1 − j, 0, 0, 0, 1 + j, 0, 0, 0, 1 + j, 0, 0, 0, 0, 0, 0, 0, 1 + j, 0, 0, 0, −1 − j, 0, 0, 0, −1 − j} | 3.3095 dB |
| \sqrt{1/2} {−1 − j, 0, 0, 0, −1 − j, 0, 0, 0, 1 + j, 0, 0, 0, 0, 0, 0, 0, 1 + j, 0, 0, 0, 1 + j, 0, 0, 0, −1 − j} | 3.3095 dB |
| \sqrt{1/2} {1 + j, 0, 0, 0, 1 + j, 0, 0, 0, 1 + j, 0, 0, 0, 0, 0, 0, 0, 1 + j, 0, 0, 0, −1 − j, 0, 0, 0, 1 + j} | 4.2597 dB |
| \sqrt{1/2} {1 + j, 0, 0, 0, 1 + j, 0, 0, 0, −1 − j, 0, 0, 0, 0, 0, 0, 0, −1 − j, 0, 0, 0, 1 + j, 0, 0, 0, −1 − j} | 4.2597 dB |

Accordingly, the STF sequences 512 of Table 25 can correspond to STF sequences with optimally low PAPR values for a 32-point FFT for the twenty-second allocation shown in FIG. 6. The STF sequences 512 can correspond to training sequences with low PAPR values when using a four times oversampled IFFT.

In another embodiment, STF sequences 512 for the twenty-second allocation of FIG. 6 can also be determined for use with an extended range mode. As described above, rather than selecting every fourth pilot or data subcarrier to be modulated with a non-zero value, for an extended range mode, every two pilot or data subcarriers can be modulated with a non-zero value. Table 26 below shows STF sequences 512 optimized for low PAPR for the twenty-second allocation shown in FIG. 6 where the values for pilot and data subcarriers are chosen from either \sqrt{1/2}(1+j) or \sqrt{1/2}(−1−j) and where the non-zero values correspond to subcarriers having indices that are multiples of two in the spectral line of M_{-12:12}.

TABLE 26

| M−12:12 | PAPR |
|---|---|
| \sqrt{1/2} {1 + j, 0, 1 + j, 0, 1 + j, 0, −1 − j, 0, −1 − j, 0, −1 − j, 0, 0, 0, −1 − j, 0, 1 + j, 0, −1 − j, 0, −1 − j, 0, 1 + j, 0, −1 − | 2.0589 dB |
| j} | |
| \sqrt{1/2} {1 + j, 0, −1 − j, 0, 1 + j, 0, 1 + j, 0, −1 − j, 0, 1 + j, 0, 0, 0, 1 + j, 0, 1 + j, 0, 1 + j, 0, −1 − j, 0, −1 − j, 0, −1 − j} | 2.0589 dB |
| \sqrt{1/2} {−1 − j, 0, 1 + j, 0, −1 − j, 0, −1 − j, 0, 1 + j, 0, −1 − j, 0, 0, 0, −1 − j, 0, −1 − j, 0, −1 − | 2.0589 dB |
| j, 0, 1 + j, 0, 1 + j, 0, 1 + j} | |
| \sqrt{1/2} {−1 − j, 0, −1 − j, 0, −1 − j, 0, 1 + j, 0, 1 + j, 0, 1 + j, 0, 0, 0, 1 + j, 0, −1 − j, 0, 1 + j, 0, 1 + j, 0, −1 − j, 0, 1 + j} | 2.0589 dB |
| \sqrt{1/2} {1 + j, 0, 1 + j, 0, 1 + j, 0, 1 + j, 0, −1 − j, 0, −1 − j, 0, 0, 0, 1 + j, 0, −1 − j, 0, −1 − j, 0, 1 + j, 0, −1 − j, 0, 1 + j} | 2.2394 dB |
| \sqrt{1/2} {1 + j, 0, −1 − j, 0, 1 + j, 0, −1 − j, 0, −1 − j, 0, 1 + j, 0, 0, 0, −1 − j, 0, −1 − j, 0, 1 + j, 0, 1 + j, 0, 1 + j, 0, 1 + j} | 2.2394 dB |
| \sqrt{1/2} {−1 − j, 0, 1 + j, 0, −1 − j, 0, 1 + j, 0, 1 + j, 0, −1 − j, 0, 0, 0, 1 + j, 0, 1 + j, 0, −1 − j, 0, −1 − j, 0, −1 − j, 0, −1 − | 2.2394 dB |
| j} | |
| \sqrt{1/2} {−1 − j, 0, −1 − j, 0, −1 − j, 0, −1 − j, 0, 1 + j, 0, 1 + j, 0, 0, 0, −1 − j, 0, 1 + j, 0, 1 + j, 0, −1 − j, 0, 1 + j, 0, −1 − | 2.2394 dB |
| j} | |
| \sqrt{1/2} {1 + j, 0, 1 + j, 0, 1 + j, 0, 1 + j, 0, 1 + j, 0, −1 − j, 0, 0, 0, −1 − j, 0, 1 + j, 0, 1 + j, 0, −1 − j, 0, −1 − j, 0, 1 + j} | 2.2974 dB |
| \sqrt{1/2} {−1 − j, 0, −1 − j, 0, −1 − j, 0, −1 − j, 0, −1 − j, 0, 1 + j, 0, 0, 0, 1 + j, 0, −1 − j, 0, −1 − j, 0, 1 + j, 0, 1 + j, 0, −1 − | 2.2974 dB |
| j} | |

Accordingly, the STF sequences 512 of Table 26 can correspond to STF sequences with optimally low PAPR values for a 32-point FFT for the twenty-second allocation shown in FIG. 6. The STF sequences 512 can correspond to training sequences with low PAPR values when using a four times oversampled IFFT.

In another embodiment, LTF sequences 514 for the twenty-second allocation of FIG. 6 can be determined Table 27 below shows LTF sequences optimized for low PAPR where the values for all the data and pilot subcarriers are chosen from either +1 or −1 in the spectral line of LTF_{-12:12}.

TABLE 27

| LTF_{-12:12} | PAPR |
|---|---|
| {1, 1, −1, −1, −1, −1, 1, 1, −1, 1, 1, −1, 0, 1, 1, 1, −1, 1, 1, −1, 1, −1, 1, −1, 1} | 1.8712 dB |
| {1, −1, −1, −1, 1, −1, −1, 1, 1, 1, 1, 1, 0, 1, −1, −1, 1, 1, 1, 1, −1, 1, −1, 1, 1} | 2.1749 dB |
| {1, 1, 1, 1, 1, 1, −1, −1, −1, 1, 1, 1, 0, −1, 1, 1, −1, 1, 1, −1, −1, 1, −1, 1, −1} | 2.1821 dB |
| {1, 1, 1, 1, −1, −1, −1, −1, −1, 1, −1, −1, 0, 1, −1, −1, −1, 1, −1, 1, −1, −1, 1, −1, 1} | 2.1847 dB |
| {1, −1, 1, −1, −1, −1, 1, 1, 1, −1, 1, 1, 0, 1, −1, −1, −1, 1, −1, −1, 1, −1, −1, −1, −1} | 2.2697 dB |
| {1, 1, −1, −1, −1, −1, −1, −1, −1, 1, 1, −1, 0, −1, −1, 1, 1, −1, 1, −1, 1, −1, 1, 1, −1} | 2.2899 dB |
| {1, 1, 1, 1, 1, −1, 1, 1, 1, 1, −1, −1, 0, −1, 1, −1, 1, −1, 1, 1, −1, −1, 1, 1, −1} | 2.3227 dB |
| {1, 1, 1, 1, 1, 1, −1, 1, −1, −1, −1, 1, 0, 1, 1, −1, 1, −1, −1, 1, 1, 1, −1, −1, 1} | 2.3775 dB |
| {1, 1, −1, −1, −1, 1, 1, 1, 1, 1, 1, −1, 0, −1, 1, −1, −1, −1, 1, −1, −1, 1, −1, −1, 1} | 2.3892 dB |
| {1, −1, −1, −1, 1, −1, −1, −1, 1, −1, 1, −1, 0, 1, −1, 1, −1, −1, 1, 1, 1, 1, 1, −1, −1} | 2.4027 dB |

Accordingly, the LTF sequences 514 of Table 27 can correspond to LTF sequences with optimally low PAPR values for a 32-point FFT for the twenty-second allocation shown in FIG. 6. The LTF sequences 514 can correspond to training sequences with low PAPR values when using a four times oversampled IFFT.

In another embodiment, LTF sequences 514 for the twenty-second allocation of FIG. 6 can be determined for use with single stream pilots. Table 28 below shows LTF sequences optimized for low PAPR where the values for all the data and pilot subcarriers are chosen from either +1 or −1 in the spectral line of LTF_{-12:12}, the pilot subcarriers have indices of −10, −3, +3 and +10 for the spectral line, and the LTF sequences are chose to minimize the maximal PAPR for all possible P and R values for up to 4 streams to transmit.

TABLE 28

| LTF_{-12:12} | PAPR |
|---|---|
| {1, 1, 1, −1, 1, −1, 1, −1, −1, 1, 1, −1, 0, −1, 1, −1, −1, 1, −1, −1, −1, −1, −1, 1, 1} | 3.0103 dB |
| {1, 1, 1, −1, 1, 1, 1, −1, −1, −1, −1, 1, 0, 1, −1, 1, −1, −1, 1, −1, 1, 1, −1, 1, 1} | 3.0490 dB |
| {1, 1, 1, 1, −1, −1, −1, −1, 1, 1, −1, −1, 0, 1, −1, 1, −1, 1, −1, 1, 1, −1, 1, 1, −1} | 3.1686 dB |
| {1, 1, 1, −1, 1, 1, 1, 1, −1, 1, −1, −1, 0, −1, 1, 1, 1, −1, 1, −1, −1, 1, 1, −1, 1} | 3.2108 dB |
| {1, 1, 1, −1, −1, −1, 1, −1, −1, −1, 1, −1, 0, 1, 1, −1, 1, 1, −1, 1, −1, 1, 1, 1, 1} | 3.2417 dB |
| {1, −1, 1, 1, −1, 1, 1, 1, 1, 1, 1, 1, 0, −1, −1, 1, −1, 1, −1, −1, −1, 1, 1, 1, −1} | 3.2441 dB |
| {1, 1, 1, 1, 1, −1, 1, 1, −1, 1, −1, −1, 0, 1, 1, 1, −1, −1, 1, −1, −1, −1, 1, 1, −1} | 3.2814 dB |
| {1, −1, 1, −1, −1, −1, −1, 1, −1, 1, 1, −1, 0, 1, 1, 1, 1, −1, 1, 1, −1, −1, 1, 1, 1} | 3.3017 dB |
| {1, 1, 1, −1, 1, −1, −1, 1, −1, 1, 1, −1, 0, 1, 1, −1, −1, −1, −1, −1, 1, −1, −1, −1, 1} | 3.3335 dB |
| {1, −1, 1, 1, −1, −1, −1, −1, 1, 1, 1, 1, 0, 1, 1, −1, 1, 1, −1, −1, −1, 1, −1, 1, −1} | 3.3523 dB |

Accordingly, the LTF sequences 514 of Table 28 can correspond to LTF sequences with optimally low PAPR values for a 32-point FFT for use with single stream pilots for the twenty-second allocation shown in FIG. 6. The LTF sequences 514 can correspond to training sequences with low PAPR values when using a four times oversampled IFFT.

While the description above describes STF sequences and LTF sequences 512 and 514 for the allocations as shown in FIG. 6 and described above, it should be appreciated that STF sequences and LTF sequences that are optimized for low PAPR can also be generated for any of the other allocations according to the systems and methods described herein.

While the allocations described above with reference to FIG. 6 correspond to a 32-point FFT, training sequences. According to another embodiment, training sequences can be developed for a 64-point FFT implementation. For example a STF sequence can be optimized for low PAPR for a 64-point FFT. To differentiate 32-point FFT and 64-point FFT, two different periodicities can be used and detected. In one embodiment, for a 64-point FFT, there can be 7 guard subcarriers, 1 DC subcarrier 606, 4 pilot subcarriers 610, and 52 data subcarriers. For the STF sequence, the subcarriers corresponding to the guard subcarriers and DC subcarrier can be modulated with a value of zero. The position of the guard subcarriers can be divided and be at the beginning and the end of the spectral line of subcarriers. A limited number of data or pilot subcarriers for the STF sequence 512 are chosen to be modulated with non-zero values. The spectral line for all non guard symbols can be from −28:28 To achieve a low PAPR, the values for modulating the non-zero value subcarriers can be chosen from:

$$\{ {e}^{\pm j \frac{π}{4}} = \pm \sqrt{\frac{1}{2}} ( 1 + j ) \}$$

and can correspond to indices that are a multiple of 8 in the spectral line of S_{-28:28} (i.e., populating every eighth tone with the exception of the DC tone). The two values of \sqrt{1/2}(1+j) and \sqrt{1/2}(−1−j) can correspond to values that provide improved correlation for the detection of the presence of a packet while also additionally providing a value to allow a reduced PAPR for the STF sequence 512. Repeating non-zero values (e.g., ensuring the sequence has periodicity) and ensuring that there are an equal number of non-zero values on each side of the DC value provides good correlation and helps with packet detection. The values in Table 29 below shows short training sequences 512, according to certain embodiments, that have been determined to have low PAPR values using the choice of symbols as just described according to a 64-point size FFT.

TABLE 29

| S_{-13:13} | PAPR |
|---|---|
| \sqrt{1/2} {0, 0, 0, 0, 1 + j, 0, 0, 0, 0, 0, 0, 0, −1 − j, 0, 0, 0, 0, 0, 0, 0, 1 + j, 0, 0, 0, 0, 0, 0, 0, 0, 0, 0, 0, 0, 0, 0, 0, −1 − | 2.2303 dB |
| j, 0, 0, 0, 0, 0, 0, 0, −1 − j, 0, 0, 0, 0, 0, 0, 0, −1 − j, 0, 0, 0, 0} | |
| \sqrt{1/2} {0, 0, 0, 0, −1 − j, 0, 0, 0, 0, 0, 0, 0, 1 + j, 0, 0, 0, 0, 0, 0, 0, −1 − | 2.2303 dB |
| j, 0, 0, 0, 0, 0, 0, 0, 0, 0, 0, 0, 0, 0, 0, 0, 1 + j, 0, 0, 0, 0, 0, 0, 0, 1 + j, 0, 0, 0, 0, 0, 0, 0, 1 + j, 0, 0, 0, 0} | |
| \sqrt{1/2} {0, 0, 0, 0, 1 + j, 0, 0, 0, 0, 0, 0, 0, 1 + j, 0, 0, 0, 0, 0, 0, 0, 1 + j, 0, 0, 0, 0, 0, 0, 0, 0, 0, 0, 0, 0, 0, 0, 0, −1 − | 2.2303 dB |
| j, 0, 0, 0, 0, 0, 0, 0, 1 + j, 0, 0, 0, 0, 0, 0, 0, −1 − j, 0, 0, 0, 0} | |
| \sqrt{1/2} {0, 0, 0, 0, −1 − j, 0, 0, 0, 0, 0, 0, 0, −1 − j, 0, 0, 0, 0, 0, 0, 0, −1 − | 2.2303 dB |
| j, 0, 0, 0, 0, 0, 0, 0, 0, 0, 0, 0, 0, 0, 0, 0, 1 + j, 0, 0, 0, 0, 0, 0, 0, −1 − j, 0, 0, 0, 0, 0, 0, 0, 1 + j, 0, 0, 0, 0} | |
| \sqrt{1/2} {0, 0, 0, 0, 1 + j, 0, 0, 0, 0, 0, 0, 0, 1 + j, 0, 0, 0, 0, 0, 0, 0, −1 − j, 0, 0, 0, 0, 0, 0, 0, 0, 0, 0, 0, 0, 0, 0, 0, −1 − | 3.3095 dB |
| j, 0, 0, 0, 0, 0, 0, 0, −1 − j, 0, 0, 0, 0, 0, 0, 0, 1 + j, 0, 0, 0, 0} | |
| \sqrt{1/2} {0, 0, 0, 0, 1 + j, 0, 0, 0, 0, 0, 0, 0, −1 − j, 0, 0, 0, 0, 0, 0, 0, −1 − j, 0, 0, 0, 0, 0, 0, 0, 0, 0, 0, 0, 0, 0, 0, 0, −1 − | 3.3095 dB |
| j, 0, 0, 0, 0, 0, 0, 0, 1 + j, 0, 0, 0, 0, 0, 0, 0, 1 + j, 0, 0, 0, 0} | |
| \sqrt{1/2} {0, 0, 0, 0, −1 − | 3.3095 dB |
| j, 0, 0, 0, 0, 0, 0, 0, 1 + j, 0, 0, 0, 0, 0, 0, 0, 1 + j, 0, 0, 0, 0, 0, 0, 0, 0, 0, 0, 0, 0, 0, 0, 0, 1 + j, 0, 0, 0, 0, 0, 0, 0, −1 − | |
| j, 0, 0, 0, 0, 0, 0, 0, −1 − j, 0, 0, 0, 0} | |
| \sqrt{1/2} {0, 0, 0, 0, −1 − j, 0, 0, 0, 0, 0, 0, 0, −1 − | 3.3095 dB |
| j, 0, 0, 0, 0, 0, 0, 0, 1 + j, 0, 0, 0, 0, 0, 0, 0, 0, 0, 0, 0, 0, 0, 0, 0, 1 + j, 0, 0, 0, 0, 0, 0, 0, 1 + j, 0, 0, 0, 0, 0, 0, 0, −1 − | |
| j, 0, 0, 0, 0} | |
| \sqrt{1/2} {0, 0, 0, 0, 1 + j, 0, 0, 0, 0, 0, 0, 0, 1 + j, 0, 0, 0, 0, 0, 0, 0, 1 + j, 0, 0, 0, 0, 0, 0, 0, 0, 0, 0, 0, 0, 0, 0, 0, −1 − | 4.2597 dB |
| j, 0, 0, 0, 0, 0, 0, 0, 1 + j, 0, 0, 0, 0, 0, 0, 0, 1 + j, 0, 0, 0, 0} | |
| \sqrt{1/2} {0, 0, 0, 0, 1 + j, 0, 0, 0, 0, 0, 0, 0, 1 + j, 0, 0, 0, 0, 0, 0, 0, −1 − | 4.2597 dB |
| j, 0, 0, 0, 0, 0, 0, 0, 0, 0, 0, 0, 0, 0, 0, 0, 1 + j, 0, 0, 0, 0, 0, 0, 0, 1 + j, 0, 0, 0, 0, 0, 0, 0, 1 + j, 0, 0, 0, 0} | |

Accordingly, these STF sequences can correspond to optimally low PAPR values that can avoid distorting the short training sequence when transmitted while having good correlation properties for packet detection for a 64-point FFT. These sequences can correspond to training sequence with low PAPR values when using a four times oversampled IFFT.

The wireless device 202a can be configured to operate in FFT modes. For example, as just described, the wireless device 202a can be configured to use a 64-point FFT size in conjunction with a higher-bandwidth channel as compared to a 32-point FFT channel. For example, the 64-point FFT channel can have twice the bandwidth of the 32-point FFT channel. In one embodiment, the IFFT 304 can be configured to use a 64-point FFT size in conjunction with a 2 MHz channel, and the IFFT 304 can be configured to use a 32-point FFT channel in conjunction with a 1 MHz channel. In an embodiment, the IFFT 304 can be configured to selectively use a plurality of different FFT sizes. In another embodiment, a plurality of different IFFTs can be each configured to use a different FFT size, the output of which can be selectively routed to the DAC 306.

In one embodiment, the LTF sequence can be used to detect a specific operating mode (e.g., operating using 1 MHz versus 2 MHz). In one embodiment, the 1 MHz channel LTF sequence (32-point FFT) can be chosen such that the 1 MHz channel LTF sequence is substantially orthogonal in frequency from and LTF sequence used for 2 MHz (64-point FFT). The orthogonality can then be used to determine whether the LTF sequence is associated with the 1 MHz or 2 MHz mode. Ideally, the 32-point LTF (corresponding to the 1 MHz channel) can be perfectly orthogonal to both halves of the 64-point LTF (corresponding to the 2 MHz channel). However, as both halves of the 64-point LTF sequence cannot be identical, determining a single 32-point LTF sequence that is orthogonal to both halves of the 64-point FFT LTF can be difficult. In one aspect, orthogonality can be determined by deriving an orthogonality metric of the 32-point LTF for each of the halves of the 64-point LTF sequence. To distinguish between two LTF sequences (e.g., 32-point versus 64-point), it can be sufficient such that the orthogonality metric is small relative to the number of populated tones in the 32-point LTF sequence. In one embodiment, orthogonality can be determined by an orthogonality metric as shown by the equations below for each of the 32-point LTF sequence and the 64-point LTF sequence:

$${\sum }_{k} {P}_{32} ( k ) {{P}_{32} ( k + 1 )}^{*} {P}_{64 U} ( k + 1 ) {{P}_{64 U} ( k )}^{*} \approx 0 \qquad Equation 1$$

$${\sum }_{k} {P}_{32} ( k ) {{P}_{32} ( k + 1 )}^{*} {P}_{64 D} ( k + 1 ) {{P}_{64 D} ( k )}^{*} \approx 0 \qquad Equation 2$$

where P₃₂ corresponds to the 32-point LTF sequence, P_{64U} corresponds to the upper half of the 64-point LTF sequence (e.g., tones 1-32), and P_{64D} corresponds to the lower half of the 64-point LTF sequence (e.g., tones 33-64). In other words, orthogonality can be determined if an orthogonality metric of the 32-point FFT LTF and the upper or lower half of the 64 FFT LTF is substantially close to zero.

As such, 32-point FFT LTF sequences that minimize PAPR as described above can further be determined to minimize PAPR while being orthogonal to the 64-point LTF. As classification performance can not suffer as long as the orthogonality metric is small as compared to the number of tones, to balance low PAPR sequences with the ability to classify sequences (to detect the 1 MHz channel versus the 2 MHz channel), sequences with low PAPR can be identified with an orthogonality metric of less than or equal to five. For example, LTF sequences 514 can be determined for the fifth allocation shown in FIG. 6 that have low PAPR values while satisfying the orthogonality condition as described by Equations 1 and 2. For an LTF sequence, every subcarrier corresponding to a data subcarrier or a pilot subcarrier can be modulated with a non-zero symbol. To achieve a low PAPR, all the data and pilot symbol values can be chosen from either +1 or −1, and selected so as to minimize the PAPR ratio. The values in Table 30 below shows LTF sequences 512, according to certain embodiments, that have been determined to have low PAPR values using the choice of symbols as just described according to the fifth subcarrier allocation shown in FIG. 6 for the spectral line of −13:13 while being orthogonal to the 64-point FFT.

TABLE 30

| LTF_{-13:13} | PAPR |
|---|---|
| {1, −1, 1, 1, −1, 1, 1, −1, 1, 1, 1, −1, 1, 0, −1, −1, −1, 1, −1, −1, −1, 1, 1, 1, −1, −1, −1} | 1.8365 dB |
| {1, −1, 1, −1, 1, −1, −1, 1, −1, −1, 1, 1, −1, 0, −1, −1, 1, 1, −1, −1, −1, 1, 1, 1, 1, 1, 1} | 1.9942 dB |
| {1, −1, −1, 1, 1, −1, −1, 1, −1, −1, 1, −1, 1, 0, 1, 1, 1, 1, 1, 1, 1, −1, −1, −1, 1, 1, 1} | 2.3622 dB |

Accordingly, these LTF sequences 514 can correspond to optimally low PAPR values for the fifth allocation shown in FIG. 6 while also satisfying the orthogonality condition. The sequence with the lowest PAPR can have a maximum of absolute value of correlation (orthogonality metric) with either the upper or lower half of the 2 MHz LTF that is as small as 5 (given that there can be 24 overlapping tones between 1 MHz LTF and 2 MHz LTF, and 56 tones in 2 MHz LTF). As such, the lowest PAPR sequence in Table 30 can be substantially orthogonal to either the upper or lower half of the 2 MHz LTF. Power boosting can also be possible with the LTF. As described above, the full LTF sequence can include guard tones with zero values (e.g., 3 zeros from −16:−14 and 2 zeros from 14:15 in the spectral line. The sequences can correspond to training sequence with low PAPR values when using a four times oversampled IFFT.

Multiple LTF sequences spanning multiple LTF symbols of a preamble can introduce significant overhead. To reduce this overhead, the LTF sequences described can be used in conjunction with power boosting. For example, rather than sending 4 LTF symbols within the preamble for the 1 MHz channel, two LTF symbols (corresponding to two LTF sequences) can be used. The two LTF symbols can be power boosted (e.g., by 2 dB to 4 dB). Power boosting can allow the two LTF symbols to be sufficient for channel estimation, etc. while still taking advantage of LTF sequences with low PAPR as stated. Power boosting can only be done for transmissions where the data is encoded based on a 2× repetition of BPSK rate ½. As such the preamble structure can remove at least 2 LTF symbols that can reduce overhead.

The LTF field can additionally be used in conjunction with single stream pilots to track frequency drift over multiple LTF symbols that can be used to improve channel estimation. A preamble can have at least four LTF symbols that can be used for tracking frequency drift. Single stream pilots can be useful for both single stream transmissions as well as for estimating a MIMO channel and provides training for space time streams. When using single stream pilots, data subcarriers can be multiplied a matrix P before being transmitted while pilot subcarriers can be multiplied by a matrix R whose values can be different than the P matrix. This can allow for tracking phase offset and frequency offset during channel estimation at the receiver.

After multiplication by a matrix and transformation to a time domain signal, the resulting PAPR can be different when P matrix values are different than R matrix values. As such, having different P and R values results in different LTF sequences 514. Accordingly, according to embodiments as described above with respect to orthogonality, the LTF can be chosen by identifying a sequence that minimizes the maximal PAPR over all possible P and R matrix values:

$$LTF = {min}_{S} \{ {max}_{P , R} [ PAPR ( S , P , R ) ] \}$$

where S are the possible sequences for all chosen tone values that meet the orthogonality condition. As with the embodiment described above with reference to Table 30, data and pilot symbol values can be chosen from +1 or −1. As such, according to the fifth allocation of FIG. 6 where sub-carriers chosen for the pilot signals are at indices of −7, and +7 of the spectral line −13:13, where there are up to four streams to transmit, the LTF sequences 512 shown below in Table 31 have been determined to have low PAPR values for all possible P and R matrix values that satisfy the orthogonality condition.

TABLE 31

| | PAPR (4x |
|---|---|
| LTF_{-13:13} | OS) |
| {1, 1, −1, 1, 1, −1, −1, 1, −1, −1, −1, −1, −1, 0, −1, 1, −1, 1, −1, −1, 1, 1, 1, −1, −1, −1, 1} | 2.8580 dB |
| {1, 1, −1, −1, −1, −1, 1, −1, −1, 1, 1, 1, −1, 0, 1, −1, 1, 1, −1, −1, −1, 1, −1, 1, −1, 1, −1} | 3.0931 dB |
| {1, −1, 1, 1, −1, 1, 1, −1, −1, 1, −1, −1, −1, 0, −1, −1, −1, 1, −1, −1, −1, 1, 1, 1, −1, −1, −1} | 3.0984 dB |

Accordingly, the LTF sequences 514 of Table 4 can correspond to LTF sequences with optimally low PAPR values for a 32-point FFT for the fifth allocation shown in FIG. 6 for use with single stream pilots such that the 32-point FFT LTF is substantially orthogonal with both the upper and lower halves of the 64-point FFT LTF. The sequence with the lowest PAPR can have a maximum of absolute value of correlation (orthogonality metric) with either upper or lower half of the 2 MHz LTF that is as small as 5 (given that there can be 24 overlapping tones between 1 MHz LTF and 2 MHz LTF, and 56 tones in 2 MHz LTF). As described above, the full LTF sequence can include guard tones with zero values (e.g., 3 zeros from −16:−14 and 2 zeros from 14:15 in the spectral line. The LTF sequences 514 can correspond to training sequences with low PAPR values when using a four times oversampled IFFT.

In another embodiment, an STF sequence can be determined with low PAPR that can have good correlation properties and for which power boosting can also be possible. The STF sequence for 1 MHz can have non-zero values at indices {±4, ±8, ±12}. This can be used to ensure the same periodicity as a STF sequence for 2 MHz mode. As described above, tone values can be chosen from:

$$\{ {e}^{\pm j \frac{π}{4}} = \pm \sqrt{\frac{1}{2}} ( 1 + j ) \}$$

so as to preserve good correlation. An STF sequence can be determined for the lowest PAPR when using four times oversampled IFFT to also have a 3 db power boost capability for 2× repetition mode. Power boosting can accomplished for 2 MHz mode where PAPR(2 MHz STF) can be approximately 2.2394 db while the mean for PAPR(BPSK data))=6.8547 db. The PAPR of the 1 MHz STF should not be worse than 2 MHz STF. As such, when using non zero values at indices {±4, ±8, ±12}, an optimized 1 MHz STF sequence that minimizes the PAPR when using four times sampled IFFT are shown in Table 32 below according to the fifth subcarrier allocation shown in FIG. 6 that can allow for power boosting.

TABLE 32

| S_{-13:13} | PAPR |
|---|---|
| \sqrt{1/2} {0, 1, + j, 0, 0, 0, −1, − j, 0, 0, 0, 1, + j, 0, 0, 0, 0, 0, 0, 0, −1, − j, 0, 0, 0, −1, − j, 0, 0, 0, −1, − j, 0} | 2.2303 dB |
| \sqrt{1/2} {0, −1, − j, 0, 0, 0, 1, + j, 0, 0, 0, −1, − j, 0, 0, 0, 0, 0, 0, 0, 1, + j, 0, 0, 0, 1, + j, 0, 0, 0, 1, + j, 0} | 2.2303 dB |
| \sqrt{1/2} {0, 1, + j, 0, 0, 0, 1, + j, 0, 0, 0, 1, + j, 0, 0, 0, 0, 0, 0, 0, −1, − j, 0, 0, 0, 1, + j, 0, 0, 0, −1, − j, 0} | 2.2303 dB |
| \sqrt{1/2} {0, −1, − j, 0, 0, 0, −1, − j, 0, 0, 0, −1, − j, 0, 0, 0, 0, 0, 0, 0, 1, + j, 0, 0, 0, −1, − j, 0, 0, 0, 1, + j, 0} | 2.2303 dB |

Accordingly, these STF sequences can correspond to optimally low PAPR values that can avoid distorting the short training sequence when transmitted while having good correlation properties for packet detection for the fifth allocation shown in FIG. 6. These sequences can correspond to training sequence with low PAPR values when using a four times oversampled IFFT. Including guard tones, one entire sequence can be \sqrt{1/2}{0,1+j,0,0,0,−1−j,0,0,0,1+j,0,0,0,0,0,0,0,−1−j,0,0,0,−1−j,0,0,0,−1−j,0}. The sequences in Table 32 can correspond to STF sequences for 1 MHz that can have a PAPR that can be slightly lower than a 2 MHz STF that can be sufficient for power boosting purposes.

Thirty-two point FFT LTF sequences that minimize PAPR as described above can further be determined to minimize PAPR while being orthogonal to the 64-point LTF can further be derived for an additional tone allocation. As classification performance can not suffer as long as the orthogonality metric is small as compared to the number of tones, to balance low PAPR sequences with the ability to classify sequences (to detect the 1 MHz channel versus the 2 MHz channel), sequences with low PAPR can be identified with an orthogonality metric of less than or equal to five. The LTF sequences 514 can be determined for the twenty-eighth tone allocation shown in FIG. 6, with pilot tones at tone indexes {±5, ±10} that have low PAPR values while satisfying the orthogonality condition as described by Equations 1 and 2. As such the sequences can have seven guard tones, twenty data tones, one DC tone, and four pilot tones at indexes {±5, ±10}. For an LTF sequence, every subcarrier corresponding to a data subcarrier or a pilot subcarrier can be modulated with a non-zero symbol. To achieve a low PAPR, all the data and pilot symbol values can be chosen from either +1 or −1, and selected so as to minimize the PAPR ratio. The values in Table 33 below shows LTF sequences 512, according to certain embodiments, that have been determined to have low PAPR values using the choice of symbols as just described according to the twenty-eighth tone allocation shown in FIG. 6, for the spectral line of −12:12 while being orthogonal to the 64-point FFT.

TABLE 33

| LTF_{-12:12} | PAPR |
|---|---|
| {1, 1, −1, 1, −1, 1, 1, 1, 1, −1, −1, 1, 0, 1, 1, 1, 1, 1, −1, −1, | 2.1749 dB |
| 1, −1, −1, −1, 1} | |
| {1, −1, 1, −1, −1, −1, 1, 1, 1, −1, 1, 1, 0, 1, −1, −1, −1, 1, | 2.2697 dB |
| −1, −1, 1, −1, −1, −1, −1} | |
| {1, 1, −1, −1, −1, −1, −1, −1, −1, 1, 1, −1, 0, −1, −1, 1, | 2.2899 dB |
| 1, −1, 1, −1, 1, −1, 1, 1, −1} | |

Accordingly, these LTF sequences 514 can correspond to optimally low PAPR values for the twenty-eighth tone allocation shown in FIG. 6 while also satisfying the orthogonality condition. The sequence with the lowest PAPR can have a maximum of absolute value of correlation (orthogonality metric) with either the upper or lower half of the 2 MHz LTF that can be as small as 2 (given that there can be 24 overlapping tones between 1 MHz LTF and 2 MHz LTF, and 56 tones in 2 MHz LTF). As such, the lowest PAPR sequence in Table 33 can be substantially orthogonal to either the upper or lower half of the 2 MHz LTF. Power boosting can also be possible with the LTF. As described above, the full LTF sequence can include guard tones with zero values (e.g., 4 zeros from −16:−13 and 3 zeros from 13:15 in the spectral line. The sequences can correspond to training sequence with low PAPR values when using a four times oversampled IFFT.

Multiple LTF sequences spanning multiple LTF symbols of a preamble can introduce significant overhead. To reduce this overhead, the LTF sequences described can be used in conjunction with power boosting. For example, rather than sending 4 LTF symbols within the preamble for the 1 MHz channel, two LTF symbols (corresponding to two LTF sequences) can be used. The two LTF symbols can be power boosted (e.g., by 2 dB to 4 dB). Power boosting can allow the two LTF symbols to be sufficient for channel estimation, etc. while still taking advantage of LTF sequences with low PAPR as stated. Power boosting can only be done for transmissions where the data is encoded based on a 2× repetition of BPSK rate ½. As such the preamble structure can remove at least 2 LTF symbols that can reduce overhead.

The LTF field can additionally be used in conjunction with single stream pilots to track frequency drift over multiple LTF symbols that can be used to improve channel estimation. A preamble can have at least four LTF symbols that can be used for tracking frequency drift. Single stream pilots can be useful for both single stream transmissions as well as for estimating a MIMO channel and provides training for space time streams. When using single stream pilots, data subcarriers can be multiplied a matrix P before being transmitted while pilot subcarriers can be multiplied by a matrix R whose values can be different than the P matrix. This can allow for tracking phase offset and frequency offset during channel estimation at the receiver.

After multiplication by a matrix and transformation to a time domain signal, the resulting PAPR can be different when P matrix values are different than R matrix values. As such, having different P and R values results in different LTF sequences 514. Accordingly, according to embodiments as described above with respect to orthogonality, the LTF can be chosen by identifying a sequence that minimizes the maximal PAPR over all possible P and R matrix values:

$$LTF = {min}_{S} \{ {max}_{P , R} [ PAPR ( S , P , R ) ] \}$$

where S are the possible sequences for all chosen tone values that meet the orthogonality condition. As with the embodiment described above with reference to Table 33, data and pilot symbol values can be chosen from +1 or −1. As such, according to the twenty-eighth tone allocation as shown in FIG. 6, where sub-carriers chosen for the pilot signals are at indices of ±5, and ±10 of the spectral line −12:12, where there are up to four streams to transmit, the LTF sequences 512 shown below in Table 34 have been determined to have low PAPR values for all possible P and R matrix values that satisfy the orthogonality condition.

TABLE 34

| | PAPR (4x |
|---|---|
| LTF_{-12:12} | OS) |
| {1, −1, 1, 1, 1, −1, 1, −1, −1, 1, −1, 1, 0, 1, 1, 1, 1, 1, −1, −1, | 3.0981 dB |
| −1, 1, 1, −1, −1} | |
| {1, 1, −1, 1, 1, 1, −1, −1, −1, 1, −1, 1, 0, −1, −1, 1, 1, 1, 1, | 3.1760 dB |
| 1, −1, 1, 1, −1, 1} | |
| {1, 1, −1, −1, 1, 1, 1, −1, −1, 1, −1, 1, 0, −1, −1, −1, −1, −1, | 3.2382 dB |
| 1, −1, 1, 1, 1, −1, 1} | |

Accordingly, the LTF sequences 514 of Table 4 can correspond to LTF sequences with optimally low PAPR values for a 32-point FFT for the twenty-eighth tone allocation shown in FIG. 6 for use with single stream pilots such that the 32-point FFT LTF is substantially orthogonal with both the upper and lower halves of the 64-point FFT LTF. The sequence with the lowest PAPR can have a maximum of absolute value of correlation (orthogonality metric) with either upper or lower half of the 2 MHz LTF that can be substantially zero (given that there can be 24 overlapping tones between 1 MHz LTF and 2 MHz LTF, and 56 tones in 2 MHz LTF). As described above, the full LTF sequence can include guard tones with zero values (e.g., 4 zeros from −16:−13 and 3 zeros from 13:15 in the spectral line. The LTF sequences 514 can correspond to training sequences with low PAPR values when using a four times oversampled IFFT.

In another embodiment, an STF sequence can be determined with low PAPR that can have good correlation properties and for which power boosting can also be possible. The STF sequence for 1 MHz can have non-zero values at indices {±4, ±8, ±12}. This can be used to ensure the same periodicity as a STF sequence for 2 MHz mode. As described above, tone values can be chosen from:

$$\{ {e}^{\pm j \frac{π}{4}} = \pm \sqrt{\frac{1}{2}} ( 1 + j ) \}$$

so as to preserve good correlation. An STF sequence can be determined for the lowest PAPR when using four times oversampled IFFT to also have a 3 db power boost capability for 2× repetition mode. Power boosting can accomplished for 2 MHz mode where PAPR(2 MHz STF) can be approximately 2.2394 db while the mean for PAPR(BPSK data))=6.8547 db. The PAPR of the 1 MHz STF should not be worse than 2 MHz STF. As such, when using non zero values at indices {±4, ±8, ±12}, an optimized 1 MHz STF sequence that minimizes the PAPR when using four times sampled IFFT are shown in Table 35 below according to the twenty-eighth tone allocation shown in FIG. 6 that can allow for power boosting.

TABLE 35

| S_{-12:12} | PAPR |
|---|---|
| \sqrt{1/2} {1 + j, 0, 0, 0, −1 − j, 0, 0, 0, 1 + j, 0, 0, 0, 0, 0, 0, 0, | 2.2303 dB |
| −1 − j, 0, 0, 0, −1 − j, 0, 0, 0, −1 − j} | |
| \sqrt{1/2} {−1 − j, 0, 0, 0, 1 + j, 0, 0, 0, −1 − j, 0, 0, 0, 0, 0, 0, 0, | 2.2303 dB |
| 1 + j, 0, 0, 0, 1 + j, 0, 0, 0, 1 + j} | |
| \sqrt{1/2} {1 + j, 0, 0, 0, 1 + j, 0, 0, 0, 1 + j, 0, 0, 0, 0, 0, 0, 0, | 2.2303 dB |
| −1 − j, 0, 0, 0, 1 + j, 0, 0, 0, −1 − j} | |
| \sqrt{1/2} {−1 − j, 0, 0, 0, −1 − j, 0, 0, 0, −1 − j, 0, 0, 0, | 2.2303 dB |
| 0, 0, 0, 0, 1 + j, 0, 0, 0, −1 − j, 0, 0, 0, 1 + j} | |

Accordingly, these STF sequences can correspond to optimally low PAPR values that can avoid distorting the short training sequence when transmitted while having good correlation properties for packet detection for the twenty-eighth tone allocation shown in FIG. 6. These sequences can correspond to training sequence with low PAPR values when using a four times oversampled IFFT. Including guard tones, one entire sequence can be \sqrt{1/2}{0, 0, 0, 0, 1+j, 0, 0, 0, −1−j, 0, 0, 0, 1+j, 0, 0, 0, 0, 0, 0, 0, −1−j, 0, 0, 0, −1−j, 0, 0, 0, −1−j, 0, 0, 0}. The sequences in Table 35 can correspond to STF sequences for 1 MHz that can have a PAPR that can be slightly lower than a 2 MHz STF that can be sufficient for power boosting purposes.

Power boosting can also be accomplished by having unequal power on different non-zero tones of the STF sequence. This can be accomplished by either boosting (e.g., increasing the power) of selected non-zero tones of the STF sequence (e.g., in a middle section of the STF sequence) or suppressing (e.g., reducing the power) non-zero tones (e.g., towards the ends of the STF sequence). However, in some cases this can cause inaccuracies in the gains setting and automatic gain control (AGC). For example, suppressing outer non-zero tones can reduce PAPR, but this unequal power allocation can result in that fact that low signal-to-noise ratio detection performance can be less reliable because of diversity loss. Furthermore, the STF power estimate can be more sensitive to channel dips at the boosted tones. AGC errors can therefore increase. As such, according to certain aspects, unequal power on different non-zero tones can be used while also balancing the need to maintain the gain setting accuracy at acceptable levels. For accurate AGC gain setting, the received STF power can be chosen to match the LTF power or up to a constant multiplication if power boosting is used.

As such, according to another embodiment, to balance low PAPR with accurate correlation properties for use with power boosting, the non-zero tones can have unequal power. For example, there can be a 3 dB change (e.g., reduction or suppression) on the outer tones of the STF sequence. For example, according to an embodiment, the STF can include the values {0, 0, 0, 0, \sqrt{1/2}(1+j), 0, 0, 0, −1−j, 0, 0, 0, 1+j, 0, 0, 0, 0, 0, 0, 0, −1−j, 0, 0, 0, −1−j, 0, 0, 0, −\sqrt{1/2}(1+j), 0, 0, 0}, where there are four guard tones at the beginning of the sequence and 3 guard tones at the end of the sequence. Each of the tones at the ends of the sequence therefore are suppressed (e.g., multiplied by \sqrt{1/2} while the other tones are either 1+j or −1−j). This sequence corresponds to suppressing the outer non-zero tones of the STF sequence by 3 dB. This sequence can result in a PAPR of substantially 1.3524 dB. In addition, the sequence with a 3 dB suppression can have acceptable gain setting accuracy (e.g., within 0.5 dB of an AGC error range performed by STF as compared to equal power allocation). The STF sequence can be also multiplied with a normalization factor ‘K’ that can be \sqrt{26/10} for a normal mode and \sqrt{26/5} for repetition mode. As such, one example of an STF sequence is described that balances low PAPR with good correlation properties by having unequal power on selected non-zero tones. It should further be appreciated that non-zero tones that are not at the end of the sequence can also be boosted rather than suppressing the outer tones according to other embodiments.

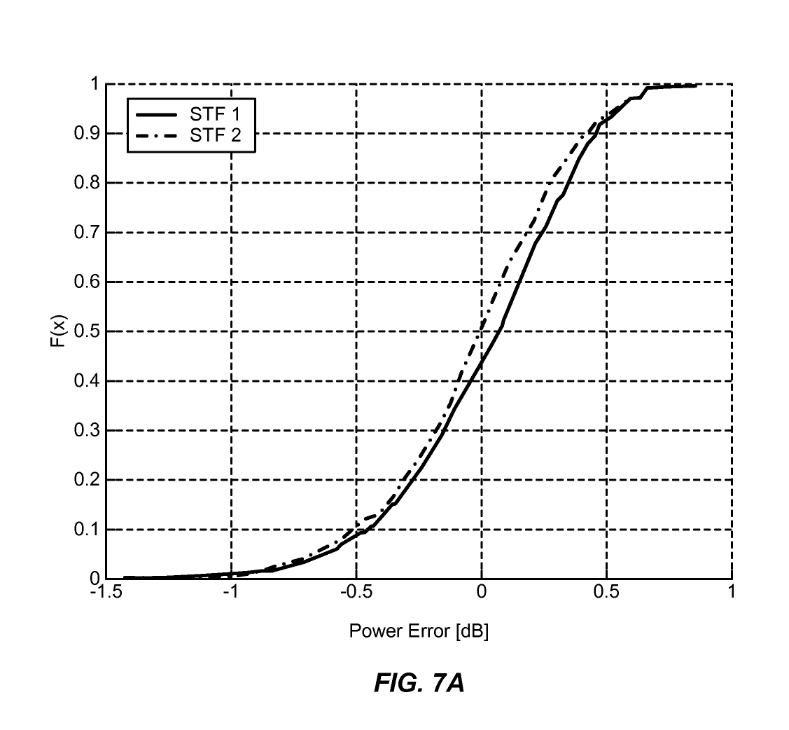

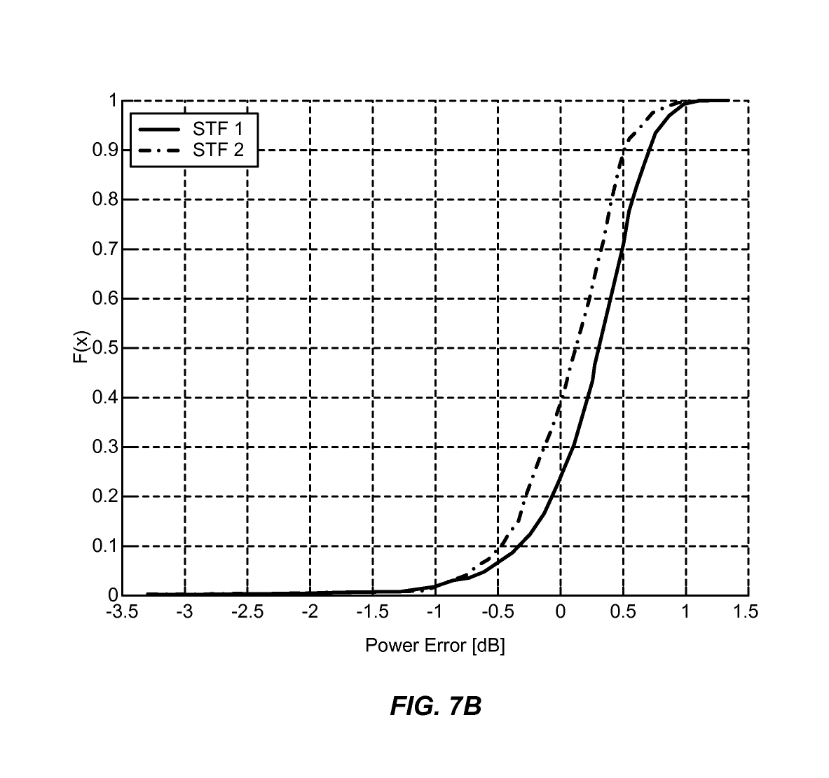

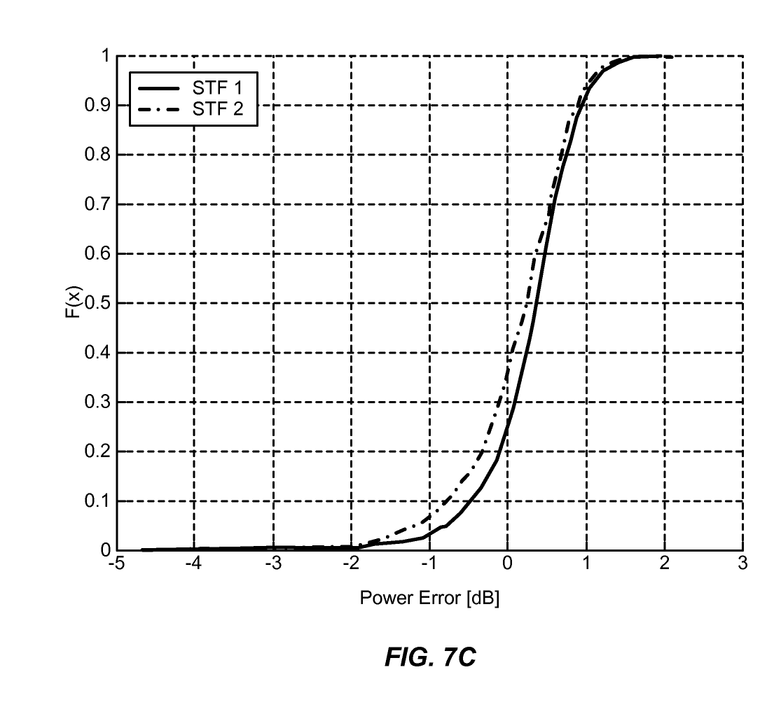

FIGS. 7A, 7B, and 7C show a comparison of the AGC error span (i.e., from 2.5% to 97.5% of the CDF of the power error between STF and LTF) between an STF sequence with equal power on all non-zero tones as compared an STF with unequal power on certain tones as just described above. For example, in FIGS. 7A, 7B, and 7C, the ‘STF 1’ sequences can refer to an STF sequence with equal power on all non-zero tones while the ‘STF 2’ sequences can refer to the STF sequence just described above with unequal power on the end tones. 7A shows the power error CDF for a 1×1 channel and shows a 95% of AGC error span of substantially 1.3983 dB for ‘STF 1’ and a 1.4318 dB for ‘STF 2’ as one example. 7B shows the power error CDF for a 2×1 channel and shows a 95% of AGC error span of substantially 1.8314 dB for ‘STF 1’ and a 1.6660 dB for ‘STF 2’ as one example. 7C shows the power error CDF for the 4×1 channel and shows a 95% of AGC error span of substantially 2.3409 dB for ‘STF 1’ and a 2.7659 dB for ‘STF 2’ as one example. As shown, STF 2 (corresponding to the STF with unequal power on the non-zero tones) approaches the same power error as STF 1 (corresponding to equal power on all tones) which is within an acceptable power error level. As such, certain embodiments provide for allowing an STF to have unequal power on the non-zero tones while maintaining an acceptable gain setting while still having low PAPR. In some cases, suppressing or boosting the non-zero tones by too great an amount can result in poor power error as compared to the power error plots shown in FIGS. 7A, 7B, and 7C as also described above.

In another embodiment, the orthogonal 1 MHz LTF sequence can be constructed using a zero cross-correlation in frequency with the 2 MHz LTF sequence to ensure robust mode detection. The orthogonality metric described above in Equations 1 and 2 can be used, but the DC tone can be skipped. For example, index “k” in Equations 1 and 2 can be limited to indices 1:16 and 18:31.

As such, 32-point 1 MHz FFT LTF sequences that minimize PAPR as described above can further be determined to minimize PAPR while being orthogonal to the 2 MHz 64-point LTF. To balance low PAPR sequences with the ability to classify sequences (to detect the 1 MHz channel versus the 2 MHz channel), sequences with low PAPR can be identified with an orthogonality metric of substantially zero. For example, LTF sequences 514 can be determined for the fifth allocation shown in FIG. 6 that have low PAPR values while satisfying the orthogonality condition as described by Equations 1 and 2 while ignoring the DC tone. For an LTF sequence, every subcarrier corresponding to a data subcarrier or a pilot subcarrier can be modulated with a non-zero symbol. To achieve a low PAPR, all the data and pilot symbol values can be chosen from either +1 or −1, and selected so as to minimize the PAPR ratio. The 1 MHz LTF sequence that minimizes PAPR and is orthogonal to either half of the 2 MHz LTF for the fifth subcarrier allocation shown in FIG. 6 while skipping the DC tone in the orthogonality metric can be the sequence {0, 0, 0, 1, −1, −1, 1, −1, 1, 1, −1, 1, −1, −1, −1, −1, 0, −1, −1, −1, 1, −1, −1, −1, 1, −1, 1, 1, 1, −1, 0, 0}. This sequence can have a PAPR of 2.3983 dB when using four times oversampled IFFT. Accordingly, this LTF sequence 514 can correspond to the LTF sequence with optimally low PAPR values for a 32-point FFT for the fifth allocation shown in FIG. 6 such that the 32-point FFT LTF is substantially orthogonal with both the upper and lower halves of the 64-point FFT LTF. As described above, the full LTF sequence can include guard tones with zero values (e.g., 3 zeros from −16:−14 and 2 zeros from 14:15 in the spectral line.

As described above, the LTF field can additionally be used in conjunction with single stream pilots to track frequency drift over multiple LTF symbols that can be used to improve channel estimation. In this case, the issues regarding frequency offset (and phase noise) can be increased (e.g., five times carrier frequency reduction but 10 times symbol lengthening). A preamble can have at least four LTF symbols that can be used for tracking frequency drift. Single stream pilots can be useful for both single stream transmissions as well as for estimating a MIMO channel and provides training for space time streams. When using single stream pilots, data subcarriers can be multiplied a matrix P before being transmitted while pilot subcarriers can be multiplied by a matrix R whose values can be different than the P matrix. This can allow for tracking phase offset and frequency offset during channel estimation at the receiver.

After multiplication by a matrix and transformation to a time domain signal, the resulting PAPR can be different when P matrix values are different than R matrix values. As such, having different P and R values results in different LTF sequences 514. Accordingly, according to embodiments as described above with respect to orthogonality, the LTF can be chosen by identifying a sequence that minimizes the maximal PAPR over all possible P and R matrix values: LTF=min{max[PAPR(S,P,R)]} where S are the possible sequences for all chosen tone values that meet the orthogonality condition. As with the embodiment described above, data and pilot symbol values can be chosen from +1 or −1. As such, according to the fifth allocation of FIG. 6 where sub-carriers chosen for the pilot signals are at indices of −7, and +7, where there are up to four streams to transmit, the LTF sequence that minimizes a worst case PAPR over all P and R values that satisfies the orthogonaolity condition while skipping the DC tone is {0, 0, 0, 1, 1, −1, −1, 1, 1, 1, −1, −1, 1, 1, −1, 1, 0, −1, 1, 1, −1, 1, −1, −1, −1, 1, 1, 1, 1, 1, 0, 0}. This sequence can have a worst case PAPR of 3.3970 dB using four times oversampled IFFT. The sequence can have a PAPR of 3.0730 dB with unequal P and R and a PAPR of 3.3970 with equal P and R. It should further be appreciated that the resulting sequence which is equal to the above LTF sequence when multiplied by negative one (−1) can have the same PAPRs and the same orthogonality to the 2 MHz LTF. Accordingly, these LTF sequences 514 can correspond to the LTF sequence with optimally low PAPR values for a 32-point FFT for the fifth allocation shown in FIG. 6 for use with single stream pilots such that the 32-point FFT LTF is substantially orthogonal with both the upper and lower halves of the 64-point FFT LTF while skipping the DC tone. As described above, the full LTF sequence can include guard tones with zero values (e.g., 3 zeros from −16:−14 and 2 zeros from 14:15 in the spectral line.

FIG. 8 shows a flow chart of an aspect of an exemplary method for generating and transmitting a data unit. The method 800 can be used to generate any of the data units and STF sequences 512 described above. The data units can be generated at either the AP 104 or the STA 106 and transmitted to another node in the wireless network 100. Although the method 800 is described below with respect to elements of the wireless device 202a, those having ordinary skill in the art will appreciate that other components can be used to implement one or more of the steps described herein. In block 802, a transmitter can generate one or more short training field (STF) sequences comprising thirty two values or less. The 32 values can correspond to or be transmitted with 32 subcarriers or less and each value can be identified by indices starting at −16 and ending at +15 to define a spectral line. The one or more STF sequences can include a first subset of values (e.g., indices from −13:13) including values of zero and non-zero values, where the non-zero values are located at indices of the first subset that are at least a multiple of two and can be multiples of four. A DC subcarrier can be mapped to a 0 index and have a zero value. The one or more STF sequences comprises a second subset of zero values (e.g., −16:−14 and +14:15). The second subset of zero values can include all values not included within the first subset. The STF sequences can include any of the STF sequences described above. In block 804, the transmitter can transmit a data unit including the one or more STF sequences over a wireless channel.

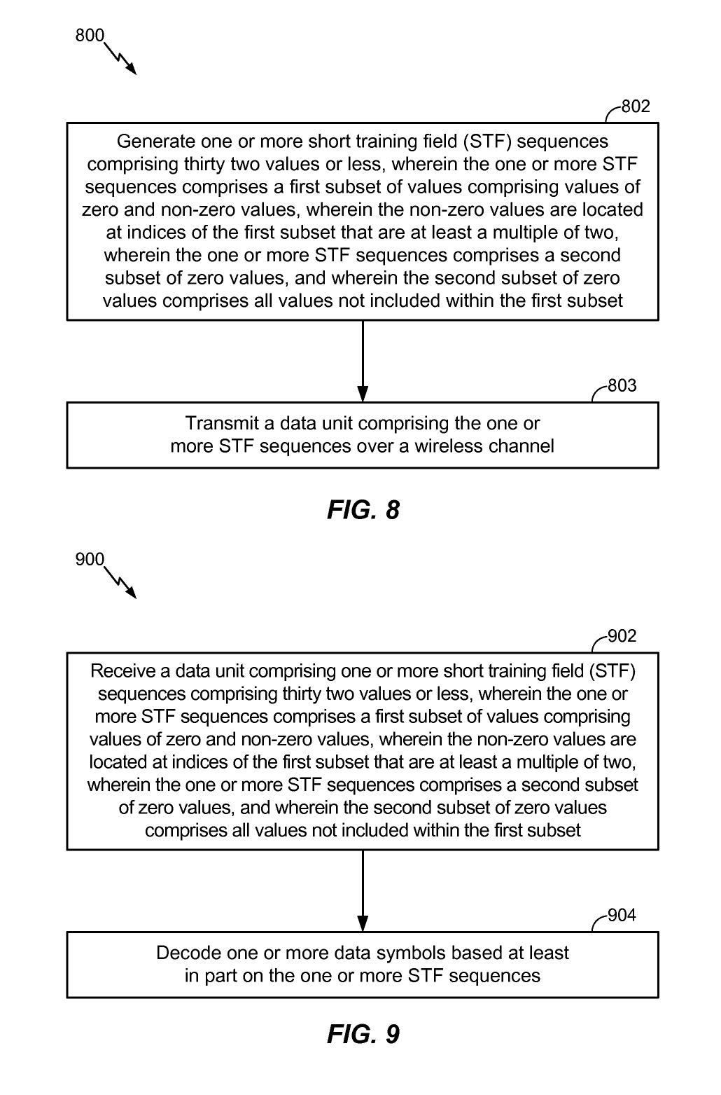

FIG. 9 shows a flow chart of another aspect of an exemplary method 900 for receiving and processing a data unit including a training sequence. The method 900 can be used to receive any of the data units described above. The packets can be received at either the AP 104 or the STA 106 from another node in the wireless network 100. Although the method 900 is described below with respect to elements of the wireless device 202b, those having ordinary skill in the art will appreciate that other components can be used to implement one or more of the steps described herein. In block 902, a receiver can generate one or more short training field (STF) sequences comprising thirty two values or less. The 32 values can correspond to or be transmitted with 32 subcarriers or less and each value can be identified by indices starting at −16 and ending at +15 to define a spectral line. The one or more STF sequences can include a first subset of values (e.g., indices from −13:13) including values of zero and non-zero values, where the non-zero values are located at indices of the first subset that are at least a multiple of two and can be multiples of four. A DC subcarrier can be mapped to a 0 index and have a zero value. The one or more STF sequences comprises a second subset of zero values (e.g., −16:−14 and +14:15). The second subset of zero values can include all values not included within the first subset. The STF sequences can include any of the STF sequences described above. In block 904, the transmitter can decode one or more data symbols based at least in part on the one or more STF sequences.

If the data unit includes an interposed STF, the processor 204 or 220 can adjust the gain of the receive amplifier 401 using automatic gain control, and can receive subsequent data symbols with the adjusted gain.

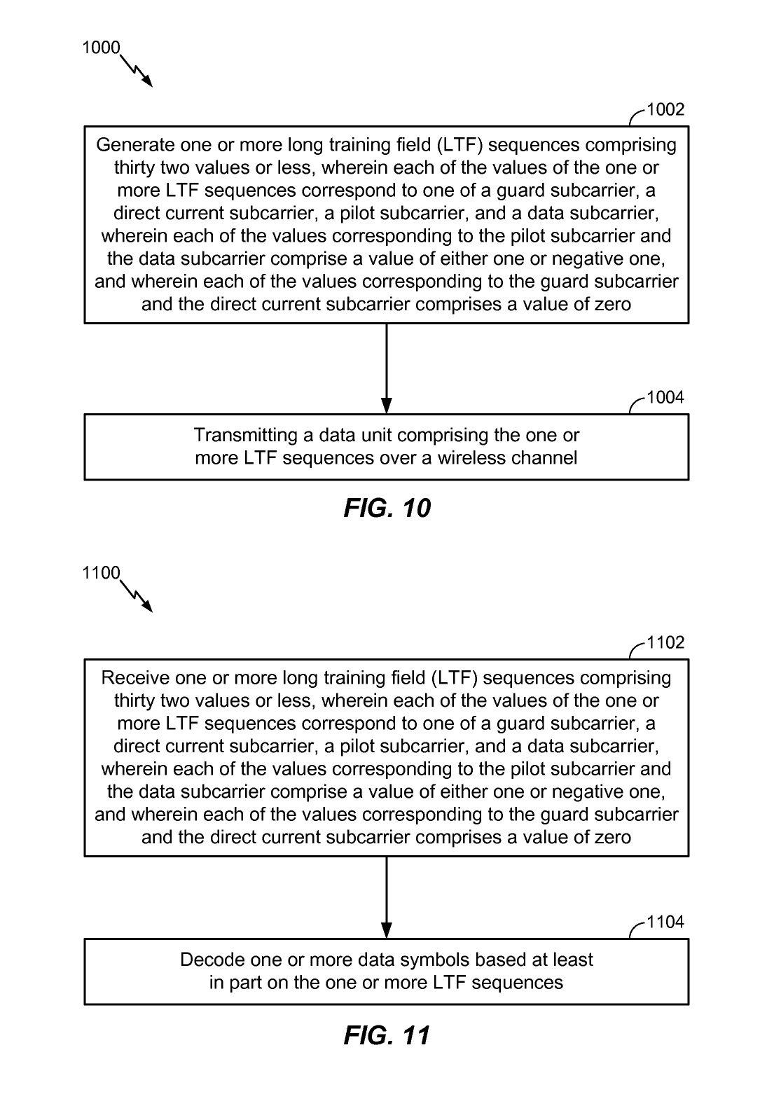

FIG. 10 shows a flow chart of an aspect of another exemplary method for generating and transmitting a data unit. The method 1000 can be used to generate any of the data units and LTF sequences 512 described above. The data units can be generated at either the AP 104 or the STA 106 and transmitted to another node in the wireless network 100. Although the method 1000 is described below with respect to elements of the wireless device 202a, those having ordinary skill in the art will appreciate that other components can be used to implement one or more of the steps described herein. In block 1002, a transmitter can generate one or more long training field (LTF) sequences comprising thirty two values or less. The 32 values can correspond to or be transmitted with 32 subcarriers or less and each value can be identified by indices starting at −16 and ending at +15 to define a spectral line. Each of the values of the one or more LTF sequences can correspond to one of a guard subcarrier, a direct current subcarrier, a pilot subcarrier, and a data subcarrier. Each of the values corresponding to the pilot subcarrier and the data subcarrier (e.g., spanning indices from −13 to +13 except for the 0 index) can include a value of either one or negative one. Each of the values corresponding to the guard subcarrier and the direct current subcarrier comprises a value of zero where the direct current can be located at the 0 index while the guard carriers can be located at the beginning and end of the sequence. The LTF sequences can include any of the LTF sequences described above. In block 1004, the transmitter can transmit a data unit including the one or more LTF sequences over a wireless channel.

FIG. 11 shows a flow chart of an aspect of another exemplary method 1100 for receiving and processing a data unit including a training sequence. The method 1100 can be used to receive any of the data units described above. The packets can be received at either the AP 104 or the STA 106 from another node in the wireless network 100. Although the method 900 is described below with respect to elements of the wireless device 202b, those having ordinary skill in the art will appreciate that other components can be used to implement one or more of the steps described herein. In block 1102, a receiver can receive one or more long training field (LTF) sequences comprising thirty two values or less. The 32 values can correspond to or be transmitted with 32 subcarriers or less and each value can be identified by indices starting at −16 and ending at +15 to define a spectral line. Each of the values of the one or more LTF sequences can correspond to one of a guard subcarrier, a direct current subcarrier, a pilot subcarrier, and a data subcarrier. Each of the values corresponding to the pilot subcarrier and the data subcarrier (e.g., spanning indices from −13 to +13 except for the 0 index) can include a value of either one or negative one. Each of the values corresponding to the guard subcarrier and the direct current subcarrier comprises a value of zero where the direct current can be located at the 0 index while the guard carriers can be located at the beginning and end of the sequence. The LTF sequences can include any of the LTF sequences described above. In block 1104, the receiver can decode a data unit including the one or more LTF sequences over a wireless channel.

If the data unit includes an interposed LTF, the channel estimator and equalizer can form an estimate of the channel over which the data unit is received. The channel estimate can be used by the processor 204 or 220 to decode only subsequent data symbols, or can be used to decode both subsequent and preceding data symbols. In some aspects, the processor 204 or 220 calculates an interpolation between two channel estimates, and uses that interpolation to decode the data symbols.

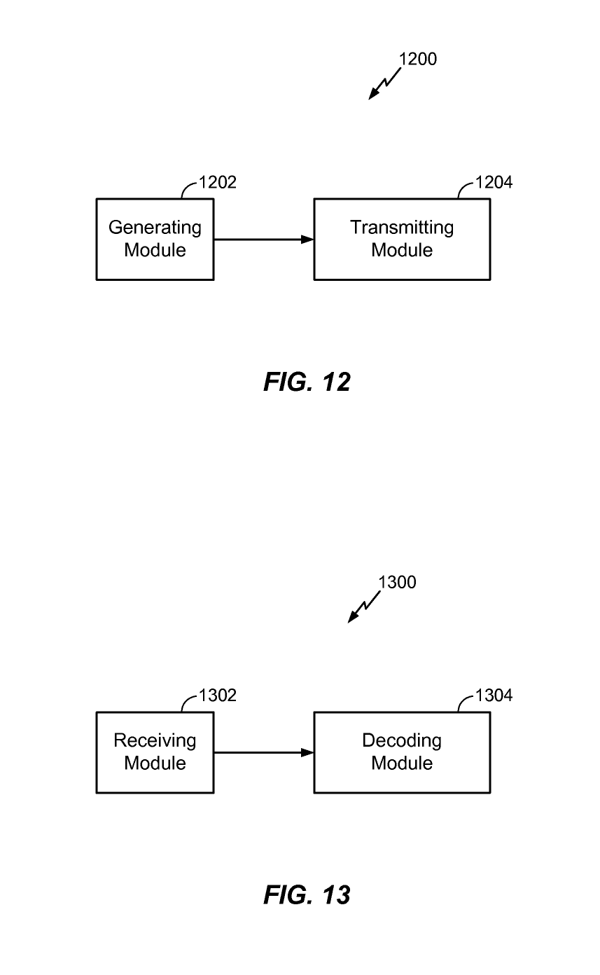

FIG. 12 is a functional block diagram of another exemplary wireless device 1200 that can be employed within the wireless communication system 100. The device 1200 comprises a generating module 1202 for generating a data unit for wireless transmission. The generating module 1202 can be configured to perform one or more of the functions discussed above with respect to the block 802 illustrated in FIG. 8. The generating module 1202 can further be configured to perform one or more of the functions discussed above with respect to the block 1002 illustrated in FIG. 10. The generating module 1202 can correspond to one or more of the processor 204 and the DSP 220. The device 1200 further comprises a transmitting module 1204 for wirelessly transmitting the data unit. The transmitting module 1204 can be configured to perform one or more of the functions discussed above with respect to the block 804 illustrated in FIG. 8. The transmitting module 1204 can further be configured to perform one or more of the functions discussed above with respect to the block 1004 illustrated in FIG. 10. The transmitting module 1204 can correspond to the transmitter 210.

FIG. 13 is a functional block diagram of yet another exemplary wireless device 1300 that can be employed within the wireless communication system 100. The device 1300 comprises a receiving module 1302 for wirelessly receiving a data unit. The receiving module 1302 can be configured to perform one or more of the functions discussed above with respect to the block 902 illustrated in FIG. 9. The receiving module 1302 can further be configured to perform one or more of the functions discussed above with respect to the block 1102 illustrated in FIG. 11. The receiving module 1302 can correspond to the receiver 212, and can include the amplifier 401. The device 1300 further comprises a decoding module 1304 for decoding a plurality of data symbols in the data unit based at least in part on one or more training fields. The decoding module 1304 can be configured to perform one or more of the functions discussed above with respect to the block 904 illustrated in FIG. 9. The decoding module 1304 can be configured to perform one or more of the functions discussed above with respect to the block 1104 illustrated in FIG. 11. The decoding module 1304 can correspond to one or more of the processor 204, the signal detector 218, and the DSP 220, and can including the channel estimator and equalizer 405.

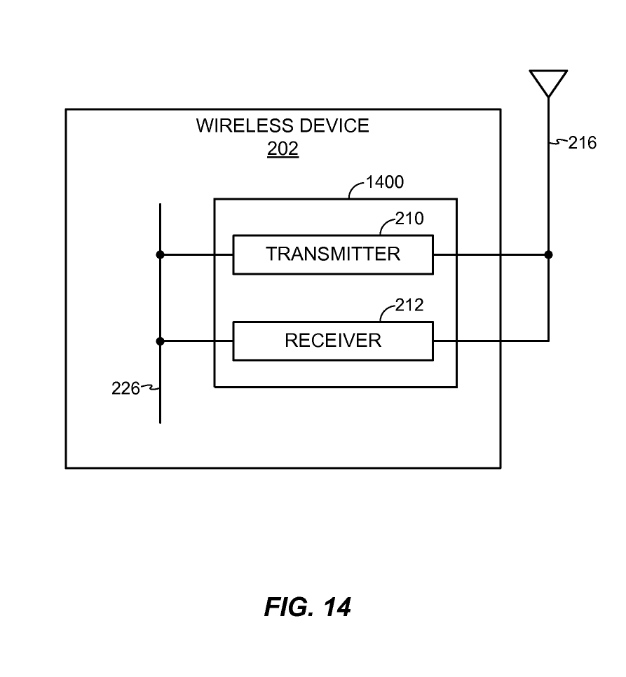

FIG. 14 depicts an exemplary physical layer device (PHY) 1400 that can be employed within the wireless device 202. A PHY connects a media access control layer device to a physical information transport medium, such as a WiFi compliant wireless link (e.g., using IEEE 802.11 protocol such as 802.11ah). The PHY 1400 includes circuitry that is configured to perform at least a part of a method and/or perform a function described herein. In an example, the PHY 1400 can include the transmitter 210 and/or the receiver 212. The transmitter 210 can be configured to transmit a data unit comprising an STF sequence, and/or a LTF sequence, over a wireless channel via the antenna 216. The transmitter 210 can also be configured to perform at least a part of a method and/or perform a function described herein. Further, the receiver 212 can be configured to receive a data unit comprising an STF sequence, and/or a LTF sequence, over a wireless channel via the antenna 216. The receiver 212 can also be configured to perform at least a part of a method and/or perform a function described herein.

As used herein, the term “determining” encompasses a wide variety of actions. For example, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like. Further, a “channel width” as used herein can encompass or can also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The operations of methods described above can be performed by any suitable means capable of performing the operations, such as hardware and/or software component(s), circuits, and/or module(s). Generally, any operations illustrated in the Figures can be performed by corresponding functional means capable of performing the operations.

The illustrative logical blocks, modules and circuits described in connection with the present disclosure can be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor can be a microprocessor, but in the alternative, the processor can be any commercially available processor, controller, microcontroller or state machine. A processor can also be implemented as a combination of computing devices, e.g., a combination of a DSP and a microprocessor, a plurality of microprocessors, one or more microprocessors in conjunction with a DSP core, or any other such configuration.

In one or more aspects, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium can comprise non-transitory computer readable medium (e.g., tangible media). In addition, in some aspects computer readable medium can comprise transitory computer readable medium (e.g., a signal). Combinations of the above should also be included within the scope of computer-readable media.

The methods disclosed herein comprise one or more steps or actions for achieving the described method. The method steps and/or actions can be interchanged with one another without departing from the scope of the claims. In other words, unless a specific order of steps or actions is specified, the order and/or use of specific steps and/or actions can be modified without departing from the scope of the claims.

The functions described can be implemented in hardware, software, firmware or any combination thereof. If implemented in software, the functions can be stored as one or more instructions on a computer-readable medium. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects can comprise a computer program product for performing the operations presented herein. For example, such a computer program product can comprise a computer readable medium having instructions stored (and/or encoded) thereon, the instructions being executable by one or more processors to perform the operations described herein. For certain aspects, the computer program product can include packaging material.

Software or instructions can also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, methods described herein can be provided via storage means (e.g., RAM, ROM, a physical storage medium such as a compact disc (CD) or floppy disk, etc.), such that a user terminal and/or base station can obtain the methods upon coupling or providing the storage means to the device. Moreover, any other suitable technique for providing the methods and techniques described herein to a device can be utilized.

It is to be understood that the claims are not limited to the precise configuration and components illustrated above. Modifications, changes and variations can be made in the arrangement, operation and details of the methods and apparatus described above without departing from the scope of the claims.

While the foregoing is directed to aspects of the present disclosure, other and further aspects of the disclosure can be devised without departing from the basic scope thereof, and the scope thereof is determined by the claims that follow.

What is claimed is:

1. A method for wireless communication, comprising:
generating one or more short training field (STF) sequences comprising thirty two values or less, wherein the one or more STF sequences comprises a first subset of values comprising values of zero and non-zero values, wherein the non-zero values are located at indices of the first subset that are at least a multiple of two, wherein the one or more STF sequences comprises a second subset of zero values, and wherein the second subset of zero values comprises all values not included within the first subset; and
transmitting a data unit comprising the one or more STF sequences over a wireless channel.

2. The method of claim 1, wherein the non-zero values comprises either a value of one plus the imaginary unit multiplied by the square root of one-half (+\sqrt{1/2}(1+j)) or a value of one plus the imaginary unit multiplied by the negative square root of one-half (−\sqrt{1/2}(1+j)).

3. The method of claim 1, wherein the STF sequence is characterized by a peak-to-average power ratio having a value less than 4.5 db.

4. The method of claim 1, wherein the STF sequence is characterized by a peak-to-average power ratio having a value less than 2.25 db.

5. The method of claim 1, wherein the non-zero values are located at indices of the first subset that are a multiple of four.

6. The method of claim 5, wherein the first subset of values corresponds to indices in a range from −13 to +13, and wherein the first subset of value comprises values of a square root of one half multiplied by 0, 1+j, 0, 0, 0, −1−j, 0, 0, 0, 1+j, 0, 0, 0, 0, 0, 0, 0, −1−j, 0, 0, 0, −1−j, 0, 0, 0, −1−j, and 0.

7. The method of claim 6, wherein the values of the STF sequence comprise values corresponding to five guard subcarriers, one DC subcarrier, two pilot subcarriers, and twenty-four data subcarriers, and wherein the first three values of the STF sequence correspond to three guard subcarriers, and the last two values of the STF sequence correspond to two guard subcarriers, and wherein a value corresponding to an index of zero corresponds to the DC subcarrier.

8. The method of claim 5, wherein the first subset of values corresponds to indices in a range from −12 to +12, and wherein the first subset of value comprises values of a square root of one half multiplied by 1+j, 0, 0, 0, −1−j, 0, 0, 0, 1+j, 0, 0, 0, 0, 0, 0, 0, −1−j, 0, 0, 0, −1−j, 0, 0, 0, and −1−j.

9. The method of claim 8, wherein the values of the STF sequence comprise values corresponding to seven guard subcarriers, one DC subcarrier, two pilot subcarriers, and twenty-two data subcarriers, and wherein the first four values of the STF sequence correspond to four guard subcarriers, and the last three values of the STF sequence correspond to two three subcarriers, and wherein a value corresponding to an index of zero corresponds to the DC subcarrier.

10. The method of claim 1, wherein the generating one or more short training field (STF) sequences comprises generating one or more STF sequences for use with an extended range mode.

11. The method of claim 10, wherein the first subset of values corresponds to indices in a range from −13 to +13, and wherein the first subset of values comprises values of the square root of one half multiplied by 0, 1+j, 0, 1+j, 0, 1+j, 0, −1−j, 0, −1−j, 0, −1−j, 0, 0, 0, −1−j, 0, 1+j, 0, −1−j, 0, −1−j, 0, 1+j, 0, −1−j, and 0.

12. The method of claim 11, wherein the values of the STF sequence comprise values corresponding to five guard subcarriers, one DC subcarrier, two pilot subcarriers, and twenty-four data subcarriers, and wherein the first three values of the STF sequence correspond to three guard subcarriers, and the last two values of the STF sequence correspond to two guard subcarriers, and wherein a value corresponding to an index of zero corresponds to the DC subcarrier.

13. The method of claim 10, wherein the first subset of values corresponds to indices in a range from −12 to +12, and wherein the first subset of values comprises values of the square root of one half multiplied by 1+j, 0, 1+j, 0, 1+j, 0, −1−j, 0, −1−j, 0, −1−j, 0, 0, 0, −1−j, 0, 1+j, 0, −1−j, 0, −1−j, 0, 1+j, 0, and −1−j.

14. The method of claim 13, wherein the values of the STF sequence comprise values corresponding to seven guard subcarriers, one DC subcarrier, two pilot subcarriers, and twenty-two data subcarriers, and wherein the first three values of the STF sequence correspond to three guard subcarriers, and the last two values of the STF sequence correspond to two guard subcarriers, and wherein a value corresponding to an index of zero corresponds to the DC subcarrier.

15. The method of claim 1, wherein each value in the one or more STF sequences corresponds to one of a guard subcarrier, a direct current subcarrier, a data subcarrier, and a pilot subcarrier of a signal.

16. The method of claim 15, wherein the first subset comprises values corresponding to the direct current subcarrier, the data subcarrier, and the pilot subcarrier, wherein the first subset of values corresponds to indices in a range from a negative number to a positive number, and wherein the direct current subcarrier has an index of zero.

17. The method of claim 1, wherein the second subset comprises a set of guard values each comprising a value of zero.

18. The method of claim 1, wherein the one or more STF sequences are configured to be used with a power boosting scheme.

19. A wireless communication apparatus, comprising:
a processor configured to generate one or more short training field (STF) sequences comprising thirty two values or less, wherein the one or more STF sequences comprises a first subset of values comprising values of zero and non-zero values, wherein the non-zero values are located at indices of the first subset that are at least a multiple of two, wherein the one or more STF sequences comprises a second subset of zero values, and wherein the second subset of zero values comprises all values not included within the first subset; and
a transmitter configured to transmit a data unit comprising the one or more STF sequences over a wireless channel.

20. A wireless communication apparatus, comprising:
means for generating one or more short training field (STF) sequences comprising thirty two values or less, wherein the one or more STF sequences comprises a first subset of values comprising values of zero and non-zero values, wherein the non-zero values are located at indices of the first subset that are at least a multiple of two, wherein the one or more STF sequences comprises a second subset of zero values, and wherein the second subset of zero values comprises all values not included within the first subset; and
means for transmitting a data unit comprising the one or more STF sequences over a wireless channel.

21. A method for wireless communication, comprising:
generating one or more long training field (LTF) sequences comprising thirty two values or less, wherein each of the values of the one or more LTF sequences correspond to one of a guard subcarrier, a direct current subcarrier, a pilot subcarrier, and a data subcarrier, wherein each of the values corresponding to the pilot subcarrier and the data subcarrier comprise a value of either one or negative one, and wherein each of the values corresponding to the guard subcarrier and the direct current subcarrier comprises a value of zero; and
transmitting a data unit comprising the one or more LTF sequences over a wireless channel.

22. The method of claim 21, wherein the LTF sequence is characterized by a peak to average ratio that has a value less than 2 db.

23. The method of claim 21, wherein the values corresponding to the direct current subcarrier, the pilot subcarrier, and the data subcarrier corresponds to indices in a range from −13 to +13, and wherein the values corresponding to the direct current subcarrier, the pilot subcarrier, and the data subcarrier comprise a subset of values comprising 1, −1, 1, 1, −1, 1, 1, −1, 1, 1, 1, −1, 1, 0, −1, −1, −1, 1, −1, −1, −1, 1, 1, 1, −1, −1, and −1.

24. The method of claim 23, wherein the values of the LTF sequence values correspond to five guard subcarriers, one DC subcarrier, two pilot subcarriers, and twenty-four data subcarriers, and wherein the first three values of the LTF sequence correspond to three guard subcarriers, and the last two values of the LTF sequence correspond to two guard subcarriers, and wherein a value corresponding to an index of zero corresponds to the DC subcarrier

25. The method of claim 21, wherein the values corresponding to the direct current subcarrier, the pilot subcarrier, and the data subcarrier corresponds to indices in a range from −12 to +12, and wherein the values corresponding to the direct current subcarrier, the pilot subcarrier, and the data subcarrier comprise a subset of values comprising 1, 1, −1, −1, −1, −1, 1, 1, −1, 1, 1, −1, 0, 1, 1, 1, −1, 1, 1, −1, 1, −1, 1, −1, and 1.

26. The method of claim 25, wherein the values of the LTF sequence values correspond to seven guard subcarriers, one DC subcarrier, two pilot subcarriers, and twenty-two data subcarriers, and wherein the first four values of the LTF sequence correspond to four guard subcarriers, and the last three values of the LTF sequence correspond to three guard subcarriers, and wherein a value corresponding to an index of zero corresponds to the DC subcarrier

27. The method of claim 21, wherein the generating one or more LTF sequences comprises generating one or more LTF sequences for use with a mode wherein values corresponding to pilot subcarriers are multiplied by a first value, and wherein values corresponding to data subcarriers are multiplied by a second value, the first value being different than the second value.

28. The method of claim 27, wherein the values corresponding to the direct current subcarrier, the pilot subcarrier, and the data subcarrier corresponds to indices in a range from −13 to +13, and wherein the values corresponding to the pilot subcarriers have indices of −7 and 7, and wherein the values corresponding to the direct current subcarrier, the pilot subcarriers, and the data subcarrier comprise a subset of values comprising 1, 1, −1, 1, 1, −1, 1, 1, −1, −1, −1, −1, −1, 0, −1, 1, −1, 1, −1, −1, −1, 1, 1, −1, −1, −1, and 1.

29. The method of claim 28, wherein the values of the LTF sequence values corresponding to five guard subcarriers, one DC subcarrier, two pilot subcarriers, and twenty-four data subcarriers, and wherein the first three values of the LTF sequence correspond to three guard subcarriers, and the last two values of the LTF sequence correspond to two guard subcarriers, and wherein a value corresponding to an index of zero corresponds to the DC subcarrier.

30. The method of claim 27, wherein the values corresponding to the direct current subcarrier, the pilot subcarrier, and the data subcarrier corresponds to indices in a range from −12 to +12, and wherein the values corresponding to the pilot subcarriers have indices of −7 and +7, and wherein the values corresponding to the direct current subcarrier, the pilot subcarriers, and the data subcarrier comprise a subset of values comprising 1, 1, 1, 1, 1, 1, −1, 1, 1, 1, −1, −1, 0, −1, 1, 1, −1, 1, 1, −1, −1, 1, −1, 1, and −1.

31. The method of claim 30, wherein the values of the LTF sequence values corresponding to seven guard subcarriers, one DC subcarrier, two pilot subcarriers, and twenty-two data subcarriers, and wherein the first four values of the LTF sequence correspond to four guard subcarriers, and the last three values of the LTF sequence correspond to three guard subcarriers, and wherein a value corresponding to an index of zero corresponds to the DC subcarrier.

32. The method of claim 21, wherein the one or more LTF sequences are configured to be substantially orthogonal to each halve of an additional LTF sequence comprising sixty four values, wherein the one or more LTF sequences correspond to a first channel and the additional LTF sequence corresponds to a second channel.

33. The method of claim 32, wherein the values corresponding to the direct current subcarrier, the pilot subcarrier, and the data subcarrier corresponds to indices in a range from −13 to +13, and wherein the values corresponding to the direct current subcarrier, the pilot subcarrier, and the data subcarrier comprise a subset of values comprising 1, −1, 1, 1, −1, 1, 1, −1, 1, 1, 1, −1, 1, 0, −1, −1, −1, 1, −1, −1, −1, 1, 1, 1, −1, −1, and −1.

34. The method of claim 32, wherein the values corresponding to the direct current subcarrier, the pilot subcarrier, and the data subcarrier corresponds to indices in a range from −12 to +12, and wherein the values corresponding to the direct current subcarrier, the pilot subcarrier, and the data subcarrier comprise a subset of values comprising 1, 1, −1, 1, −1, 1, 1, 1, 1, −1, −1, 1, 0, 1, 1, 1, 1, 1, −1, −1, 1, −1, −1, −1, and 1.

35. The method of claim 32, wherein the values comprise 0, 0, 0, 1, −1, −1, 1, −1, 1, 1, −1, 1, −1, −1, −1, −1, 0, −1, −1, −1, 1, −1, −1, −1, 1, −1, 1, 1, 1, −1, 0, and 0.

36. The method of claim 32, wherein the values comprise 0, 0, 0, 1, 1, −1, −1, 1, 1, 1, −1, −1, 1, 1, −1, 1, 0, −1, 1, 1, −1, 1, −1, −1, −1, 1, 1, 1, 1, 1, 0, and 0.

37. The method of claim 21, wherein a orthogonality metric of one of the one or more LTF sequences and either half of an additional LTF sequence comprising sixty four values is substantially equivalent to zero, wherein the one or more LTF sequences correspond to a first channel and the additional LTF sequence corresponds to a second channel.

38. The method of claim 21, wherein the one or more LTF sequences comprise two LTF sequences forming a part of a preamble of the data unit for use with communicating on a first channel, wherein the two TLF sequences span two symbols of the preamble.

39. The method of claim 38, wherein the two symbols are power boosted by 2 dB to 4 dB.

40. The method of claim 39, wherein the two symbols are power boosted for transmissions where data for the data unit is encoded based on a 2× repetition of BPSK rate one-half.

41. The method of claim 38 wherein the first channel corresponds to a 1 MHz channel.

42. A wireless communication apparatus, comprising:
a processor configured to generate one or more long training field (LTF) sequences comprising thirty two values or less, wherein each of the values of the one or more LTF sequences correspond to one of a guard subcarrier, a direct current subcarrier, a pilot subcarrier, and a data subcarrier, wherein each of the values corresponding to the pilot subcarrier and the data subcarrier comprise a value of either one or negative one, and wherein each of the values corresponding to the guard subcarrier and the direct current subcarrier comprises a value of 0; and
a transmitter configured to transmit a data unit comprising the one or more LTF sequences over a wireless channel.

43. A wireless communication apparatus, comprising:
means for generating one or more long training field (LTF) sequences comprising thirty two values or less, wherein each of the values of the one or more LTF sequences correspond to one of a guard subcarrier, a direct current subcarrier, a pilot subcarrier, and a data subcarrier, wherein each of the values corresponding to the pilot subcarrier and the data subcarrier comprise a value of either one or negative one, and wherein each of the values corresponding to the guard subcarrier and the direct current subcarrier comprises a value of 0; and
means for transmitting a data unit comprising the one or more LTF sequences over a wireless channel.

44. A method for wireless communication, comprising:
receiving a data unit comprising one or more short training field (STF) sequences comprising thirty two values or less, wherein the one or more STF sequences comprises a first subset of values comprising values of zero and non-zero values, wherein the non-zero values are located at indices of the first subset that are at least a multiple of two, wherein the one or more STF sequences comprises a second subset of zero values, and wherein the second subset of zero values comprises all values not included within the first subset; and
decoding one or more data symbols based at least in part on the one or more STF sequences.

45. The method of claim 44, wherein the non-zero values comprises either a value of one plus the imaginary unit multiplied by the square root of one-half (+\sqrt{1/2}/(1+j)) or a value of one plus the imaginary unit multiplied by the negative square root of one-half (−\sqrt{1/2}(1+j)).

46. The method of claim 44, wherein the STF sequence is characterized by a peak-to-average power ratio having a value less than 4.5 db.

47. The method of claim 44, wherein the STF sequence is characterized by a peak-to-average power ratio having a value less than 2.25 db.

48. The method of claim 44, wherein the non-zero values are located at indices of the first subset that are a multiple of four.

49. The method of claim 48, wherein the first subset of values corresponds to indices in a range from −13 to +13, and wherein the first subset of value comprises values of a square root of one half multiplied by 0, 1+j, 0, 0, 0, −1−j, 0, 0, 0, 1+j, 0, 0, 0, 0, 0, 0, 0, −1−j, 0, 0, 0, −1−j, 0, 0, 0, −1−j, and 0.

50. The method of claim 49, wherein the values of the STF sequence comprise values corresponding to five guard subcarriers, one DC subcarrier, two pilot subcarriers, and twenty-four data subcarriers, and wherein the first three values of the STF sequence correspond to three guard subcarriers, and the last two values of the STF sequence correspond to two guard subcarriers, and wherein a value corresponding to an index of zero corresponds to the DC subcarrier.

51. The method of claim 48, wherein the first subset of values corresponds to indices in a range from −12 to +12, and wherein the first subset of value comprises values of a square root of one half multiplied by 1+j, 0, 0, 0, −1−j, 0, 0, 0, 1+j, 0, 0, 0, 0, 0, 0, 0, −1−j, 0, 0, 0, −1−j, 0, 0, 0, and −1−j.

52. The method of claim 51, wherein the values of the STF sequence comprise values corresponding to seven guard subcarriers, one DC subcarrier, two pilot subcarriers, and twenty-two data subcarriers, and wherein the first four values of the STF sequence correspond to four guard subcarriers, and the last three values of the STF sequence correspond to two three subcarriers, and wherein a value corresponding to an index of zero corresponds to the DC subcarrier.

53. The method of claim 44, wherein the receiving one or more short training field (STF) sequences comprises receiving one or more STF sequences for use with an extended range mode.

54. The method of claim 53, wherein the first subset of values corresponds to indices in a range from −13 to +13, and wherein the first subset of values comprises values of the square root of one half multiplied by 0, 1+j, 0, 1+j, 0, 1+j, 0, −1−j, 0, −1−j, 0, −1−j, 0, 0, 0, −1−j, 0, 1+j, 0, −1−j, 0, −1−j, 0, 1+j, 0, −1−j, and 0.

55. The method of claim 54, wherein the values of the STF sequence comprise values corresponding to five guard subcarriers, one DC subcarrier, two pilot subcarriers, and twenty-four data subcarriers, and wherein the first three values of the STF sequence correspond to three guard subcarriers, and the last two values of the STF sequence correspond to two guard subcarriers, and wherein a value corresponding to an index of zero corresponds to the DC subcarrier.

56. The method of claim 53, wherein the first subset of values corresponds to indices in a range from −12 to +12, and wherein the first subset of values comprises values of the square root of one half multiplied by 1+j, 0, 1+j, 0, 1+j, 0, −1−j, 0, −1−j, 0, −1−j, 0, 0, 0, −1−j, 0, 1+j, 0, −1−j, 0, −1−j, 0, 1+j, 0, and −1−j.

57. The method of claim 56, wherein the values of the STF sequence comprise values corresponding to seven guard subcarriers, one DC subcarrier, two pilot subcarriers, and twenty-two data subcarriers, and wherein the first three values of the STF sequence correspond to three guard subcarriers, and the last two values of the STF sequence correspond to two guard subcarriers, and wherein a value corresponding to an index of zero corresponds to the DC subcarrier.

58. The method of claim 44, wherein each value in the one or more STF sequences corresponds to one of a guard subcarrier, a direct current subcarrier, a data subcarrier, and a pilot subcarrier of a signal.

59. The method of claim 58, wherein the first subset comprises values corresponding to the direct current subcarrier, the data subcarrier, and the pilot subcarrier, wherein the first subset of values corresponds to indices in a range from a negative number to a positive number, and wherein the direct current subcarrier has an index of zero.

60. The method of claim 44, wherein the second subset comprises a set of guard values each comprising a value of zero.

61. The method of claim 44, wherein the one or more STF sequences are configured to be used with a power boosting scheme

62. A wireless communication apparatus, comprising:
a receiver configured to receive a data unit comprising one or more short training field (STF) sequences comprising thirty two values or less, wherein the one or more STF sequences comprises a first subset of values comprising values of zero and non-zero values, wherein the non-zero values are located at indices of the first subset that are at least a multiple of two, wherein the one or more STF sequences comprises a second subset of zero values, and wherein the second subset of zero values comprises all values not included within the first subset; and
a processor configured to decode one or more data symbols based at least in part on the one or more STF sequences.

63. A wireless communication apparatus, comprising:
means for receiving a data unit comprising one or more short training field (STF) sequences comprising thirty two values or less, wherein the one or more STF sequences comprises a first subset of values comprising values of zero and non-zero values, wherein the non-zero values are located at indices of the first subset that are at least a multiple of two, wherein the one or more STF sequences comprises a second subset of zero values, and wherein the second subset of zero values comprises all values not included within the first subset; and
means for decoding one or more data symbols based at least in part on the one or more STF sequences.

64. The method of claim 21, wherein the LTF sequence is characterized by a peak to average ratio that has a value less than 2 db.

65. A method for wireless communication, comprising:
receiving one or more long training field (LTF) sequences comprising thirty two values or less, wherein each of the values of the one or more LTF sequences correspond to one of a guard subcarrier, a direct current subcarrier, a pilot subcarrier, and a data subcarrier, wherein each of the values corresponding to the pilot subcarrier and the data subcarrier comprise a value of either one or negative one, and wherein each of the values corresponding to the guard subcarrier and the direct current subcarrier comprises a value of zero; and
decoding one or more data symbols based at least in part on the one or more LTF sequences.

66. The method of claim 65, wherein the LTF sequence is characterized by a peak to average ratio that has a value less than 2 db.

67. The method of claim 65, wherein the values corresponding to the direct current subcarrier, the pilot subcarrier, and the data subcarrier corresponds to indices in a range from −13 to +13, and wherein the values corresponding to the direct current subcarrier, the pilot subcarrier, and the data subcarrier comprise a subset of values comprising 1, −1, 1, 1, −1, 1, 1, −1, 1, 1, 1, −1, 1, 0, −1, −1, −1, 1, −1, −1, −1, 1, 1, 1, −1, −1, and −1.

68. The method of claim 67, wherein the values of the LTF sequence values correspond to five guard subcarriers, one DC subcarrier, two pilot subcarriers, and twenty-four data subcarriers, and wherein the first three values of the LTF sequence correspond to three guard subcarriers, and the last two values of the LTF sequence correspond to two guard subcarriers, and wherein a value corresponding to an index of zero corresponds to the DC subcarrier

69. The method of claim 65, wherein the values corresponding to the direct current subcarrier, the pilot subcarrier, and the data subcarrier corresponds to indices in a range from −12 to +12, and wherein the values corresponding to the direct current subcarrier, the pilot subcarrier, and the data subcarrier comprise a subset of values comprising 1, 1, −1, −1, −1, −1, 1, 1, −1, 1, 1, −1, 0, 1, 1, 1, −1, 1, 1, −1, 1, −1, 1, −1, and 1.

70. The method of claim 69, wherein the values of the LTF sequence values correspond to seven guard subcarriers, one DC subcarrier, two pilot subcarriers, and twenty-two data subcarriers, and wherein the first four values of the LTF sequence correspond to four guard subcarriers, and the last three values of the LTF sequence correspond to three guard subcarriers, and wherein a value corresponding to an index of zero corresponds to the DC subcarrier

71. The method of claim 65, wherein generating one or more LTF sequences comprises generating one or more LTF sequences for use with a mode wherein values corresponding to pilot subcarriers are multiplied by a first value, and wherein values corresponding to data subcarriers are multiplied by a second value, the first value being different than the second value.

72. The method of claim 71, wherein the values corresponding to the direct current subcarrier, the pilot subcarrier, and the data subcarrier corresponds to indices in a range from −13 to +13, and wherein the values corresponding to the pilot subcarriers have indices of −7 and 7, and wherein the values corresponding to the direct current subcarrier, the pilot subcarriers, and the data subcarrier comprise a subset of values comprising 1, 1, −1, 1, 1, −1, 1, 1, −1, −1, −1, −1, −1, 0, −1, 1, −1, 1, −1, −1, −1, 1, 1, −1, −1, −1, and 1.

73. The method of claim 72, wherein the values of the LTF sequence values corresponding to five guard subcarriers, one DC subcarrier, two pilot subcarriers, and twenty-four data subcarriers, and wherein the first three values of the LTF sequence correspond to three guard subcarriers, and the last two values of the LTF sequence correspond to two guard subcarriers, and wherein a value corresponding to an index of zero corresponds to the DC subcarrier.

74. The method of claim 71, wherein the values corresponding to the direct current subcarrier, the pilot subcarrier, and the data subcarrier corresponds to indices in a range from −12 to +12, and wherein the values corresponding to the pilot subcarriers have indices of −7 and +7, and wherein the values corresponding to the direct current subcarrier, the pilot subcarriers, and the data subcarrier comprise a subset of values comprising 1, 1, 1, 1, 1, 1, −1, 1, 1, 1, −1, −1, 0, −1, 1, 1, −1, 1, 1, −1, −1, 1, −1, 1, and −1.

75. The method of claim 74, wherein the values of the LTF sequence values corresponding to seven guard subcarriers, one DC subcarrier, two pilot subcarriers, and twenty-two data subcarriers, and wherein the first four values of the LTF sequence correspond to four guard subcarriers, and the last three values of the LTF sequence correspond to three guard subcarriers, and wherein a value corresponding to an index of zero corresponds to the DC subcarrier.

76. The method of claim 65, wherein the one or more LTF sequences are configured to be substantially orthogonal to each halve of an additional LTF sequence comprising sixty four values, wherein the one or more LTF sequences correspond to a first channel and the additional LTF sequence corresponds to a second channel.

77. The method of claim 76, wherein the values corresponding to the direct current subcarrier, the pilot subcarrier, and the data subcarrier corresponds to indices in a range from −13 to +13, and wherein the values corresponding to the direct current subcarrier, the pilot subcarrier, and the data subcarrier comprise a subset of values comprising 1, −1, 1, 1, −1, 1, 1, −1, 1, 1, 1, −1, 1, 0, −1, −1, −1, 1, −1, −1, −1, 1, 1, 1, −1, −1, and −1.

78. The method of claim 76, wherein the values corresponding to the direct current subcarrier, the pilot subcarrier, and the data subcarrier corresponds to indices in a range from −12 to +12, and wherein the values corresponding to the direct current subcarrier, the pilot subcarrier, and the data subcarrier comprise a subset of values comprising 1, 1, −1, 1, −1, 1, 1, 1, 1, −1, −1, 1, 0, 1, 1, 1, 1, 1, −1, −1, 1, −1, −1, −1, and 1.

79. The method of claim 76, wherein the values comprise 0, 0, 0, 1, −1, −1, 1, −1, 1, 1, −1, 1, −1, −1, −1, −1, 0, −1, −1, −1, 1, −1, −1, −1, 1, −1, 1, 1, 1, −1, 0, and 0.

80. The method of claim 76, wherein the values comprise 0, 0, 0, 1, 1, −1, −1, 1, 1, 1, −1, −1, 1, 1, −1, 1, 0, −1, 1, 1, −1, 1, −1, −1, −1, 1, 1, 1, 1, 1, 0, and 0.

81. The method of claim 65, wherein a orthogonality metric of one of the one or more LTF sequences and either half of an additional LTF sequence comprising sixty four values is substantially equivalent to zero, wherein the one or more LTF sequences correspond to a first channel and the additional LTF sequence corresponds to a second channel.

82. The method of claim 65, wherein the one or more LTF sequences comprise two LTF sequences forming a part of a preamble of the data unit for use with communicating on a first channel, wherein the two TLF sequences span two symbols of the preamble.

83. The method of claim 82, wherein the two symbols are power boosted by 2 dB to 4 dB.

84. The method of claim 83, wherein the two symbols are power boosted for transmissions only where data for the data unit is encoded based on a 2× repetition of BPSK rate one-half.

85. The method of claim 82 wherein the first channel corresponds to a 1 MHz channel.

86. A wireless communication apparatus, comprising:
a receiver configured to receive one or more long training field (LTF) sequences comprising thirty two values or less, wherein each of the values of the one or more LTF sequences correspond to one of a guard subcarrier, a direct current subcarrier, a pilot subcarrier, and a data subcarrier, wherein each of the values corresponding to the pilot subcarrier and the data subcarrier comprise a value of either one or negative one, and wherein each of the values corresponding to the guard subcarrier and the direct current subcarrier comprises a value of zero; and
a processor configured to decode one or more data symbols based at least in part on the one or more LTF sequences.

87. A wireless communication apparatus, comprising:
means for receiving one or more long training field (LTF) sequences comprising thirty two values or less, wherein each of the values of the one or more LTF sequences correspond to one of a guard subcarrier, a direct current subcarrier, a pilot subcarrier, and a data subcarrier, wherein each of the values corresponding to the pilot subcarrier and the data subcarrier comprise a value of either one or negative one, and wherein each of the values corresponding to the guard subcarrier and the direct current subcarrier comprises a value of zero; and
means for decoding one or more data symbols based at least in part on the one or more LTF sequences.

88. A method for wireless communication, comprising:
generating a training field sequence comprising thirty two values, wherein each value corresponds to a wireless subcarrier, the training field sequence comprising values corresponding to:
seven guard subcarriers;
one DC subcarrier;
twenty two data subcarriers; and
two pilot subcarriers; and
transmitting the training field sequence over a wireless subcarrier.

89. The method of claim 88, wherein the thirty values corresponds to indices in a range from −16 to +15, and wherein a first pilot of the two pilot values has an index of −7 and a second pilot of the two pilot values has an index of +7.

90. The method of claim 88, wherein the thirty values corresponds to indices in a range from −16 to +15, and wherein a first pilot of the two pilot values has an index of −9 and a second pilot of the two pilot values has an index of 5.

91. A method for wireless communication, comprising:
generating one or more short training field (STF) sequences comprising thirty two values or less, wherein the STF sequence comprises values of 0, 0, 0, 0, 1+j, 0, 0, 0, −1−j, 0, 0, 0, 1+j, 0, 0, 0, 0, 0, 0, 0, −1−j, 0, 0, 0, −1−j, 0, 0, 0, −1−j, 0, 0, and 0; and
transmitting a data unit comprising the one or more STF sequences over a wireless channel.

92. A method for wireless communication, comprising:
generating one or more short training field (STF) sequences comprising thirty two values or less, wherein a peak-to-average power ratio of a time domain signal generated from the one or more STF sequences has value that is less than 3 dB; and
transmitting a data unit comprising the one or more STF sequences over a wireless channel.

93. A method for wireless communication, comprising:
receiving one or more short training field (STF) sequences comprising thirty two values or less, wherein the STF sequence comprises values of 0, 0, 0, 0, 1+j, 0, 0, 0, −1−j, 0, 0, 0, 1+j, 0, 0, 0, 0, 0, 0, 0, −1−j, 0, 0, 0, −1−j, 0, 0, 0, −1−j, 0, 0, and 0; and
decoding one or more data symbols based at least in part on the one or more STF sequences.

94. A method for wireless communication, comprising:
receiving one or more short training field (STF) sequences comprising thirty two values or less, wherein a peak-to-average power ratio of a time domain signal generated from the one or more STF sequences has value that is less than 3 dB; and
decoding one or more data symbols based at least in part on the one or more STF sequences.

95. A method for wireless communication, comprising:
generating one or more short training field (STF) sequences comprising thirty two values or less, wherein the one or more STF sequences comprises a subset of values comprising non-zero values, and wherein at least one of the non-zero values has a different assigned value than at least one other of the non-zero values; and
transmitting a data unit comprising the one or more STF sequences over a wireless channel.

96. The method of claim 95, wherein a first subset of non-zero tones of the one or more STF sequences at the beginning of the one or more STF sequences and a second subset of non-zero tones at the end of the one or more STF sequences comprise values that are less than the values assigned to a third subset of non-zero tones between the first subset and the second subset.

97. The method of claim 95, wherein there is a 3 db reduction in power on the beginning and ending non-zero tones of the one or more STF sequences.

98. The method of claim 95, wherein the one or more STF sequences comprises values of 0, 0, 0, 0, \sqrt{1/2}(1+j), 0, 0, 0, −1−j, 0, 0, 0, 1+j, 0, 0, 0, 0, 0, 0, 0, −1−j, 0, 0, 0, −1−j, 0, 0, 0, −\sqrt{1/2}(1+j), 0, 0, and 0.

99. A method for wireless communication, comprising:
receiving one or more short training field (STF) sequences comprising thirty two values or less, wherein the one or more STF sequences comprises a subset of values comprising non-zero values, and wherein at least one of the non-zero values has a different assigned value than at least one other of the non-zero values; and
decoding one or more data symbols based at least in part on the one or more STF sequences.

100. The method of claim 99, wherein a first subset of non-zero tones of the one or more STF sequences at the beginning of the one or more STF sequences and a second subset of non-zero tones at the end of the one or more STF sequences comprise values that are less than the values assigned to a third subset of non-zero tones between the first subset and the second subset.

101. The method of claim 99, wherein there is a 3 db reduction in power on the beginning and ending non-zero tones of the one or more STF sequences.

102. The method of claim 99, wherein the one or more STF sequences comprises values of 0, 0, 0, 0, \sqrt{1/2}(1+j), 0, 0, 0, −1−j, 0, 0, 0, 1+j, 0, 0, 0, 0, 0, 0, 0, −1−j, 0, 0, 0, −1−j, 0, 0, 0, −\sqrt{1/2}(1+j), 0, 0, and 0.

103. A physical layer device configured to generate one or more short training field (STF) sequences comprising thirty two values or less, wherein:
the one or more STF sequences comprises a first subset of values comprising values of zero and non-zero values,
the non-zero values are located at indices of the first subset that are at least a multiple of two, wherein the one or more STF sequences comprises a second subset of zero values, and
the second subset of zero values comprises all values not included within the first subset.

104. A station, comprising:
a physical layer device configured to generate one or more short training field (STF) sequences comprising thirty two values or less, wherein:
the one or more STF sequences comprises a first subset of values comprising values of zero and non-zero values,
the non-zero values are located at indices of the first subset that are at least a multiple of two, wherein the one or more STF sequences comprises a second subset of zero values, and
the second subset of zero values comprises all values not included within the first subset.

105. An access point, comprising:
a physical layer device configured to generate one or more short training field (STF) sequences comprising thirty two values or less, wherein:
the one or more STF sequences comprises a first subset of values comprising values of zero and non-zero values,
the non-zero values are located at indices of the first subset that are at least a multiple of two, wherein the one or more STF sequences comprises a second subset of zero values, and
the second subset of zero values comprises all values not included within the first subset.

106. A physical layer device configured to generate one or more long training field (LTF) sequences comprising thirty two values or less, wherein:
each of the values of the one or more LTF sequences correspond to one of a guard subcarrier, a direct current subcarrier, a pilot subcarrier, and a data subcarrier,
each of the values corresponding to the pilot subcarrier and the data subcarrier comprise a value of either one or negative one, and
each of the values corresponding to the guard subcarrier and the direct current subcarrier comprises a value of zero.

107. A station, comprising a physical layer device configured to generate one or more long training field (LTF) sequences comprising thirty two values or less, wherein:
each of the values of the one or more LTF sequences correspond to one of a guard subcarrier, a direct current subcarrier, a pilot subcarrier, and a data subcarrier,
each of the values corresponding to the pilot subcarrier and the data subcarrier comprise a value of either one or negative one, and
each of the values corresponding to the guard subcarrier and the direct current subcarrier comprises a value of zero.

108. An access point, comprising a physical layer device configured to generate one or more long training field (LTF) sequences comprising thirty two values or less, wherein:
each of the values of the one or more LTF sequences correspond to one of a guard subcarrier, a direct current subcarrier, a pilot subcarrier, and a data subcarrier,
each of the values corresponding to the pilot subcarrier and the data subcarrier comprise a value of either one or negative one, and
each of the values corresponding to the guard subcarrier and the direct current subcarrier comprises a value of zero.

109. A physical layer device, comprising a circuit configured:
to receive a data unit comprising one or more short training field (STF) sequences comprising thirty two values or less, wherein:
the one or more STF sequences comprises a first subset of values comprising values of zero and non-zero values, wherein the non-zero values are located at indices of the first subset that are at least a multiple of two,
the one or more STF sequences comprises a second subset of zero values, and
the second subset of zero values comprises all values not included within the first subset; and
to decode one or more data symbols based at least in part on the one or more STF sequences.

110. A station, comprising a physical layer device configured:
to receive a data unit comprising one or more short training field (STF) sequences comprising thirty two values or less, wherein:
the one or more STF sequences comprises a first subset of values comprising values of zero and non-zero values, wherein the non-zero values are located at indices of the first subset that are at least a multiple of two,
the one or more STF sequences comprises a second subset of zero values, and
the second subset of zero values comprises all values not included within the first subset; and
to decode one or more data symbols based at least in part on the one or more STF sequences.

111. An access point, comprising a physical layer device configured:
to receive a data unit comprising one or more short training field (STF) sequences comprising thirty two values or less, wherein:
the one or more STF sequences comprises a first subset of values comprising values of zero and non-zero values, wherein the non-zero values are located at indices of the first subset that are at least a multiple of two,
the one or more STF sequences comprises a second subset of zero values, and
the second subset of zero values comprises all values not included within the first subset; and
to decode one or more data symbols based at least in part on the one or more STF sequences.

112. A physical layer device, comprising a circuit configured:
to receive one or more long training field (LTF) sequences comprising thirty two values or less, wherein:
each of the values of the one or more LTF sequences correspond to one of a guard subcarrier, a direct current subcarrier, a pilot subcarrier, and a data subcarrier,
each of the values corresponding to the pilot subcarrier and the data subcarrier comprise a value of either one or negative one, and
each of the values corresponding to the guard subcarrier and the direct current subcarrier comprises a value of zero; and
to decode one or more data symbols based at least in part on the one or more LTF sequences.

113. A station, comprising a physical layer device configured:
to receive one or more long training field (LTF) sequences comprising thirty two values or less, wherein:
each of the values of the one or more LTF sequences correspond to one of a guard subcarrier, a direct current subcarrier, a pilot subcarrier, and a data subcarrier,
each of the values corresponding to the pilot subcarrier and the data subcarrier comprise a value of either one or negative one, and
each of the values corresponding to the guard subcarrier and the direct current subcarrier comprises a value of zero; and
to decode one or more data symbols based at least in part on the one or more LTF sequences.

114. An access point, comprising a physical layer device configured:
to receive one or more long training field (LTF) sequences comprising thirty two values or less, wherein:
each of the values of the one or more LTF sequences correspond to one of a guard subcarrier, a direct current subcarrier, a pilot subcarrier, and a data subcarrier,
each of the values corresponding to the pilot subcarrier and the data subcarrier comprise a value of either one or negative one, and
each of the values corresponding to the guard subcarrier and the direct current subcarrier comprises a value of zero; and
to decode one or more data symbols based at least in part on the one or more LTF sequences.
